(19) United States
(12) Patent Application Publication
(10) Pub. No.: US 2017/0109709 A1
(43) Pub. Date: Apr. 20, 2017

(54) COMPUTERIZED SYSTEMS AND METHODS FOR OFFLINE ACTIVITY MANAGEMENT

(71) Applicants: Steven Wu, Hong Kong (HK); Tyler Rosche, Westport, CT (US); Man Yung Wong, Hong Kong (HK); Theodore Root Smith, Seattle, WA (US)

(72) Inventors: Steven Wu, Hong Kong (HK); Tyler Rosche, Westport, CT (US); Man Yung Wong, Hong Kong (HK); Theodore Root Smith, Seattle, WA (US)

(21) Appl. No.: 15/261,265

(22) Filed: Sep. 9, 2016

Related U.S. Application Data
(60) Provisional application No. 62/216,243, filed on Sep. 9, 2015.

(51) Int. Cl. G06Q 10/10; G06F 7/02; G06Q 50/00

(52) U.S. Cl. CPC G06Q 10/1095; G06Q 50/01; G06F 7/02

(57) ABSTRACT

Offline activity management systems, interactions, interfaces, and methods are disclosed for facilitating user creation of successful offline social activities. An interpersonal network manager provides interfaces for entering or selecting the details of a potential offline social activity. A user selects a target size for the activity, which may correspond to an activity size limit maximum or minimum based on the venue or size of the location. The user selects a list of potential guests to invite to the potential offline social activity, and indicates an invitation preference. The interpersonal network manager selects sets of potential guests to invite to the potential offline social activity on the basis of the invitation preference and information on the potential guests. The interpersonal network manager stops inviting guests when the target size is reached.

This application claims the benefit of U.S. Provisional Application No. 62/216,243, filed Sep. 9, 2015.

### BACKGROUND

Professionals and other individuals often attend events and participate in activities to facilitate interpersonal meetings (herein “Networking Activities”). At these Networking Activities, attendees of the event or activity (“Attendees”) meet other Attendees. Networking Activities may include huge activities with tens of thousands of Attendees, such as major industry events and conventions, or may be as small as an informal lunch between two Attendees. These Networking Activities may occur through formal avenues such as conventions, trade association meetings, and classes, or may comprise informal meet-ups in venues such as bars, cafes, night clubs, or private homes. Attendees are typically alerted to a Networking Activity through one or more of a number of different formal and informal channels; for example, Attendees may be invited or introduced by friends, hear about an activity by word of mouth, find listings of activities on bulletin boards or online, or may alerted about an upcoming activity by an advertisement or sponsoring organization.

Attendees may have interest in attending particular types of Networking Activities or meeting other Attendees with particular traits. Yet, in order to find interesting people at a Networking Activity or find Networking Activities with interesting people attending, Attendees currently rely on serendipity or the proactivity and attentiveness of the hosts of the events. For example, an Attendee interested in meeting an individual with certain interests or employed in a specific sector or position may have difficulty finding an upcoming Network Activity in their area that is likely to include this type of person. Still further, Attendees often have limited ability or resources to plan, host, or organize their own events, and may find it difficult to find a venue and invite a guest list of Attendees that would meet their goals for a Networking Activity. Even once she has identified or organized a Networking Activity, an Attendee may find it difficult to identify or engage with the specific types of people she wishes to meet. Taken as a whole, these issues make it difficult for individuals to attend enjoyable Networking Events and meet other compatible and interesting people. A system that could facilitate off-line social interaction by enabling or facilitating the creation, invitation, and planning of Networking Activities, personalized introductions, group matching, or Networking Activity recommendations would help make interpersonal networking more efficient and effective for potential Attendees.

### BRIEF DESCRIPTION OF THE DRAWINGS

The foregoing aspects and many of the attendant advantages of this disclosure may become more readily appreciated and better understood by reference to the following detailed description in conjunction with the accompanying drawings, wherein:

FIG. 1 is a block diagram depicting an illustrative embodiment of a computing environment implementing an interpersonal networking and recommendation system;

FIG. 2 is a block diagram depicting an illustrative embodiment of a computing environment implementing aspects of an interpersonal networking and recommendation system;

FIG. 3 is a block diagram depicting an illustrative embodiment of a computing environment implementing aspects of an interpersonal networking and recommendation system;

FIG. 4 is a flow diagram depicting an illustrative routine for a Recommendation feedback process for a user or Networking Activity Attendee;

FIG. 5 is a data diagram depicting an illustrative example of Interest attractiveness and validity weights associated with an illustrative interpersonal networking and recommendation system user.

FIG. 6 is a data diagram depicting an illustrative example of Characteristic attractiveness and validity weights associated with an illustrative interpersonal networking and recommendation system user.

FIG. 7 is a flow diagram depicting an illustrative routine for determining Characteristics and Interests for a user or Networking Activity Attendee;

FIG. 8 is a flow diagram depicting an illustrative routine for gathering information associated with a user or Networking Activity Attendee;

FIG. 9 is a device diagram depicting an illustrative embodiment of a user data entry interface of an illustrative interpersonal networking and recommendation system;

FIG. 10 is a data diagram depicting an illustrative example of recommendation weights associated with an illustrative interpersonal networking and recommendation system;

FIG. 11 is a flow diagram depicting an illustrative routine for determining Recommendations for a user or Networking Activity Attendee;

FIG. 12 is a flow diagram depicting an illustrative routine for scoring user or Attendee Recommendations;

FIG. 13 is a device diagram depicting an illustrative embodiment of a Networking Activity selection interface of an illustrative interpersonal networking and recommendation system;

FIG. 14 is a flow diagram depicting an illustrative routine for creating a custom Networking Activity;

FIG. 15 is a device diagram depicting an illustrative embodiment of a create Networking Activity interface of an illustrative interpersonal networking and recommendation system;

FIG. 16 is a device diagram depicting an illustrative embodiment of an invitation edit interface of an illustrative interpersonal networking and recommendation system;

FIG. 17 is a device diagram depicting an illustrative embodiment of a recommendation request interface of an illustrative interpersonal networking and recommendation system;

FIG. 18 is a device diagram depicting an illustrative embodiment of a group Recommendation interface of an illustrative interpersonal networking and recommendation system;

FIG. 19 is a device diagram depicting an illustrative embodiment of a user details interface of an illustrative interpersonal networking and recommendation system;

FIG. 20 is a device diagram depicting an illustrative embodiment of a user feedback interface of an illustrative interpersonal networking and recommendation system.

FIG. 21 is a device diagram depicting an illustrative embodiment of a Networking Activity feedback interface of an illustrative interpersonal networking and recommendation system;

### DETAILED DESCRIPTION

This application claims the benefit of U.S. Provisional Application No. 62/216,243, filed Sep. 9, 2015 and incorporated by reference herein. Generally described, the present disclosure is directed towards a computer system, and more specifically towards an interpersonal networking system, including generating personalized individual or group recommendations for interpersonal networking. Specifically, embodiments of interpersonal networking and recommendation interfaces, systems, and methods are disclosed for improving the efficiency, friendless, or effectiveness of interpersonal introductions or recommendations, both between individuals and groups of individuals. Additional or alternate embodiments of systems, interactions, interfaces, or methods of or relating to interpersonal networking and recommendation interfaces, systems, and methods are disclosed in the following three co-pending U.S. patent applications filed concurrently with the present application and incorporated by reference herein: patent application Ser. No. ______ (attorney docket number: SALAD.001A) filed by inventors Steven Wu, Tyler Rosche, Russell Wong, and Theodore R. Smith Jr on the same date as the present application and entitled COMPUTERIZED SYSTEMS AND METHODS FOR OFFLINE SOCIAL RECOMMENDATIONS; patent application Ser. No. ______ (attorney docket number: SALAD.002A) filed by inventors Steven Wu, Tyler Rosche, Russell Wong, and Theodore R. Smith Jr on the same date as the present application and entitled COMPUTERIZED SYSTEMS AND METHODS FOR OFFLINE EVENT FACILITATION; and patent application Ser. No. ______ (attorney docket number: SALAD.004A) filed by inventors Steven Wu, Tyler Rosche, Russell Wong, and Theodore R. Smith Jr on the same date as the present application and entitled COMPUTERIZED SYSTEMS AND METHODS FOR OFFLINE INTERPERSONAL FACILITATION.

Potential Attendees, such as interpersonal networking and recommendation system users, may have various characteristics associated with themselves or corresponding to various associated groups, friends or friendships, past events, personal property, devices, accounts, or other instrumentalities. For purposes of brevity, an attribute, trait, characteristic, or piece of descriptive information associated with a system user or potential Networking Event Attendee may be referred to herein as a “Characteristic.” Characteristics may be directly determined or may be inferred from information associated with the user. It is important to note that such Characteristics are not limited to personal attributes of a user or Attendee, but may broadly encompass any directly or indirectly associated trait or piece of information. For example, a Characteristic may include any personal physical or mental trait, interest, hobby, opinion, friendship, quality, habit, ability, experience, behavior, qualification, temporary or permanent status, or other piece of descriptive data associated with a specific user or Attendee, and may further include descriptive data associated with an associated friend, demographic, group, organization, club, employer, or team; data or traits associated with a pet, device, or other property; data or traits inferred, generated, or obtained from photographs, articles, social media, or other informational sources; data collected or inferred from interactions, environmental sources, or feedback associated with the user or Attendee; or any other direct or indirectly associated qualitative or quantitative characteristic. Illustratively, environmental sources may include any sensed or detectable information associated with a user or Attendees environment, including audio, chemical, physical (e.g. temperature, motion, humidity, acceleration, location, etc.), or electromagnetic (e.g. light, IR, radio, microwave, magnetic) information. In some embodiments, individual Characteristics may be generated, determined, or inferred based on an analysis or compilation of data from one or a number of sources. Characteristics may, in some embodiments, be updated or otherwise modified based on feedback or additional data collected from one or more Attendees or other sources. In some embodiments, Characteristics may be assigned one or more quantitative values representing properties like a Characteristic's strength, a validity weight or confidence interval that the Characteristic actually applies to the user or Attendee, etc.

In addition to Characteristics, a user or potential Attendee may have various levels of interest in meeting individuals with specific Characteristics or in achieving one or more personal goals. For the purpose of brevity, these interests may be generally referred to herein as “Interests”. In various embodiments, Interests may include interests in meeting particular types or categories of people, interests in meeting people with particular Characteristics, or interests in attaining particular personal, group, or organizational objectives. In one embodiment, an interpersonal networking and recommendation system may include a number of Interests corresponding to other users of the system. For example, a user of an interpersonal networking and recommendation system may have an Interest value corresponding to each other user representing how interested the user is in each of the other users. In some embodiments, Interests may be assigned one or more quantitative values representing properties like an Interest's strength or importance to the user, a validity weight or confidence interval that the Interest actually applies to the user or Attendee, etc. For example, the Interests of an Attendee at a Networking Activity might include a strong interest in meeting hedge fund managers, a strong interest in meeting people who code as a hobby, a medium interest in finding a new job as a litigation attorney, a medium interest in meeting a romantic partner, a weak interest in learning more about quantum mechanics, a weak interest towards meeting people who like dogs, and a weak interest in being able to leave the event before 10 pm. Interests may, in some embodiments, be updated or otherwise modified based on user feedback or other data collected from one or more Attendees or other sources. Illustratively, Interests may be based on data directly related to a user or Attendee, or may be based on indirectly related data, such as data related to a user's friends, environment, surrounding location, etc. In some cases, Interests may specifically correspond to one or more Characteristics of Attendees or of groups of Attendees. In alternate embodiments, an interpersonal networking and recommendation system may not utilize Interests as a separate category of data from Characteristics, but may determine a user or Attendees interest in a specific Characteristic by utilizing the user's Characteristic value directly or in combination with other information.

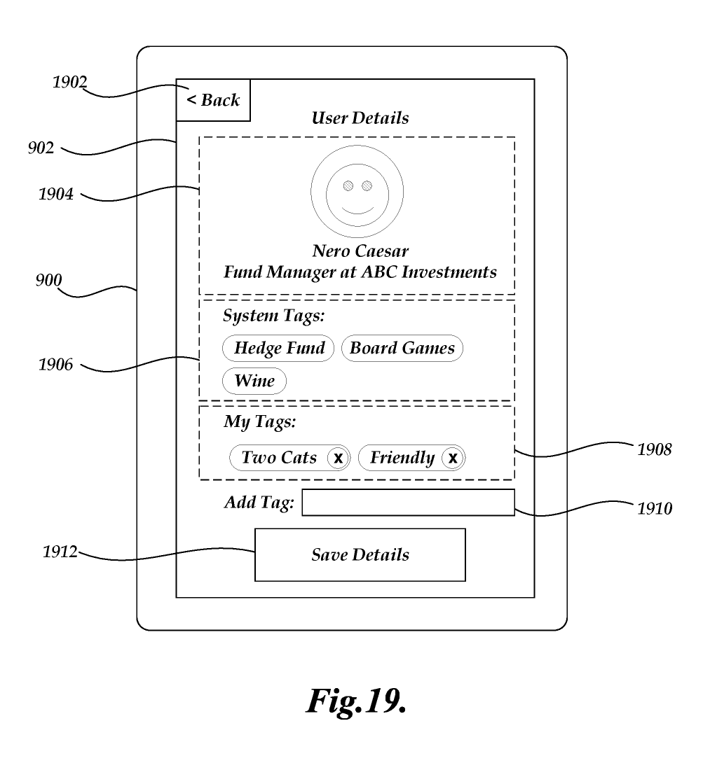

In one embodiment, users or Attendees may be tagged with metadata tags by themselves, other users or Attendees, a system admin, or automatically by an interpersonal networking and recommendation system. Illustratively, in one embodiment, tags may be limited to a certain set of tags defined by an interpersonal networking and recommendation system admin or determined by the system based on popular words or terms used by system users or Attendees. In another embodiment, tags may be entered freely by users or Attendees. Illustratively, particular tags or sets of tags may be associated with different visibility or permission attributes. For example, a set of tags may be utilized by an interpersonal networking and recommendation system only, and not displayed or visible to any system users or Attendees. As another example, a set of tags may be displayed or visible only to the user or Attendee they are associated with. As a further example, a set of tags may be displayed or visible only to the user or Attendee who added them to a target user or Attendee. An illustrative interface enabling or facilitating the adding of tags to another user or Attendee is discussed below with reference to illustrative FIG. 19. As a still further example, a set of tags may be displayed or visible to any user or Attendee in an interpersonal networking and recommendation system, or may only be displayed or visible to a particular group, demographic, type, or status of user. For example, a certain set of tags associated with a first user may only be visible to users who have been friended by the first user. Illustratively, although tag visibility is discussed in the above examples, permissions to change, add, or remove tags may vary by tag or by set of tags may additionally or alternately vary in any of the same ways or based on any of the same or alternate categories of user or Attendee. In one embodiment, one or more Characteristic or Interests may correspond directly to metadata tags. For example, in one embodiment, an interpersonal networking and recommendation system may not maintain Characteristics or Interests separately from a set of metadata tags, but may utilize the set of metadata tags in any of the ways discussed herein with reference to Characteristics or Interests (e.g. maintaining a set of values or validity weights associated with metadata tags, etc.). In one embodiment, metadata tags may be further applied or associated with Networking Activities or types or templates of Networking Activities; Recommendations or types of Recommendations as discussed below; interpersonal interactions; types, demographics, or groups of users or Attendees; or any other object or concept associated with an interpersonal networking and recommendation system.

Specifically, embodiments of item management interfaces, systems, and methods herein disclosed may compare, analyze, weight, and otherwise process Characteristics and Interests associated with one or more users or potential Attendees to generate or identify recommendations or suggestions for one or more interpersonal interactions. Interpersonal interactions may broadly include attendance at one or more Networking Activities, interaction or engagement with a group of Attendees or system users, interaction, introduction, or engagement with an individual Attendee or system user, participation in a conversation, or any other activity associated with interpersonal networking. For the purpose of brevity, recommendations or suggestions for interpersonal interactions may be referred to herein as “Recommendations.” In addition to a suggestion for an interpersonal interactions as discussed above, Recommendations may further or specifically include: a suggestion that a user or potential Attendee attend one or more Networking Activities; a suggestion that a user or Attendee engage in one or more of a general category of interpersonal interaction; a suggestion that a user or Attendee connect generally with another user or Attendee; enabling a user or potential Attendee to search, filter, or manage a set of Networking Activities, users, or groups; recommending venues or times for potential Networking Activities, matching Attendees with other Attendees or groups at a Networking Activity, suggesting topics of conversation, games, activities, or behaviors to Attendees to facilitate networking, recommending specific interpersonal introductions or interpersonal interactions to Attendees, recommending that Attendees join specific ongoing activities or conversations, etc. Recommendations may include both passive suggestions, such as recommending that an Attendee make a specific introduction or engage another Attendee in a discussion of a particular topic, as well as the taking of actions intended to assist the user in their interpersonal networking efforts, such as assisting in the organization or hosting of a Networking Activity by identifying and reserving a venue, inviting guests, ordering food, arranging transportation, or other actions. In some embodiments, a system may not utilize Interests as a specific category of data, but may make Recommendations based on Characteristics alone. In various embodiments, the interfaces, systems, and methods described herein may be implemented, performed, or displayed on one or more general purpose computing devices or other computing system(s).

In order to illustrate various aspects and advantages of this disclosure, a number of embodiments and examples are provided below.

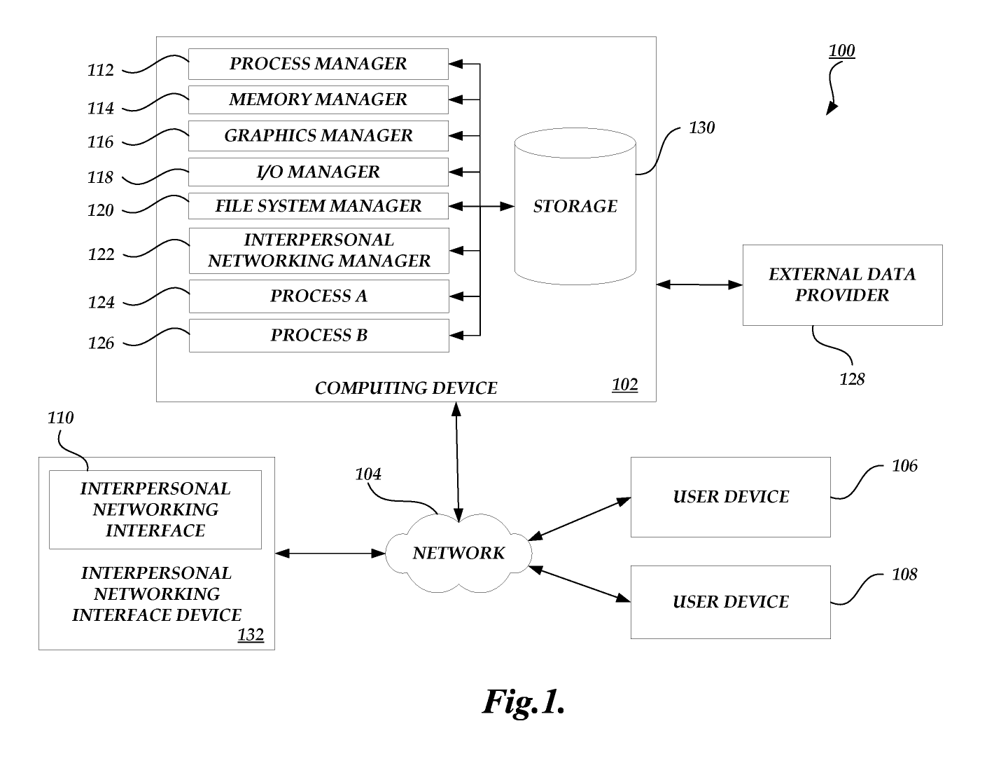

FIG. 1 is a block diagram illustrative of computing environment 100 implementing an embodiment of an interpersonal networking and recommendation system for the determination, generation, display, modification, and management of Recommendations and associated interpersonal networking functionality. As illustrated in FIG. 1, computing environment 100 includes a computing device 102. In an illustrative embodiment, computing device 102 may correspond to any of a wide variety of computing devices including personal computing devices (e.g. desktop or laptop computing devices), tablet or other hand-held computing devices, mobile devices, wireless devices, augmented reality devices or glasses, virtual reality devices, set-top devices, terminal devices, network or cloud computing devices, virtualized computing devices, server or mainframe computing devices, or any other electronic device or appliance.

Illustratively, computing device 102 may include or be comprised of one or more hardware or software components for management of various aspects of the computing device 102 and associated functionality, such as process manager 112, memory manager 114, graphics manager 116, I/O manager 118, and file system manager 120. Computing device 102 may further include or be comprised of one or more computing processes 124 and 126. Computing processes 124 and 126 may include, but are not limited to any variety of application, service, utility, script, or other software process. Still further, computing device 102 may include or be comprised of one or more storage device 130. Illustratively, storage device 130 may comprise any kind or configuration of one or more devices or modules allowing the storage of electronic information, which may include but are not limited to computer hard drives, solid state drives (SSD), clustered drives (e.g. RAID), flash storage, removable storage media such as CD or DVD, tape drive, holographic storage, or other storage technology or device. Client computing device 102 may further be directly or indirectly connected to one or more external data provider 128, such as an external hard drive or flash memory device, drive cluster, storage management system, external media device, cloud storage device, third party data provider or server, or other storage solution. In some embodiments, external data provider 128 may include third party databases, websites, or other data repositories accessible through an API. For example, external data provider 128 may include a data repository associated with a third party social networking web site or a public search engine. As another example, external data provider 128 may include an external CRM database or service, or a customer or attendee database associated with a convention or other event.

Client computing device 102 may further include interpersonal networking manager 122 for providing functionality associated with the provision of interpersonal networking services. Illustratively, this functionality may include, but is not limited to, generating and providing Recommendations; managing and processing user and Attendee data, determining; identifying, generating, or determining user or Attendee Characteristics and Interests; requesting and gathering feedback from Networking Activities and Attendees; displaying or managing the display of user interface functionality; managing user devices or interface devices; managing apps, routines, or processes associated with user devices or interface devices; generating, identifying, obtaining, processing, or providing data to interpersonal networking or third-party services; or any other functionality discussed herein with respect to interpersonal networking services. Interpersonal networking manager 122 may be implemented in any combination of software or hardware, and may in one or more embodiments provide one or more commands, API calls, or interface elements allowing a user or user device to interact with interpersonal networking data, interfaces, data or feedback requests, user or Attendee Characteristics or Interests, Recommendations, user or Attendee profile data (e.g. tag data, biographic data, preferences, pictures, professional profile data, etc.), or any other type of data associated with an interpersonal networking and recommendation service. In one embodiment, interpersonal networking manager 122 may interface or communicate with an app or process on a device associated with a user or interpersonal networking interface to cause interpersonal networking interface elements to be directly or indirectly displayed to a user.

In an illustrative embodiment, computing device 102 includes necessary hardware and software components for establishing communications over communication network 104, such as a wide area network (e.g. the Internet), or local area network (e.g. an intranet). For example, computing device 102 may establish communications over communication network 104 through I/O manager 118 or any other combination of networking equipment and software.

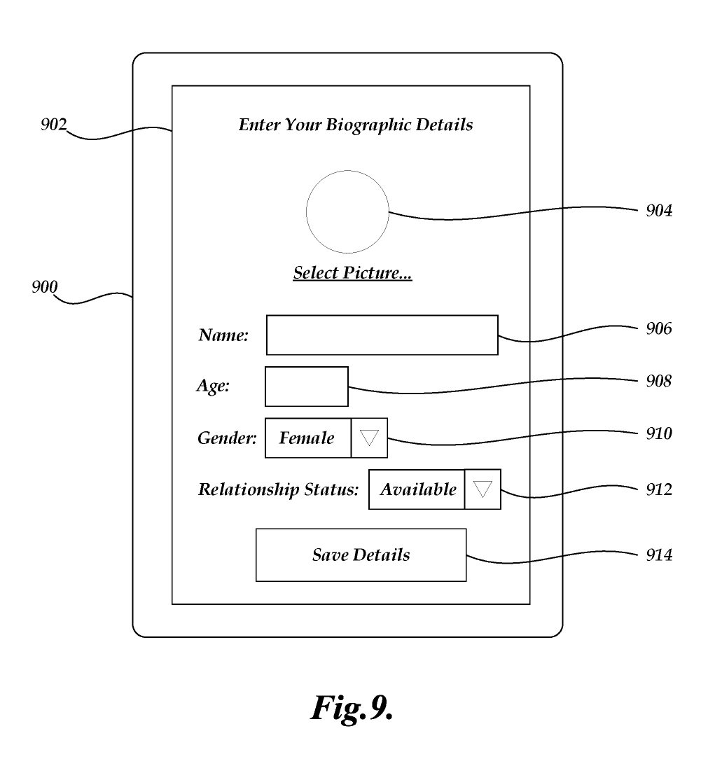

Computing environment 100 may also include one or more user devices 106 and 108 in communication with computing device 102 over communication network 104. Illustratively, user devices 106 and 108 may correspond to any of a wide variety of computing devices including personal computing devices (e.g. desktop or laptop computing devices), tablet or other hand-held computing devices, wearable devices, mobile devices, wireless devices, augmented reality devices or glasses, virtual reality devices, set-top devices, terminal devices, network or cloud computing devices, virtualized computing devices, server or mainframe computing devices, or any other electronic device or appliance. For example, user devices 106 and 108 may correspond to mobile devices associated with Attendees at a Networking Event. In one embodiment, user devices 106 and 108 may allow interaction with data, interface, Recommendations, or other functionality provided or managed by computing device 102 or interpersonal networking manager 122. For example, user device 106 may run an app displaying one or more graphical user interface as discussed below with reference to FIGS. 9, 13, and 15-21, and may communicate data and user interactions back to computing device 102.

With continued reference to FIG. 1, computing environment 100 may further include one or more interpersonal networking interface device 132 in communication with computing device 102 over communication network 104. Illustratively, interpersonal networking interface device 132 may correspond to a computing device accessible by one or more Attendee at a Networking Event, and may provide a interpersonal networking interface 110 allowing interaction with various data, interfaces, Characteristics and Interests, user or Attendee profiles, Recommendations, or other functionality provided or managed by computing device 102 or interpersonal networking manager 122. For example, interpersonal networking device may correspond to an electronic kiosk or touch-screen display. In one embodiment, interpersonal networking interface device 132 may provide means for Attendees to interact with functionality provided or managed by computing device 102 or interpersonal networking manager 122 without having access to a personal device such as user devices 106 or 108. Specifically, interpersonal networking interface device 132 illustrated in FIG. 1 may comprise any combination of hardware or software such as discussed with reference to computing device 102 or user devices 106 or 108 above.

In one embodiment, one or more aspects or functionalities described herein with reference to computing device 102 may be provided by, implemented on, or included in one or more of user devices 106 and 108 or interpersonal networking interface device 132 instead of or in addition to computing device 102. Although computing device 102 is referenced herein for purposes of clarity, in a still further embodiment any combination of user devices or other devices may perform all processes and functionalities discussed with reference to computing device 102 or interpersonal networking manager 122. In further embodiments, functionalities or aspects of computing device 102 may be provided by, implemented on, or included within various other components, devices, providers, or systems, including but not limited to external data provider 128 or other entity.

In one embodiment, interpersonal networking manager 122 may communicate with various devices such as user devices 106 and 108 or interpersonal networking interface device 132 through a combination of hardware or software associated with communication network 104, or through a direct data connection to client computing device 102. Illustratively, networking interpersonal manager 122 may cause or manage the processing of user or Attendee data, determination of Characteristics or Interests, management of interfaces or other client processes, the determination of Recommendations, or other functionality responsive to or in conjunction with commands or calls generated by user devices 106 and 108 or interpersonal networking interface device 132.

As a specific example, elements of hardware or software associated with user devices 106 or 108 may cause one or more elements of an interpersonal networking interface to be displayed to a user, and may cause one or more call or command to be communicated to networking interpersonal manager 122 based on user interaction.

Illustratively, calls or commands communicated to networking interpersonal manager 122 may include, but are not limited to: instruction data or other information associated with the provision of Recommendations; feedback; interface functionality or other client processes; user or Attendee profiles or other associated data; Characteristics, Interests, or other data; instruction data corresponding to the modification or management of any of the components, devices, or entities included in computing environment 100, such as interpersonal networking interface device 132, user devices 106 and 108, external data provider 128, computing device 102, etc.; or any other command, API call, or instruction.

In one embodiment, user interaction with elements of a user interface provided through interpersonal networking interface device 132 or user devices 106 or 108 may be the basis for calls or commands communicated to interpersonal networking manager 122. In further embodiments, on one or more automated sequences or processes may cause calls or commands to be communicated to interpersonal networking manager 122; sequences or processes may include, but are not limited to hardware or software processes associated with computing device 102 (e.g. computing processes 124 and 126), processes associated with networking interface device 132 or user devices 106 or 108, processes associated external data provider 128, or any other entity.

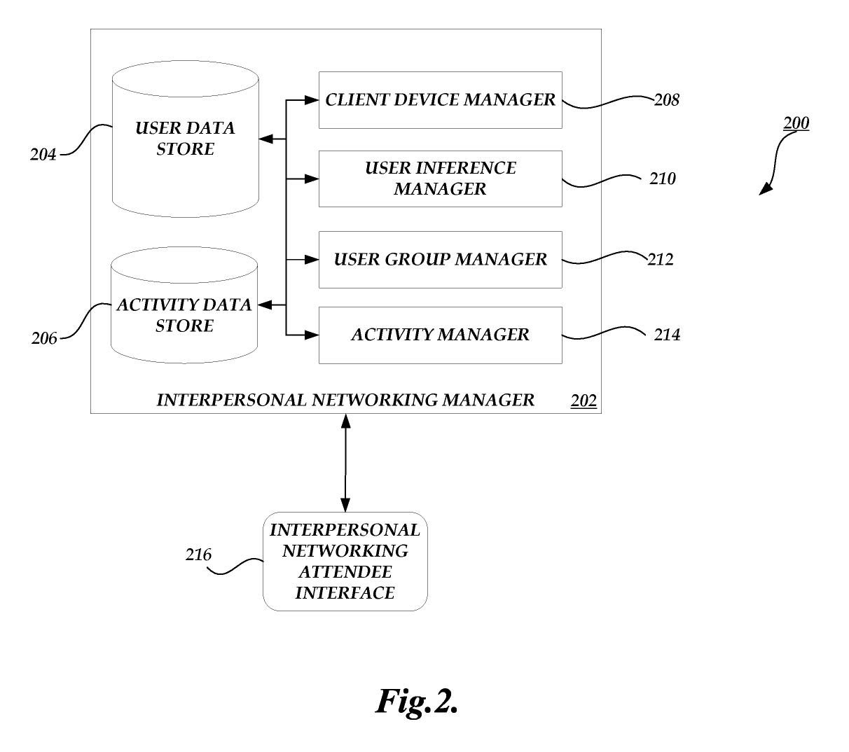

FIG. 2 is a block diagram illustrative of computing environment 200 implementing aspects of an embodiment of an interpersonal networking and recommendation system. As illustrated in FIG. 2, computing environment 200 includes an interpersonal networking manager 202. In one embodiment, interpersonal networking manager 202 may correspond to interpersonal networking manager 122 such as described above with reference to FIG. 1. Illustratively, interpersonal networking manager 202 may be implemented in hardware or software on any combination of computing device 102, interpersonal networking interface device 132, user devices 106 or 108, external data provider 128, or any other general purpose computer or device. Interpersonal networking manager 202 may provide functionality including generating and providing Recommendations; managing and processing user and Attendee data; requesting and gathering feedback from Networking Activities and Attendees; displaying, providing, or managing the display of user interface functionality; or any other functionality discussed herein with respect to interpersonal networking services.

Interpersonal networking manager 202 may include a user data store 204 for managing and storing data associated with system users. For example, user data store 204 may store Characteristics, Interests, feedback, and other associated data as well as data more broadly associated with users, such as names, logins, passwords, pictures, usage histories, etc. In one embodiment user data store 204 may store sets of user-associated or user-provided data used to determine user Characteristics and Interests. Illustratively, user data store 204 may correspond to a part or whole of data store 130 or external data provider 128 with reference to FIG. 1 above, or may be implemented on or by any other storage device, storage platform, or entity. In one embodiment, user data store 204 may be split between multiple devices, and data may be cached, replicated, or split between physical machines or storage instrumentalities.

Interpersonal networking manager 202 may further include an activity data store 206 for managing and storing data associated with Networking Activities. For example, activity data store 206 may store information on past and upcoming Networking Activities, including but not limited to activity times, activity descriptions and billing records, activity locations, activity photographs and multimedia recordings, activity attendance or Attendee records, activity feedback, and other associated data. Illustratively, information associated with Networking Activities may be generated, identified, or entered by an activity planner associated with the interpersonal networking and recommendation system, may be automatically generated by a process or service associated with the interpersonal networking and recommendation system such as activity manager 214 discussed below, may be generated, identified, or entered by a system user acting as an event host, may be obtained from a third party event service or social network, or determined through interaction with any other agent or component in the system. In one embodiment activity data store 206 may store sets of data associated with Networking Activities that may be used to determine user Characteristics and Interests. Illustratively, activity data store 206 may correspond a part or whole of data store 130 or external data provider 128 with reference to FIG. 1 above, or may be implemented on or by any other storage device, storage platform, or entity. In one embodiment, activity data store 206 may be split between multiple devices, and data may be cached, replicated, or split between physical machines or storage instrumentalities.

In one embodiment, interpersonal networking manager 202 may include a client device manager 208 for managing or providing data to user devices such as user devices 106 and 108, interpersonal networking interface device 132 with reference to FIG. 1 above, or other client devices providing or assisting in interaction with users or Attendees. Client device manager 208 may provide devices with Recommendation data, commands, instruction data, interface data or other information supporting any of the interpersonal networking functionality described herein. Client device manager 208 may also manage the collection of data (e.g. user data and Networking Activity data) from user devices or other interface devices. For example, client device manager 208 may provide a command to user device 106 causing user device 106 to display an interface requesting feedback from an associated user. Client device manager 208 may receive the feedback provided by the user along with environmental or location data provided by user device 106 and store this data in user data store 205 or activity data store 206.

Still further, interpersonal networking manager 202 may include a user inference manager 210 for determining or identifying Characteristics, Interests, or other data from stored interpersonal networking data such as data collected through client device manager 208 or stored in user data store 205 or activity data store 206. Interpersonal networking manager 202 may additionally include user group manager 212 for generating, identifying, or determining user Recommendations. For example, user group manager 212 may match Attendees with other Attendees and groups of Attendees through analysis of Characteristics, Interests, or other data. Illustratively, these Characteristics, Interests, and other data may be identified, generated, or determined by user inference manager 210. In one embodiment, user group manager 212 may maintain records of active or past groups of attendees for the purpose of matching Attendees with relevant groups. Past group data may be stored in user data store 205 or activity data store 206, and in some embodiments may be utilized by user inference manager 210 to generate, identify or refine Characteristics, Interests, or other data associated with user and Attendees.

Interpersonal networking manager 202 may further include an activity manager 214 for maintaining information associated with past, current, and future activities. For example, activity manager 214 may maintain a list of upcoming Networking Activities stored in activity data store 206, and may manage data associated with potential Attendee attendance and other information associated with the upcoming Networking Activities In one embodiment, activity manager 214 may access identify, generate, or determine user Recommendations associated with Networking Activities. In a further embodiment, activity manager 214 may provide services such as Networking Activity scheduling, planning, or management.

Computing environment 200 may further include interpersonal networking attendee interface 216 for providing one or more interpersonal networking and recommendation system interface to one or more users or event Attendees. With reference to FIG. 1, interpersonal networking attendee interface 216 may be implemented on a user device such as user devices 106 and 108, may corresponding to interpersonal networking interface 110, or may be implemented directly on computing device 102. Illustratively, interpersonal networking attendee interface 216 may be in direct communication with interpersonal networking manager 202 or may communicate with interpersonal networking manager through an intermediary device or network. Interpersonal networking attendee interface 216 may display interfaces associated with Recommendations, Networking Activities, user or Attendee data, feedback, system or setting management, logins, or any other interface associated with an interpersonal networking service, including, but not limited to interfaces described below with reference to FIGS. 9, 13, and 15-21.

To provide an illustrative example of the above, client device manager 208 may cause interpersonal networking attendee interface 216 to display a short questionnaire to an Attendee at a Networking Activity. Client device manager 208 may receive the responses from the Attendee, and store the collected data in user data store 204. Client device manager 208 may communicate with user inference manager 210 and signal that new Attendee data has been collected. Responsive to this signal, user inference manager 210 may retrieve Attendee data, including previously determined Characteristics and Interests associated with the Attendee and the new Attendee data, from user data store 204. In the context of this example, user inference manager 210 may process the collected data and determine that the Attendees has a strong ranking in a Characteristic “Likes Math.” User inference manager 210 may update the “Likes Math” characteristic along with any number of other Characteristics or Interests based on the new attendee data, and store the resulting information back to user data store 204. At some point during the Networking Activity, client device manager 208 may receive a request for an interpersonal introduction through interpersonal networking attendee interface 216, and may signal user group manager 212. User group manager 212 in consort with activity manager 214 may identify a second Attendee at the current Networking Activity with a high ranking in “Likes Math” and generate a Recommendation that the two Attendees meet each other. Activity manager 214 may determine a potential meeting location for the two Attendees within the current Networking Activity, and client device manager 208 may cause interpersonal networking attendee interface 216 to provide the Recommendation for an introduction at the identified location to the First Attendee. The client device manager 208 may additionally cause an interpersonal networking attendee interface 216 to provide a Recommendation for an introduction with the First Attendee at the identified location to the second Attendee through an interpersonal networking attendee interface associated with the second Attendee.

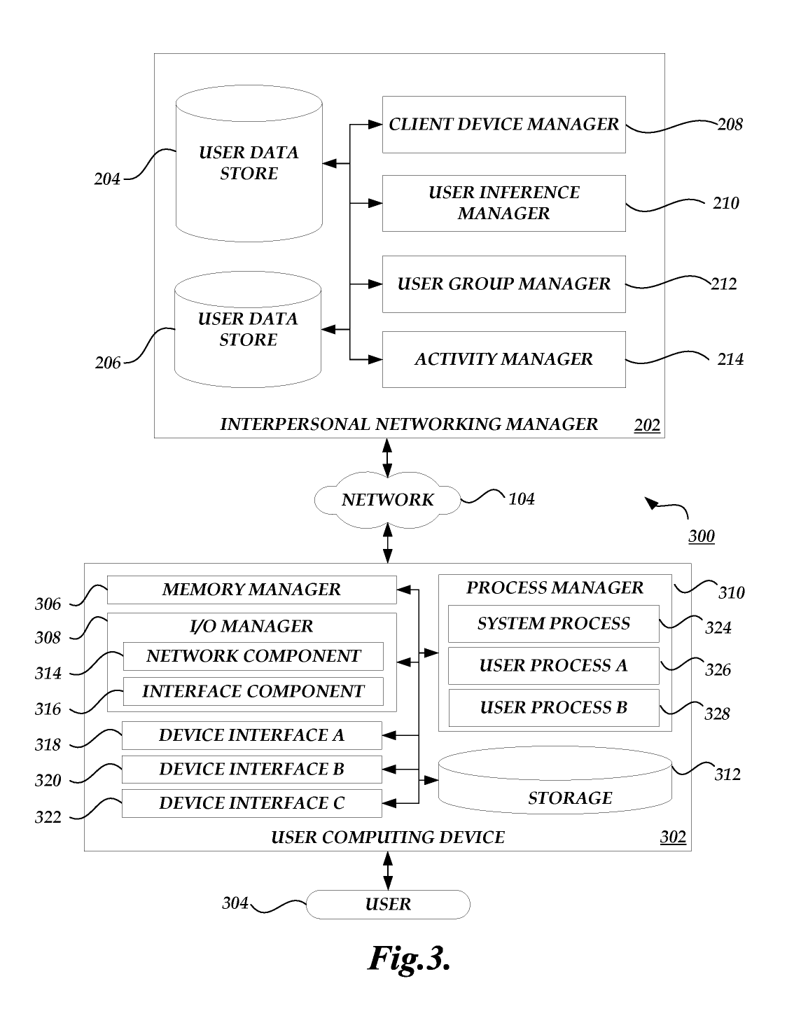

FIG. 3 is a block diagram illustrative of computing environment 300 implementing aspects of an embodiment of an interpersonal networking and recommendation system. Computing environment 300 may include interpersonal networking manager 202 as discussed with reference to FIG. 2 above in communication with user computing device 302 through communications network 104. In various embodiments, user computing device 302 may correspond to user device 106 or 108 or interpersonal networking interface device 132 with reference to FIG. 1 above, or may implement interpersonal networking attendee interface 216 as discussed with reference to FIG. 2.

Illustratively, user computing device 302 may correspond to any general purpose computer or device as discussed above with reference to computing device 102, user device 106 or 108, or interpersonal networking interface device 132. In one embodiment user computing device 302 may correspond to a mobile device such as a mobile phone or tablet associated with a user 304.

Illustratively, user computing device 302 may include or be comprised of one or more hardware or software components for management of various aspects of user computing device 302 and associated functionality, such as memory manager 306, I/O manager 308, and process manager 310. Illustratively, process manager 310 may further include or be comprised of one or more system process 324 and user computing processes 326 and 328. Illustratively, System process 324 may include any operating system process or other service required or utilized for the operation or management of the user computing device 302. User computing processes 326 and 328 may include, but are not limited to any variety of application, service, utility, script, or other software process. Still further, user computing device 302 may include or be comprised of one or more storage device 312. Illustratively, storage device 312 may comprise any kind or configuration of one or more devices or modules allowing the storage of electronic information, which may include but are not limited to computer hard drives, solid state drives (SSD), clustered drives (e.g. RAID), a third party or cloud storage provider, a network drive, flash storage, removable storage media such as CD or DVD, tape drive, holographic storage, or other storage technology or device.

Illustratively, I/O manager 308 may include or be comprised of processes for providing input, output, and data gathering functionality such as network component 314 and interface component 316.

In an illustrative embodiment, network component 314 includes or manages any necessary hardware and software components for establishing communications over communication network 104, such as a wide area network (e.g. the Internet), or local area network (e.g. an intranet). For example, computing device 302 may establish communications with interpersonal networking manager 202 over communication network 104 through I/O manager 118 or any other combination of networking equipment and software.

Illustratively, interface component 316 may manage device interfaces 318, 320, and 322 used by the device in communicating with the outside world, and provide services and functionality enabling a user 304 to interact with user computing device 302. In various embodiments, interface component 316 may manage any number of different device interfaces 318, 320, and 322, including display, audio, or tactile interfaces, input interfaces, device sensors, or any other interface with the outside world. Illustratively, devices interfaces 318, 320, and 322 may include 2 or 3-dimensional display screens, virtual reality display or input hardware, touch or stylus input devices, physical keyboards or other physical input modality (e.g. device buttons, sliders, or other controls), virtual keyboards or input controls, pointing devices such as mice or trackballs, internal sensors (e.g. battery life, error or damage sensors, etc.), gesture sensors, tactile sensors, tactile feedback devices, cameras, speakers, microphones, motion sensors (e.g. velocity, tilt, rotation, acceleration, etc.), location sensors or hardware (e.g. GPS, cell triangulation, near field radio communications chip or sensor, etc.), card scanners or chip readers, radio-wave interfaces (e.g. cell radio, Wi-Fi or mesh networks, FM/AM radio, Bluetooth, etc.), RFID or NFC interface, infrared interface, microwave interface, device LEDs, electrostatic or electromagnetic sensors or interface devices (e.g. IR, magnetic, microwave, etc.), air sensors (e.g. temperature, humidity, air speed, etc.), Radar or eco-location interface, or any other interface allowing user computing device 302 to interact with its surrounding environment.

In various embodiments, user computing device 302 may receive information, commands, and calls from interpersonal networking manager 202 to display or otherwise communicate information to the user 304. For example, client device manager 208 may send information or commands to user computing device 302 causing user computing device 302 to display a Recommendation to attend a Networking Event along with an audible alert tone. Likewise, in various embodiments, information from the user 304 and obtained through various device interfaces may be communicated to interpersonal networking manager 202 through network 104 or other channel. For example, a response that user 304 will attend a networking event may be send back to interpersonal networking manager 202, along with other interface data such as the current location, battery status, and cell radio strength as measured by user computing device 302.

One of skill in the relevant art will appreciate that any components, processes, or process managers discussed with reference to FIGS. 1-3 may be implemented in any combination of software or hardware, and may provide one or more commands, API calls, or interface elements allowing a user or user device to interact with other devices, online or offline services, software processes or components.

Illustratively, although a number of functionalities and illustrative calls and commands are discussed above with reference to FIGS. 1-3, these specific calls, commands, and functionalities are included for the purpose of example only. In various embodiments, elements or components of an item management system may support any number of different calls, commands, and functionalities associated with embodiments, behavior, or functionality described or suggested herein or known in the relevant art.

Illustratively, the specific components, devices, and elements included with reference to FIGS. 1-3 are included for purpose of example only; embodiments of interpersonal networking and recommendation systems may include any number or combination of components, devices, or elements illustrated or described with reference to FIGS. 1-3, or may include any number or configuration of additional or alternate computing devices, components, or elements as known in the relevant art. Additionally, aspects or functionalities herein ascribed to one or more components, devices or elements included or described with reference to FIGS. 1-3 may be split between or performed by any number of configuration of different components, devices, or elements in addition to, or as an alternative to the specific components, devices, or elements described herein with reference to with reference to FIGS. 1-3.

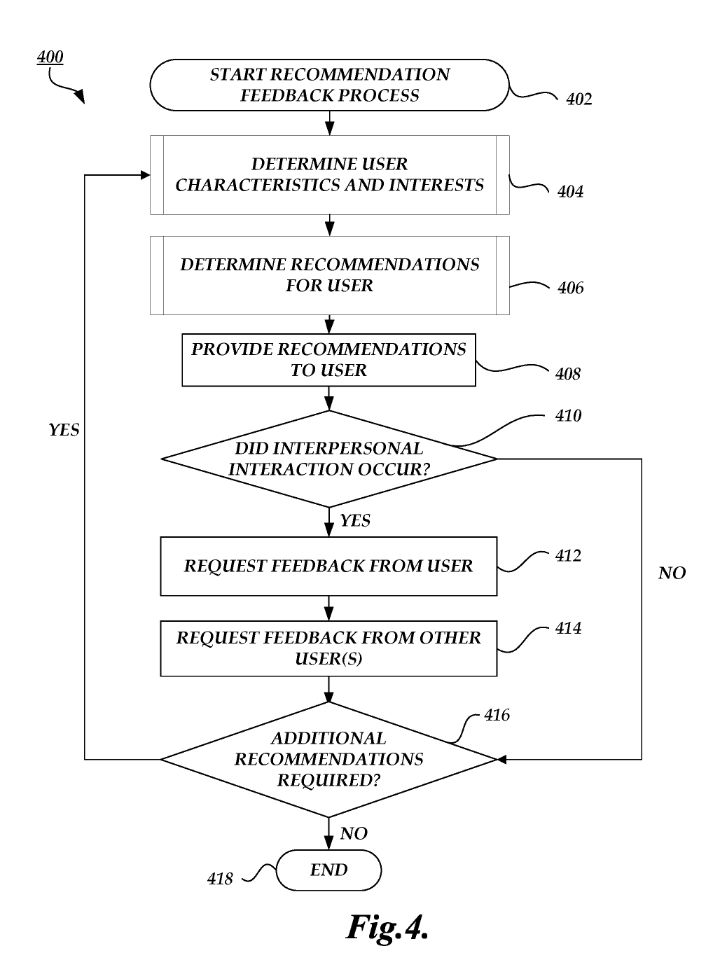

FIG. 4 is a flow diagram depicting an illustrative routine 400 for determining Recommendations for a user or Networking Activity Attendee through a recommendation feedback process. In one embodiment, routine 400 may be implemented or performed by components of an interpersonal networking service such as that depicted at least with reference to illustrative FIGS. 1-3, et al. In various embodiments, interface elements and routine blocks discussed with reference FIG. 4 may be implemented, displayed, or executed on a computing device 102 with reference to illustrative FIG. 1 or interpersonal networking manager 202 with reference to illustrative FIG. 2. Illustratively, various interfaces and processes of illustrative routine 400 may further be performed on any combination of various other devices or services such as interpersonal networking interface device 132, user devices 106 or 108, or user computing device 302 discussed with reference to FIGS. 1 and 3, respectively. In one embodiment, aspects or blocks of routine 400 may be performed by an automated or semi-automated process associated with a client computing device 102 or interpersonal networking manager 202. Aspects of routine 400 may be performed in response to specific interactions or commands by a user or process. In yet another embodiment, aspects of routine 400 may be implemented on a continuous basis. It will be appreciated by one skilled in the relevant art that various aspects or blocks of routine 400 may be performed concurrently, sequentially, or at different times and in response to different events or timings. For example, in one embodiment an interpersonal networking and recommendation system may gather data and determine user characteristics and interests continuously while the user is meeting with Attendees at a Networking Event. Illustratively, routine 400 may determine any type of Recommendation, as discussed above with respect to Recommendations, including, but not limited to Recommendations for group or individual matching at Networking Activities, interpersonal introductions, conversation topics or other interpersonal suggestions, or potential Networking Activities.

Returning to FIG. 4, illustrative routine 400 may begin at block 402. In one embodiment, routine 400 may begin responsive to an Attendee attending a Networking Activity or otherwise requesting or signaling their readiness to receive interpersonal networking Recommendations. In another embodiment, illustrative routine 400 may begin responsive to a user setting up an account with an interpersonal networking service or otherwise requesting or signaling their readiness to receive Recommendations for introductions or potential Networking Activities. For example, a user with an account with an interpersonal networking and recommendation system may open an app associated with the interpersonal networking and recommendation system on their mobile device, which may automatically signal interpersonal networking manager 202 in illustrative FIG. 2 to determine Recommendations for potential Networking Activities for the user to attend. As another example, an Attendee at a Networking Activity may utilize an app on their mobile device or an interface terminal to view Recommendations for matching with a group or individual introductions. In one embodiment, interpersonal networking manager 202 or other component of an interpersonal networking and recommendation system may automatically determine that a user or Attendee should receive one or more Recommendations based on a time since the last Recommendation, feedback, group matching, introduction, or attended Networking Activity, and may automatically determine Recommendations for that user or Attendee.

To begin an illustrative example, routine 400 may begin with an interpersonal networking manager 202 determining that a user has not attended a Networking Activity in two weeks.

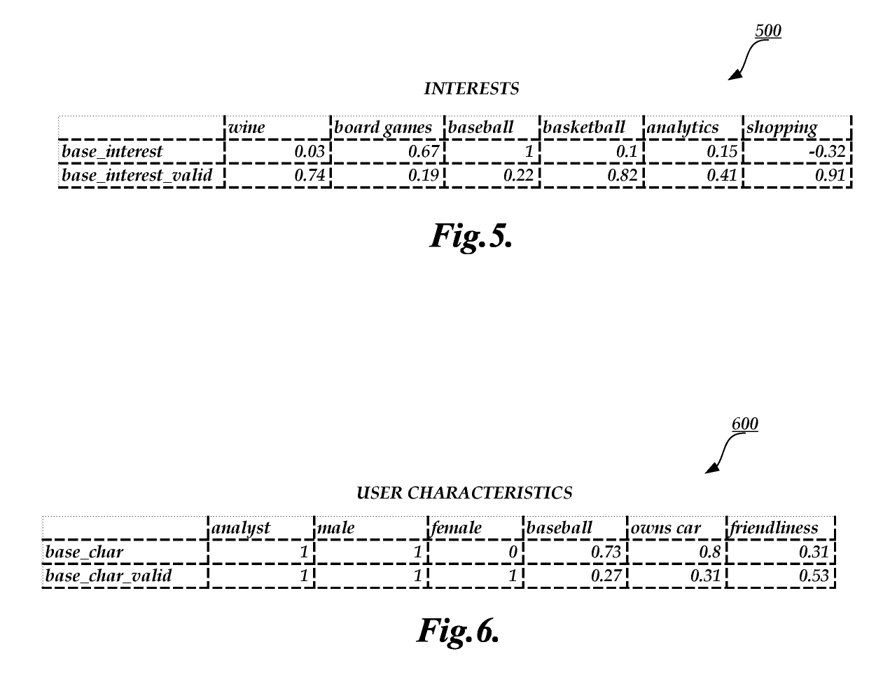

At block 404, an interpersonal networking and recommendation system determines Characteristics and Interests for a user based on past data and any currently available information. Illustrative embodiments of Characteristic and Interest data and determination processes and methods are discussed in more detail with reference to FIGS. 5-8 below. In one embodiment, an interpersonal networking and recommendation system may skip block 404 if it determines that Characteristic and Interest data for the user is up to date, for example if it has received no further relevant information about the user since last determining Characteristics and Interests. In one embodiment, at block 404 an interpersonal networking and recommendation system may further determine Characteristics and Interests for any other users associated with potential Recommendations. For example, an interpersonal networking and recommendation system determining Characteristics and Interest for an Attendee at a Networking Activity may further determine Characteristics and Interests for any or all Attendees at the same Networking Activity.

In the context of our continuing illustrative example, after determining that the user has not attended a Networking Activity in two weeks, the interpersonal networking manager 202 may retrieve any existing Characteristics and Interests along with any additional new data available regarding the user, and determine a current set of Characteristics and Interests for the user.

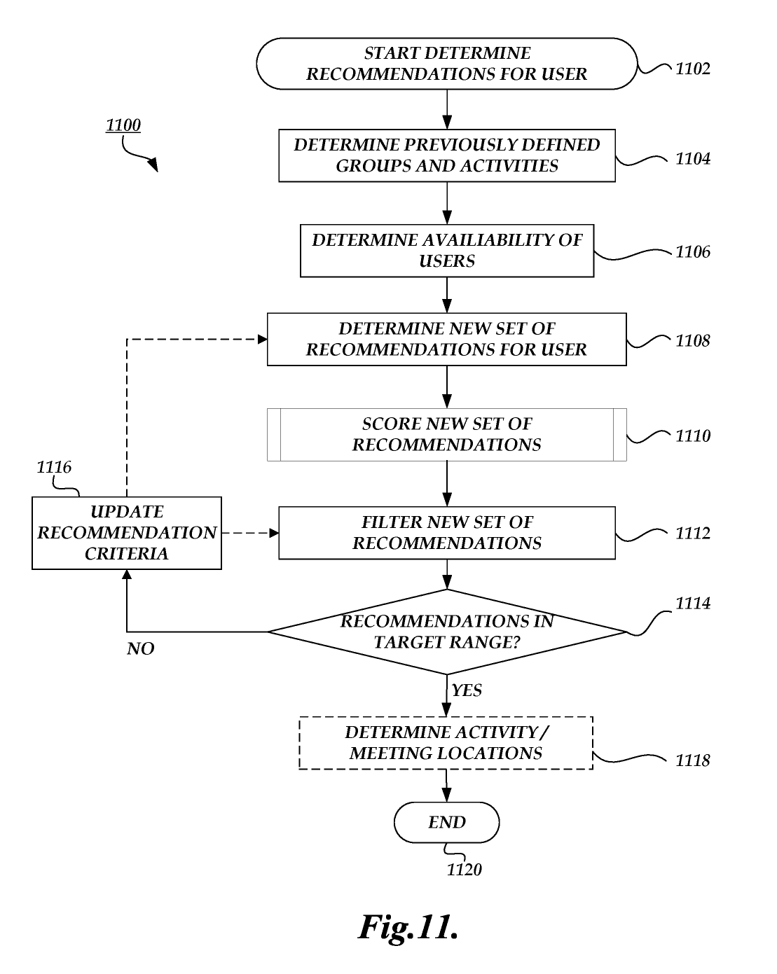

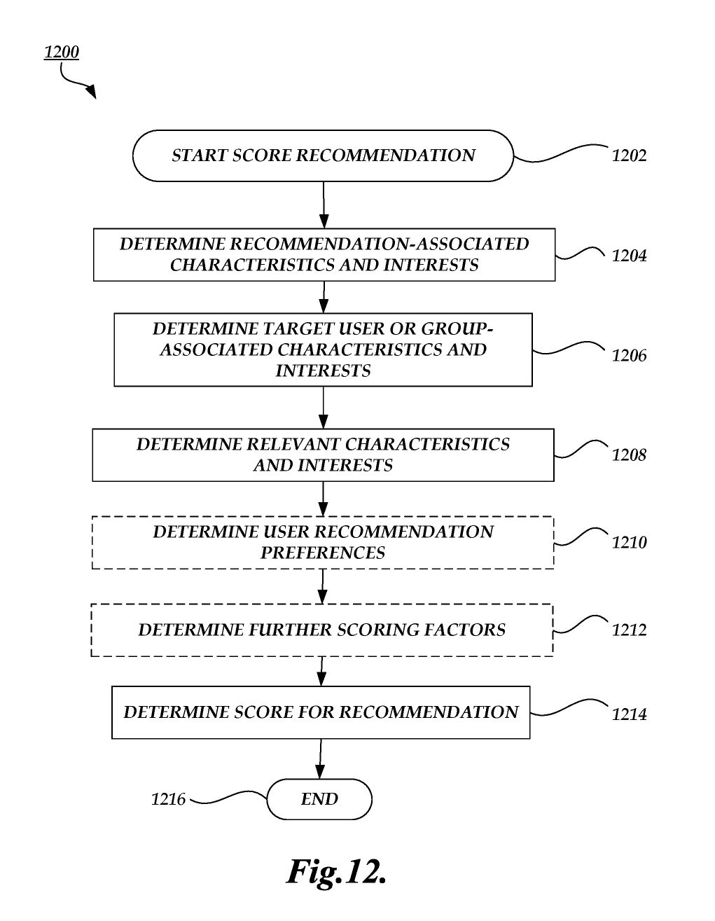

At block 406, an interpersonal networking and recommendation system process determines Recommendations for the user based on Characteristics and Interests data determined at block 404. In an alternate embodiment, the interpersonal networking and recommendation system process may determine Recommendations on the basis of Characteristics alone or on any other data relevant to the user. Illustrative embodiments of processes and methods for determination of user Recommendations is discussed in more detail with reference to FIGS. 11 and 12. Illustratively, Recommendations determined at block 406 may include recommendations for interpersonal introductions, group matching at a Networking Activity, potential Networking Activities, recommendations to host a new Networking Activity, conversation topics, or any other type of Recommendation as discussed above.

In the context of our continuing illustrative example, after determining Characteristics and Interest for the user in block 404, the interpersonal networking manager may determine Recommendations for upcoming Networking Activities appropriate for the user.

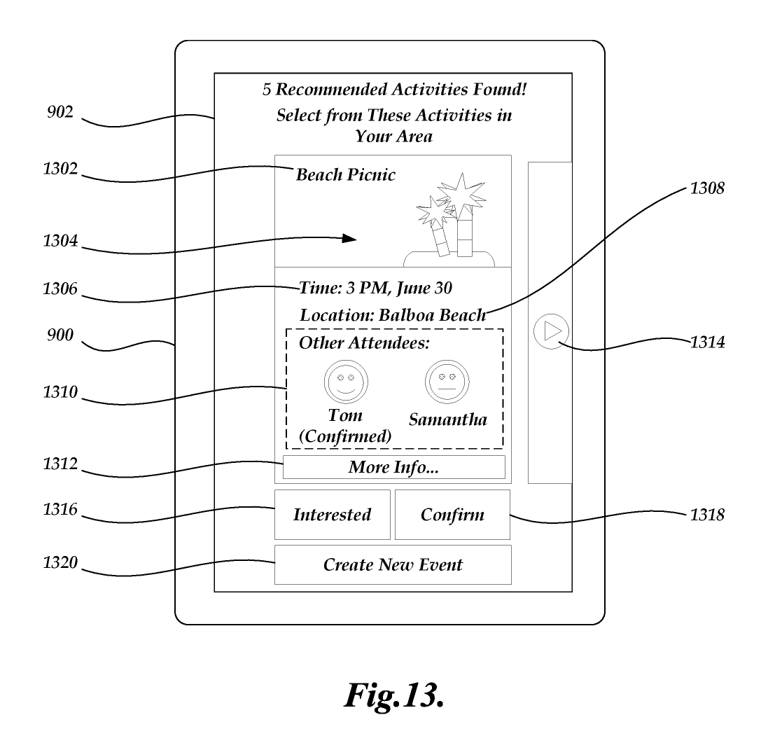

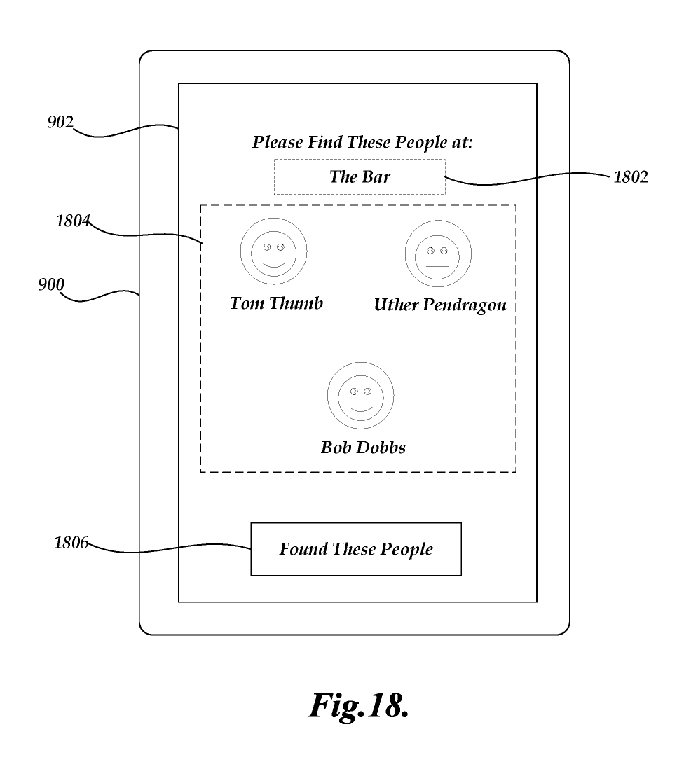

At block 408, an interpersonal networking and recommendation system process provides Recommendations determined at block 406 to the user. In one embodiment, Recommendations may be presented to a user on an associated computer, mobile or media device. In another embodiment, Recommendations may be presented to a user through an interpersonal networking interface provided through an alternate device such as interpersonal networking interface device 132 of FIG. 1. Illustratively, Recommendations may be provided to a user with accompanying information allowing a user to identify, find, and engage with any recommended groups or individuals or attend or host any recommended Networking Activities. Illustrative embodiments of interfaces for providing recommendations for Networking Activities and groups are discussed below with reference to illustrative FIGS. 13 and 18 Illustratively, multiple Recommendations may be provided in a list format displaying information on multiple recommendations or may be presented one by one to a user. In one embodiment, a user may be alerted to the presence of available Recommendations by an alert or message on an associated device.

In the context of our continuing illustrative example, after determining Recommendations for upcoming Networking Activities, interpersonal networking manager 202 may cause an alert on a mobile device associated with the user. User interaction with this alert may cause the mobile device to display the determined Recommendations for upcoming Networking Activities as a scrollable series of screens providing information about each recommended Networking Activities, as discussed below with reference to illustrative FIG. 13. Illustratively, some recommended Networking Activities may correspond to Networking Activities organized or hosted by an activity organizer associated with the interpersonal networking and recommendation system, some may correspond to Networking Activities organized or hosted by other system users, some may correspond to potential introductions suggested between the user and other system users (e.g. a suggestion of an informal lunch or dinner meeting), or some may correspond to suggestions that the user host a Networking Activity for a set of other users. For the purpose of this illustrative example, we may assume that the user selects and confirms or otherwise agrees to attend a recommended upcoming Networking Activity.

At block 410, the interpersonal networking and recommendation system process determines whether an interpersonal interaction occurred. Illustratively, and as discussed above, an interpersonal interaction may include any interaction or activity, including attendance at a Networking Activity, meeting a particular group of users or Attendees, an introduction to a specific user or Attendee, or any other meeting, introduction, or activity. For example, the interpersonal networking and recommendation system may determine that a user has attended a particular Networking Activity due to the user signing in by scanning a ticket or QR code, interacting with an interpersonal networking interface on an associated or public device, or otherwise signaling attendance at the activity.

In one embodiment, an interpersonal networking and recommendation system may determine that a user has met other users or participated in a suggested introduction or Networking Activity based on user feedback. In a further embodiment, the interpersonal networking and recommendation system may automatically assume the user has attended a particular Networking Activity or engaged with a particular group or individual after a prescribed amount of time. In other embodiments, the interpersonal networking and recommendation system may determine that a user has attended a particular Networking Activity or engaged with a particular group or individual through analysis of geolocation data, facial recognition or identification through camera data gathered at a Networking Activity, a check-in through a third-party event or social networking site, information entered by an event host or other user, RFID, NFC, or Wi-Fi detection of a mobile device associated with the user, voice identification of the user through gathered audio data, or any other means of identification. For example, an app associated with the interpersonal networking service may provide geolocation data (e.g. GPS or cell network triangulation location data) indicating that a user is standing with other users in a previously Recommended group. In one embodiment, a determination may be made that an interpersonal networking interaction did occur but no feedback is required. For example, if an interpersonal interaction is shorter than a determined period of time the interpersonal networking service may automatically proceed to block 416.

If an interpersonal networking and recommendation system determines that an interpersonal networking interaction did occur, it may continue to blocks 412 and 414 to gather feedback on the interpersonal interaction. Otherwise it may continue to block 416 to determine whether any additional recommendations are required.

In the context of our continuing illustrative example, after the user has confirmed or agreed to attend a Networking Activity, the user may arrive at the Networking Activity venue and check in by scanning a QR code associated with the Networking into a host device. In other embodiments, checking a user into an activity may correspond to selecting a name from a list, entering a code associated with the activity, or any other method. Checking in may alert the interpersonal networking manager 202 that the user is present at the Networking Activity. After determining that the user is present at the Networking Activity, the interpersonal networking may proceed to block 412.

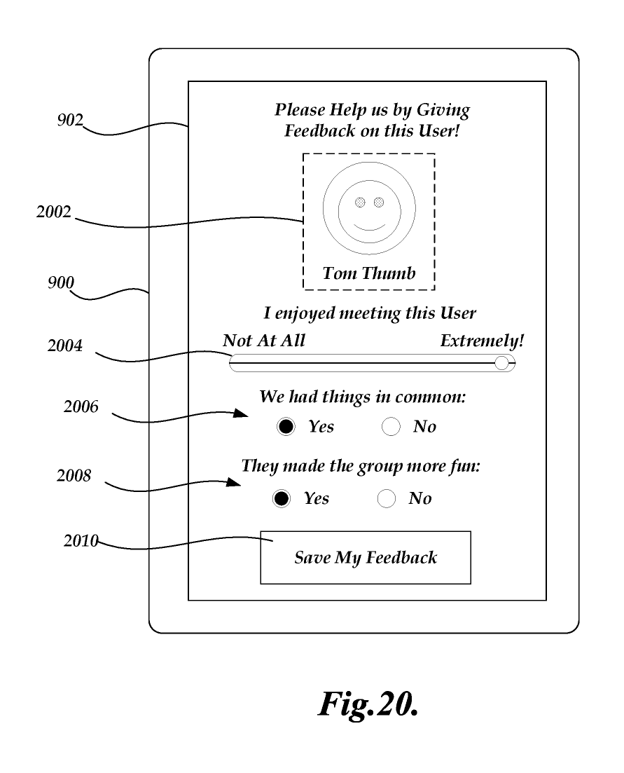

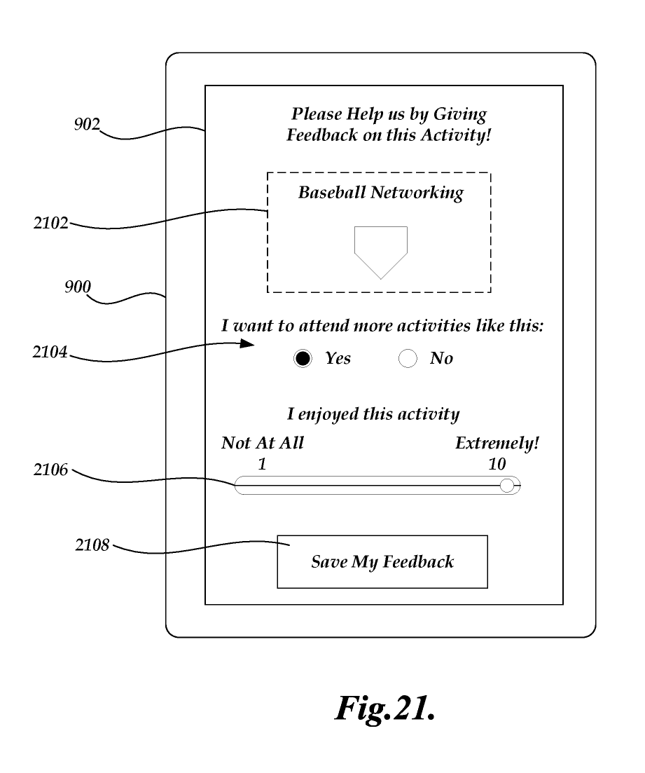

At block 412, an interpersonal networking and recommendation system process may request feedback from the user on the interpersonal interaction of block 410. For example, client device manager 208 described in FIG. 2 may request feedback by causing a device associated with a user or public interpersonal networking device or interface to display a feedback interface corresponding to the interpersonal interaction of block 410. Illustratively, a feedback interface may collect feedback on a Networking Activity, a group, an individual, a conversation topic or interpersonal suggestion, or any other interpersonal interaction. In one embodiment, a feedback interface may ask a user to rate their enjoyment or other aspects of an interpersonal networking interaction on a scale (e.g. using a series of radio buttons, slider, etc.). In another embodiment, a feedback interface may ask a user to compare attributes of different Networking Activities, groups, individuals or other interpersonal networking interactions (e.g. asking which user of two users was friendlier). In a further embodiment, a feedback interface may ask a user yes or no questions about their enjoyment or other aspects of an interpersonal networking interaction. Embodiments of feedback interfaces associated with individuals and networking activities are discussed in more detail with reference to illustrative FIGS. 20 and 21 below. In one embodiment, an interpersonal networking and recommendation system may wait for a prescribed or variable length of time after determining the occurrence of an interpersonal interaction before requesting feedback from the user.

In the context of our continuing example, after determining that the user has checked in at the Networking Activity, interpersonal networking manager 202 may wait until the scheduled end of the activity, and may then signal the client device manager 208 to cause a mobile device associated with the user to display a feedback interface asking for feedback on the Networking Activity and a random set of Attendees at the Networking Activity. For the purposes of this illustrative example, we may assume that the user enters feedback through a feedback interface which is transmitted back to the interpersonal networking manager 202.

At block 414, an interpersonal networking and recommendation system may request feedback from other users or Attendees. Illustratively, an interpersonal networking and recommendation system may cause any of the same feedback interfaces or requests as discussed with reference to block 412 to be presented before, after, or concurrently to other users or Attendees associated with one or more of the interpersonal networking interactions of block 410. For example, client device manager 208 described in FIG. 2 may cause feedback to be requested from Attendees previously engaged in a conversation with a first user by causing the Attendees' mobile devices or a public interpersonal networking device to display feedback interfaces requesting feedback on the first user. As discussed with respect to block 412, feedback may be collected on a Networking Activity, group, individual, conversation topic or interpersonal suggestion, or any other interpersonal interaction. In one embodiment, a interpersonal networking and recommendation system may cause similar or identical feedback requests or interfaces to be presented to all users or Attendees participating in an interpersonal interaction. In other embodiments, the interpersonal networking and recommendation system may cause different feedback requests or interfaces to be presented to different users or Attendees participating in the same interpersonal interaction. For example, an interpersonal networking and recommendation system may cause each user participating in an interpersonal interaction to be presented with a feedback interface corresponding to a different other user, or may cause different users to be presented with feedback interfaces corresponding to different aspects or characteristics of a particular Networking Event, Attendee, or group

In the context of our continuing example, concurrently with requesting feedback from the user in block 412, interpersonal networking manager 202 may cause other Attendees at the Networking Activity to be presented with an interface asking for feedback on the user. For the purpose of this example we may assume that feedback interfaces may be presented on mobile devices or computers associated with each Attendee, and that these other Attendees enter feedback which is transmitted back to interpersonal networking manager 202.

At block 416, an interpersonal networking and recommendation system process may determine whether any additional Recommendations are required at the present time. For example, if a user is currently attending a Networking Activity, an interpersonal networking and recommendation system may determine that there is time for additional introductions or group matchings before the activity has concluded. As another example, an interpersonal networking and recommendation system may determine additional recommendations are needed based on a period of time passing since the last Networking Activity that the user attended (e.g. two weeks). Illustratively, an interpersonal networking and recommendation system may determine that additional Recommendations are required and may proceed to block 404 before receiving feedback from all users in blocks 412 and 414. For example, in the context of a Networking Activity, an interpersonal networking and recommendation system may wait for feedback for a prescribed period of time (e.g. 2 minutes), and automatically proceed to block 404 to update user Characteristics and Interest and determine another set of Recommendations. In another embodiment, an interpersonal networking and recommendation system may wait to proceed until enough users are available from other interpersonal interactions to form new networking groups. In another embodiment, an admin or event host may determine how long to wait before proceeding to block 404. In a further embodiment, an interpersonal networking and recommendation system may wait until a user requests additional recommendations before proceeding to block 404.

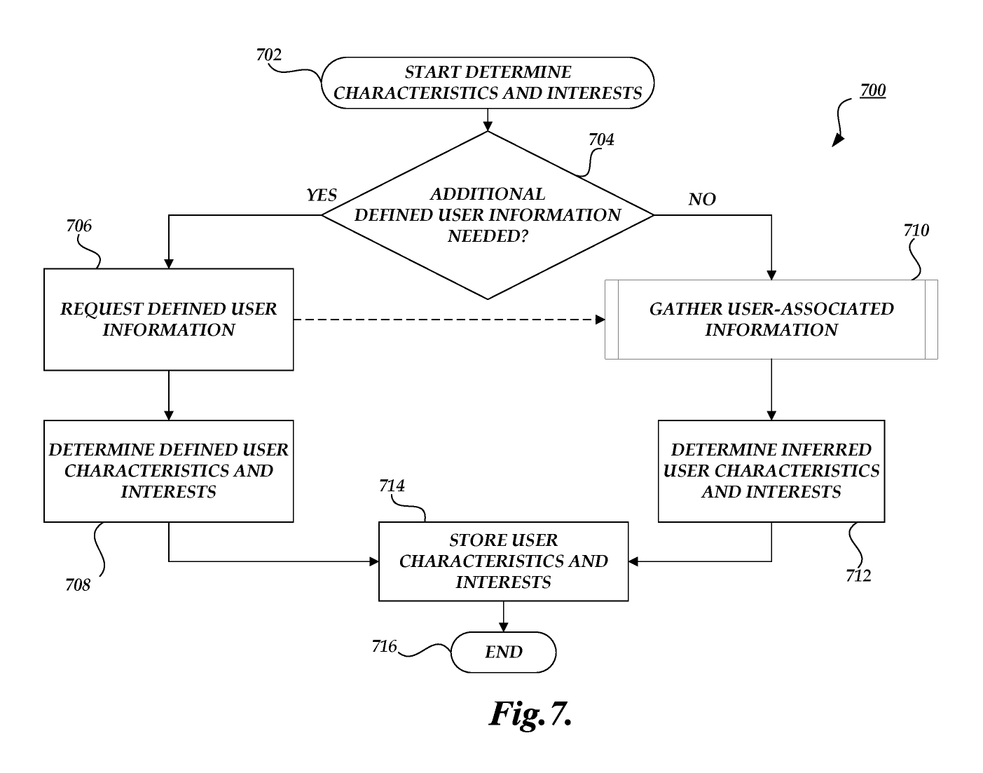

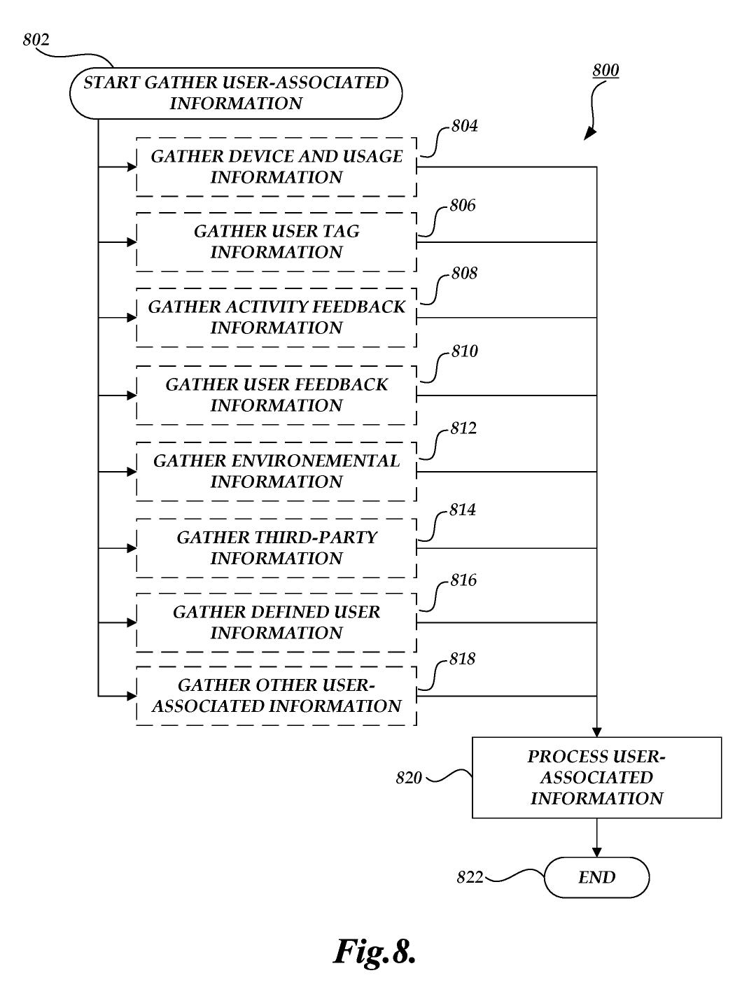

If an interpersonal networking and recommendation system determines that additional recommendations should be generated, it returns to block 404 to re-determine and update user Characteristics and Interests. Illustratively, at block 404, the process may process any feedback generated in blocks 412 and 414, along with new user-associated information as discussed with regards to illustrative FIGS. 7 and 8. Once updated user Characteristics and Interests have been determined, the process may continue to block 406 to determine a new set of Recommendations for the user.

At block 418, routine 400 ends having determined that no further Recommendations are required. Illustratively, routine 400 may be restarted at some future time, such as when triggered by a user request or by an interpersonal networking and recommendation system time-out.

To conclude our continuing example, after feedback has been received regarding the Networking Activity, interpersonal networking manager 202 may wait for another two weeks before determining that additional Networking Activity Recommendations should be presented to the user. Interpersonal networking manager 202 may return to block 404 and re-determine Characteristics and Interests, taking into account any additional user-associated information. For the purpose of this example, we may assume additional user-associated data includes feedback from the previous Networking Activity along with geolocation data received from the user's mobile device and recent social-network posts by the user and her friends. Interpersonal networking manager 202 may then proceed to block 406 and 408 to determine and present a new set of recommendations to the user.

FIG. 5 is a data diagram depicting an illustrative example of Interest values and validity weights 500 associated with an illustrative interpersonal networking and recommendation system user or Attendee. Illustratively, an interpersonal networking and recommendation system may define any number of different Interests. In one embodiment, Interest values may correspond to an attractiveness of an Interest to the user or Attendee, and corresponding validity weights may correspond to a validity of the Interest value. For example, as represented in Interest values and validity weights 500, an interpersonal networking and recommendation system may define a “wine” interest, a “board games” interest, a “basketball” interest, et al. For each Interest, an interpersonal networking and recommendation system may define Interest values (illustratively shown as values in the “base_interest” row), and an Interest validity weight (illustratively shown as values in the “base_interest_valid” row).

Illustratively, an Interest value may represent how attractive the interest is to the user. In one embodiment, Interest values greater than zero may indicate that the Interest category is attractive to the user, while Interest values less than zero may indicate that the Interest category is disliked by the user. For example, a high Interest value (e.g. closer to one) may indicate that the Interest category is very attractive to the user, while a low (e.g. closer to negative one) value may indicate that the Interest category is very unattractive to the user. In one embodiment, Interest values may be restricted to 1≧n≧−1 for ease of comparison. In other embodiments, Interest values may be represented by any other continuous or non-continuous numerical scale.

For the purpose of further illustration, an Interest validity weight may represent how well supported is (e.g. how much data exists to support) an Interest value. In one embodiment, Interest validity weights closer to one may indicate that an Interest value is better supported by extant data, while Interest validity weights closer to zero may indicate that an Interest value is less supported. For example, Interest validity weights may be used as a factor when comparing different Interest values to determine which value is more important. In one embodiment, validity weights may be restricted to 1≧n≧0 for ease of comparison. In other embodiments, validity weights may be represented by any other continuous or non-continuous numerical scale.

In various embodiments, an interpersonal networking and recommendation system may use Interest values only, and may not use Interest validity weights as a separate value. For example, an interpersonal networking and recommendation system only using Interest values may be the functional equivalent of a setting all Interest validity weights to one or some other equal value. In other embodiments, an interpersonal networking and recommendation system may combine Interest values and Interest validity weights into a single value representing a validity-weighted value. For example, an interpersonal networking and recommendation system may multiply an Interest value with an Interest validity represented as a continuous value between zero and one to obtain a single validity-weighted value.

FIG. 6 is a data diagram depicting an illustrative example of Characteristic values and validity weights 600 associated with an illustrative interpersonal networking and recommendation system user or Attendee. Illustratively, an interpersonal networking and recommendation system may define any number of different Characteristics. In one embodiment, Characteristic values may correspond to the strength of the Characteristics in the user or Attendee, and corresponding validity weights may correspond to a validity of the Characteristic value. For example, as illustrated by Characteristic values and validity weights 600, an interpersonal networking and recommendation system may define “male”, “female”, and “friendliness” Characteristic categories, et al. For each category of Characteristic, an interpersonal networking and recommendation system may define various values such as a Characteristic value (illustratively shown as values in the “base_char” row), and a Characteristic validity weight (illustratively shown as values in the “base_char_valid” row).

Illustratively, a user Characteristic value may represent how strong the Characteristic is in the user. For the purpose of illustration, a high Characteristic value (e.g. closer to one) may indicate that the user exhibits a Characteristic strongly, while a low (e.g. closer to zero) value may indicate that the user exhibits a Characteristic weakly. For example, with reference to Characteristic values and validity weights 600, an illustrative user has a “male” Characteristic with a value of 1, indicating that the user is male, a “baseball” Characteristic with a value of 0.73, indicating that the user exhibits the “baseball” characteristic fairly strongly, and a “friendliness” Characteristic with a value of 0.31, indicating that the user exhibits the “friendliness” Characteristic somewhat weakly. In one embodiment, Characteristic values may be restricted to 1≧n≧0 for ease of comparison. In other embodiments, Characteristic values may be represented by any other continuous or non-continuous numerical scale.

For the purpose of further illustration, a Characteristic validity weight may represent how well supported is (e.g. how much data exists to support) a Characteristic value. Illustratively, Characteristic validity weights closer to one may indicate that the Characteristic values are better supported by extant data, while Characteristic validity weights closer to zero may indicate that the Characteristic values are less supported. For example, with reference to Characteristic values and validity weights 600, an illustrative user may have a “male” Characteristic validity of 1, indicating that we are certain that the Characteristic value of 1 is accurate, but may have a “baseball” Characteristic validity with a value of 0.27, indicating that we are not very sure whether the “baseball” Characteristic value of 0.73 accurately represents the user. Illustratively, Characteristic validity weights may be used as a factor when comparing Characteristic values to determine which value is more likely to be accurate.

In various embodiments, an interpersonal networking and recommendation system may only use Characteristic values, and may not use Characteristic validity weights as a separate value. For example, an interpersonal networking and recommendation system only using Characteristic values may be the functional equivalent of a setting all Characteristic validity weights to one or some other equal value. In other embodiments, an interpersonal networking and recommendation system may combine Characteristic values and Characteristic validity weights into a single value representing a validity-weighted value. For example, an interpersonal networking and recommendation system may multiply a Characteristic value with a Characteristic validity represented as a continuous value between zero and one to obtain a single validity-weighted value.

Illustratively, Characteristic and Interest values and weights may be determined from various user data generated or obtained by an interpersonal networking and recommendation system. Illustrative routines and methods for determining Characteristic and Interest values and validity weights are discussed in further detail below with reference to illustrative FIGS. 5-6.

FIG. 7 is a flow diagram depicting an illustrative routine 700 for determining Characteristics and Interests for a user or Networking Activity Attendee. In one embodiment, routine 700 may be implemented or performed by components of an interpersonal networking and recommendation system such as depicted above at least with reference to illustrative FIGS. 1-3, et al. In one embodiment, interface elements and routine blocks discussed with reference to FIG. 7 may be implemented, displayed, or executed on a computing device 102 with reference to illustrative FIG. 1 or interpersonal networking manager 202 with reference to illustrative FIG. 2. Illustratively, various interfaces and processes of illustrative routine 700 may further be performed on any combination of various other devices or services such as interpersonal networking interface device 132, user devices 106 or 108, or user computing device 302 as discussed with reference to FIGS. 1 and 3, respectively. In one embodiment, aspects or blocks of routine 700 may be performed by an automated or semi-automated process associated with client computing device 102 or interpersonal networking manager 202. Aspects of routine 700 may be performed in response to specific interactions or commands by a user or process. In yet another embodiment, aspects of routine 700 may be implemented on a continuous basis. It will be appreciated by one skilled in the relevant art that various aspects or blocks of routine 700 may be performed concurrently, sequentially, or at different times and in response to different events or timings. For example, in one embodiment an interpersonal networking and recommendation system may gather user associated information from a user device or other instrumentalities at block 710 concurrently with a user entering defined user information at blocks 706 and 708.

As discussed above with reference to Characteristics and Interests, in an alternate embodiment an interpersonal networking service may only utilize user Characteristics and not a separate category of Interests. In this case, routine 700 may be modified to gather data and determine defined and inferred Characteristics but not determine user Interests.

Returning to FIG. 7, illustrative routine 700 may begin at block 702 responsive to a signal that a user's Characteristics or Interests may have changed. For example, illustrative routine 700 may begin at block 702 responsive to a determination by interpersonal networking manager 202 that additional information associated with a user is available. In one embodiment, routine 700 may be triggered as part of block 404 with reference to FIG. 4.

At block 704, an interpersonal networking and recommendation service process may determine whether additional defined information is needed from a user. This determination may be based on what defined user information has been gathered from the user in the past and what additional defined user information could be gathered from the user currently. For example, interpersonal networking manager 202 may determine that a user has previously filled out a user profile and defined user information, and that it is not necessary to gather any additional user information from the user. As another example, in the case of a new user account or an incomplete profile, interpersonal networking manager 202 may determine that there is additional defined user information needed.

If additional defined user information is needed, illustrative routine 700 moves to block 706 to request defined user information. If no further additional defined user information is needed at the present time, illustrative routine 700 moves to block 710 to gather user-associated information.

At block 706, if further defined user information is needed, an interpersonal networking service and recommendation process may request defined user information from the user. Illustratively, defined user information may be requested from through one or more user interface presented to the user by a computer, mobile device, or other device associated with the user. For example, interpersonal networking manager 202 may cause a mobile device such as user computing device 302 (with reference to illustrative FIG. 3) associated with the user to display an interface for selecting or entering user information. Illustrative examples of interfaces for selecting or entering user information are discussed below with reference to illustrative FIG. 9. In various embodiments, interfaces for selecting or entering user information may allow users to enter free data such as strings or values, select values from a selection control such as a combo-box, dropdown, slider, toggle, checkbox, radio-button, or selectable button quilt, add custom or predefined tags, or enter user information utilizing any other interface components or controls as known in the art, or in any other way.

Illustratively, defined user information may include any type of information helpful for generating or defining user Characteristics and Interests for interpersonal networking. For example, interfaces presented to a user may request biographical data; professional data; data on hobbies and pastimes; food, drink and entertainment preferences; romantic or friend preferences; questions designed to determine personality characteristics (e.g. openness, neuroticism, friendliness, sense of humor, etc.); or any other type of information. Illustratively, a number of interface pages may be presented to a user to determine any necessary defined user information. In some embodiments, particular categories, pages, or items of defined user information may be optional for a user to enter or select, while others may be required before moving on with routine 700. Once the user has entered any required defined user information, defined user information may be passed to block 710 of routine 700 where it may be gathered, processed, or combined along with other user-associated information. Routine 700 then proceeds to block 708 to determine defined characteristics and interests.

At block 708, an interpersonal networking and recommendation service process determines user Characteristics and Interests based on defined user information gathered at block 706 or previously stored. Illustratively, and as discussed above with reference to illustrative FIGS. 5 and 6, Characteristics and Interests may be defined as numerical values for the purpose of storage and later processing. Illustratively, to determine defined user Characteristics and Interests values and validity weights from defined user data, the defined user data may be processed in one or more ways to generate numerical values.

Illustratively, defined user data may be processed according to a set of logical rules to generate Characteristic values or Interest values. In one embodiment, an interpersonal networking and recommendation system may set Characteristic values or Interest values as one or zero based on a set of Boolean rules associated with the defined user data. For example, as discussed with reference to illustrative FIGS. 5 and 6, an illustrative interpersonal networking and recommendation system may define an “analyst”, “male”, and “female” Characteristic. In the context of this example, an illustrative interpersonal networking manager 202 associated with the interpersonal networking and recommendation system may apply a rule that sets the “male” Characteristic to a value of 1 with a validity weight of 1 and the “female” Characteristic to a value of 0 with a validity weight of 1 responsive to the user entering “Male” in a gender field on a biographic user data interface such as discussed with reference to FIG. 9. Further in the context of this example, illustrative interpersonal networking manager 202 may define a rule that sets the “analyst” Characteristic to a value of 1 with a validity weight of 1 responsive to the user entering any of a set of previously defined profession titles associated with the “analyst” characteristic into the “Title” field of an illustrative professional user data interface (not shown). Specifically, for the purpose of this continuing example, we may assume that a set of professional titles such as “Commodity Analyst,” “Foreign Markets Analyst,” and “Equity Researcher” have all been defined as associated with the “analyst” characteristic, and that the user has entered “Commodity Analyst” into the “Title” field of an illustrative professional user data interface.

Illustratively, logical rules to generate defined Characteristic values or Interest values may be defined by interpersonal networking and recommendation system admins or users or may be automatically determined based on stored user data. Although for the purposes of the above example rules are applied to set illustrative Characteristic values and validity weights to zero or one, in various embodiments any number of different logical rules may cause a system to set or apply one or more arithmetic operation to any combination of Characteristic or Interest values or validity weights. Accordingly, in various embodiments, Characteristic or Interest values or validity weights may be set to any decimal or real number value.

Having determined defined Characteristics and Interests, routine 700 proceeds to block 714 to store Characteristic and Interest information. Block 714 is discussed further below.

Returning to block 704, if it is determined that no additional defined user information is needed, routine 700 proceeds to block 710.

At block 710, an interpersonal networking and recommendation service process may gather other information associated with a system user. Illustratively, various types or sets of user-associated data may be collected by any number of different devices, components, or instrumentalities associated with an interpersonal networking and recommendation system. Although gathering user-associated information is described as a single block 710, in various embodiments one or more aspects, methods, sub-processes, or steps of block 710 may be performed at various points or continuously throughout parts of routine 700. It is important to note that collection of data associated with a user or Attendee may occur at any point during routine 700 or during any other routine or process associated with an interpersonal networking and recommendation system. For example, various types of user-associated data may be collected continuously from a user device or other data channel or system component and stored by interpersonal networking manager 202 for gathering in block 710 or later use in determining inferred user Characteristics and Interests. In some embodiments, information associated with a system user may include defined user information requested from block 706. An illustrative routine for gathering user-associated information is discussed with more detail with reference to FIG. 8.

Illustratively, user-associated information may be qualitative or quantitative and may include any number of numerical values (e.g. decimal, integer, etc.), weights, data sets or series, non-numerical data types such as text strings or Boolean values, or any other type of data.

At block 712, an interpersonal networking and recommendation service may process user-associated information gathered at block 710 or otherwise stored to determine inferred user Characteristics and Interests.

In one embodiment, user data may be processed according to a set of rules or weights to generate Characteristic values or Interest values. As a specific illustrative example, an interpersonal networking and recommendation system may define a “basketball” Characteristic and a “board games” and “baseball” interest, as discussed with reference to illustrative FIGS. 5 and 6. In the context of this example, a user may have submitted a value of “10-Enjoyed Extremely” regarding a Networking Activity at a Baseball game. For the purpose of this example, an illustrative interface for submitting Networking Activity feedback is discussed below with reference to illustrative FIG. 21. Illustratively, Networking Activity feedback may be associated with one or more Characteristic or Interest weight. We may assume for this example that interpersonal networking manager 202 weights Networking Activity feedback on a continuous scale between “1—Did Not Enjoy” and “10—Enjoyed Extremely.” We may further assume for purposes of this illustrative example that interpersonal networking manager 202 determines, based on this illustrative continuous scale, that addition of a value of 0.8towards the “baseball” Interest, a value of 0.3 towards the “basketball” Characteristic, and 0.1 towards the “board games” Interest is the result of the feedback “10—Enjoyed Extremely”

To continue this example, interpersonal networking manager 202 may further define a number of areas of interest that may be selected by a user through selecting buttons on an interface (not shown). Illustratively and for the purpose of this example, we may assume the selectable button interface was presented to the user to request defined user information in block 706 of routine 700. We may assume for the purposes of our example the selectable button interface includes “Games” selectable button, and weights selection of the “Games” button as contributing a value of 0.57 towards the “board games” Interest, a value of −0.2 towards the “basketball” Characteristic, and a value of 0.3 towards the “baseball” Interest.

For the purpose of our example, we may assume that the user enters a feedback value of “10—Enjoyed Extremely” with reference to the Baseball Networking Activity, and selects “Games” from the selectable button interface as described above. In the context of this example, interpersonal networking manager 202 may process this data. including adding the weight values associated with each piece of data to determine that the users baseball Interest is 0.8+0.3=1.1, the users “basketball” Characteristic” is 0.3+(−0.2)=0.1, and the users “board games” interest is 0.1+0.57=0.67.

In one embodiment, Interest values may be restricted between 1≧N≧−1 for ease of comparison. Illustratively, this may be achieved by rounding Interest values down to one or up to negative one when an Interest value potentially exceeds this range. In the context of our illustrative example, interpersonal networking manager 202 may set the users baseball Interest to 1 from the computed value of 1.1. Illustratively, Characteristic values may be similarly rounded to maintain a restricted range (e.g. 1≧N≧0). In other embodiments, Interest and Characteristic values may have a different permitted range or no range at all, and may be restricted to their permitted way by a number of alternate or additional mathematical techniques as known in the art.

For the purposes of illustration, rule categories such as a set of defined professions, logical rules, or weights used in the above specific illustrative example may be entered, managed, or curated by an interpersonal networking and recommendation system admin or user, or determined by analyzing user responses. For example, in one embodiment, rule categories may be entered or determined by an interpersonal networking and recommendation system admin or user. In a further embodiment, the weights associated with each rule category may be automatically generated by comparing Characteristics or Interests of existing users to their profession. In the context of our above illustrative example, interpersonal networking manager 202 may have determined that the average “board games” Interest of all extant users that have selected the “Games” option on a selectable button interface have a value of 0.57, and so may have set the weight of the “Games” position as contributing 0.57 towards the “board games” Interest. In various further embodiments, logical rules or modification rules may be associated with one or more type, value, aspect, or category of information and may be applied to modify Characteristics and Interests at block 712. Additional illustrative embodiments of user-associated data and embodiments of associated rules, weights, and processes for modifying Characteristics and Interest values are discussed further below with reference to illustrative FIG. 8.

Illustratively, in various embodiments an interpersonal networking and recommendation system may further assign validity weights to Characteristics and Interests as described with reference to illustrative FIGS. 5-6. Illustratively, some Characteristic or Interest categories may be assigned weight values of zero or one only, in situations when an interpersonal networking and recommendation system is certain of the validity of the Characteristic or Interest. For example, a “male” or “female” characteristic may always be assigned a validity weight of one where the value is definitively known. Further, for the purpose of illustration, validity weights may be assigned to other Characteristic or Interest categories as a continuous value on the basis of the total number of pieces of data contributing towards the Characteristic or Interest value. For example, an interpersonal networking and recommendation system may assign a validity weight to a Characteristic or Interest value on the basis of the equation N divided by N+A, where N is the number of pieces of data or number of logical rules contributing a non-zero value towards the Characteristic value or Interest value, as discussed above, and where A is an arbitrary positive value. In one embodiment, a value of 5 for A may yield satisfactory results. For example, in the context of the above example referencing the “Commodity Analyst” user, we may determine that the “baseball” Interest has only two logical rules contributing non-zero values (e.g. the rule based on the Networking Activity feedback and the “Games” selection by the user). In this example, interpersonal networking manager 202 may apply the above equation to assign the “baseball” Interest a validity weight of 2 divided by (2+5), yielding a validity weight of 0.29.

Although a number of different algorithms, equations, data sets, and examples are discussed above, these represent specific illustrative embodiments for the purpose of illustration, clarification, and example only. It should be understood that a number of different mathematical techniques exist for determining values and weights from data, and the above examples in no way limit the scope of routine 700 or other processes to the illustrative embodiments herein described. For example, a logical rule may increase or decrease a Characteristic or Interest value or validity weight by a fixed value when a data value or min, max, mean, median, or mode of a data set or series exceeds, meets, or fails to reach a fixed threshold value. As another example, a logical rule may increase or decrease a Characteristic or Interest value or validity weight as a percentage, logarithm, exponent, or power of a data value, or min, max, mean, median, or mode of a data set. As a further example, a logical rule may cause a Characteristic or Interest value or validity weight to be incremented, decremented, or set to a fixed value if a particular mathematical or Boolean condition is met.

FIG. 8 is a flow diagram depicting an illustrative routine 800 for gathering information associated with a user or Networking Activity Attendee. Illustratively, routine 800 may be implemented or performed by components of an interpersonal networking and recommendation system such as depicted above at least with reference to illustrative FIGS. 1-3, et al. In a further embodiment, interface elements and routine blocks discussed with reference to FIG. 8 may be implemented, displayed, or executed on a computing device 102 with reference to illustrative FIG. 1 or interpersonal networking manager 202 with reference to illustrative FIG. 2. Illustratively, various interfaces and processes of illustrative routine 800 may further be performed on any combination of various other devices or services such as interpersonal networking interface device 132, user devices 106 or 108, or user computing device 302 as discussed with reference to FIGS. 1 and 3, respectively. In one embodiment, aspects or blocks of routine 800 may be performed by an automated or semi-automated process associated with client computing device 102 or interpersonal networking manager 202. Aspects of routine 800 may be performed in response to specific interactions or commands by a user or process. In yet another embodiment, aspects of routine 800 may be performed in response to an automatic process or trigger, or implemented on a continuous basis. It will be appreciated by one skilled in the relevant art that various aspects or blocks of routine 800 may be performed concurrently, sequentially, or at different times and in response to different events or timings. For example, in one embodiment user-associated information may be processed at block 820 as it is received by an interpersonal networking manager 202 and concurrently with gathering information in blocks 804-818. Illustratively, any of blocks 804-818 may be performed simultaneously or in any order based on the availability of different sources of data. Still further, any processing as discussed with regards to block 820 or embodiments of a Characteristic or Interest determination process such as discussed with reference to block 712 of FIG. 7, et al. may be performed in any order respective to blocks 804-818. For example, an illustrative interpersonal networking and recommendation service may modify a first set of user Characteristic or Interest values based on a first set of data gathered at one or more of blocks 904-918 and may subsequently modify a second set of user Characteristic or Interest values based on a second set of data gathered at one or more of blocks 904-918.

While routine 900 provides a number of blocks 904-918 for gathering different types of user-associated information, it should be recognized that, in various embodiments, data gathered in blocks 904-918 may have been collected at a number of different times or throughout a number of different time periods. Although data collection may be a part of routines, processes, or steps described with reference to blocks 904-918, such data collection is not restricted to any process, routine, step, or time period described herein. Further, collection of various types and sets of user-associated information may be performed by or on behalf of any devices, instrumentalities, agents, processes, channels, or services herein described, and are not limited to any of the same illustrative devices, instrumentalities, or processes discussed with respect to gathering information in blocks 904-918. Data collected by various devices and at various times may be stored or managed by any combination of interpersonal networking and recommendation system devices, processes, components, or services such as discussed above and with reference to illustrative FIGS. 1-3. For example, device data associated with a particular user device may be collected and stored in memory or storage associated with the particular user device until it is transferred to and gathered by an interpersonal networking manager or other service in illustrative block 804 discussed below. As another illustrative example, user-associated data such as user tag data may in one embodiment be transferred to the interpersonal networking manager as it is collected and may be gathered in illustrative block 806 as discussed below.

In the context of FIG. 8, at block 820 illustrative routine 800 may process data gathered in blocks 804-818, including combining, modifying, deleting, cleaning, normalizing, or otherwise modifying or culling data into a form that may be used to determine user Characteristics, Interests, or Recommendations. For example, at block 820 interpersonal networking manager 202 of FIG. 2 may process data various sets or values of data gathered in one or more of blocks 804-818 utilizing any one or combination of mathematical techniques such as taking a moving average; determining a standard deviation, distribution, regression value, or other statistical value; determining a max, min, mean, weighted-mean, mode, or median; performing one or more arithmetical operations on values of sets of values; or any other arithmetic, statistical, or set operation. In some embodiments, various data gathered in blocks 804-818 may not be processed or modified at block 820. Although gathered information is discussed in illustrative examples below in the context of determining user Characteristics and Interests, it should be understood that any specific examples of illustrative gathered data may include or refer to gathered data that has been processed as described above with reference to block 820. Further, logical rules, weights, and values described with reference to any specific examples provided herein are provided for purposes of illustration only, and various other logical rules, weights, and values may be used in other embodiments and may be defined by various means, including by system admins, user, or automatically. An illustrative example of Characteristic or Interest value and validity weight determination is discussed above with reference to block 712 of illustrative routine 700.

Returning to FIG. 8, illustrative routine 800 may begin at block 802 responsive to a request for updated user-associated information. For example, illustrative routine 800 may begin at block 802 responsive to a determination by interpersonal networking manager 202 that updated user Characteristics or Interests are required, and additional user-associated information should be gathered. As another example, illustrative routine 800 may begin at block 802 responsive to a determination by interpersonal networking manager 202 that additional user-associated information has been collected, stored, or is otherwise available. In one embodiment, routine 800 may be triggered as part of block 710 with reference to FIG. 7.

Routine 800 may proceed from block 802 to any number or combination of different optional data gathering blocks 804-818. Illustratively, processes and steps described with reference to blocks 804-818 may be performed simultaneously, concurrently, or in any order. Although each of blocks 804-818 is described here for purposes of illustration, in various embodiments routine 800 may skip or not implement any block, process, or step herein described. Illustratively, data gathered in each of blocks 804-818 may have been previously stored in a storage medium accessible to an interpersonal networking and recommendation system component such as interpersonal networking manager 202 with reference to illustrative FIG. 2. In one embodiment, any number of other processes or components may be gathering and storing or otherwise making accessible user-associated information described with reference to blocks 804-818.

At block 804, an interpersonal networking and recommendation system may gather device and usage information. Illustratively, device and usage information may include information associated with the properties or usage of a device associated with a user, such as user devices 106 and 108 or user computing device 302 with reference to FIGS. 1 and 3, respectively. In another embodiment, device and usage information may include information associated with the properties or usage of a device interacted with by a user, such as interpersonal networking interface device 132.

Illustratively, device information may include any value, property, set, or collection of data associated with the properties of a device, such as a device battery life; a device radio connection; the presence or absence of particular hardware or software features; the type, version, or feature set of particular hardware or software features; motion sensors, cameras, microphones or other sensors; an operating system, firmware, BIOS, or hardware set version; a device model, make, serial number, or version; a screen size or type; the presence or absence of particular apps or software; software versions of installed apps or software; settings or saved data associated with installed apps or software; device storage space; device memory; device processor speed; antenna type (e.g. CDMA or GMA); user accounts enabled for the device; types, numbers, and content of files stored on the device; or any other property or data set associated with the device. Illustratively, device information may be collected through one or more processes, apps, or routines implemented on a target device. In one embodiment, collected device information may be stored on the device or through other components of an interpersonal networking and recommendation system, such as interpersonal networking manager 202, until gathered in block 804. For example and with reference to illustrative FIG. 3, device information or other user-associated information may be provided to interpersonal networking manager 202 by a user process such as user processes 326 or 328 running on user computing device 302 and may be stored in a data store such as user data store 204. Illustratively, a user process running on a device may provide any combination or set of data associated with the device, or may be limited by device security or access restrictions to a subset of properties of the device that it may access.

As discussed with reference to block 712 of illustrative routine 700, an interpersonal networking and recommendation system may process various pieces or aspects of information in order to determine user Characteristics and Interests. As an illustrative example, an interpersonal networking and recommendation system may define a list of expensive models of mobile devices. In the context of this example, a device information indicating that the user is interacting with the interpersonal networking and recommendation system through one of the devices on the defined list may cause interpersonal networking manager 202 to add a positive value to an “owns car” user Characteristic as part of an illustrative Characteristic determination process such as discussed with reference to block 712. As another example, an interpersonal networking app running on a mobile device associated with a user may determine that a chess app is installed on the mobile device and transmit this information to interpersonal networking manager 202, which may store this information in user data store 204. In the context of this example, user data store 204 may later gather this information from user data store 204, and may, based on this data, add a positive value to a “chess” user Characteristic and a “board games” Interest as part of an illustrative Characteristic and Interest determination process such as discussed with above reference to block 712.

Illustratively, usage information may include any value, property, set, or collection of data associated with the usage of a device or associated software or hardware, such as a user accessing particular software or hardware features (e.g. particular apps, camera, etc.); usage of associated or third-party apps; user clicks, touches, text or value entry, device movement, or other device interface interactions; turning a device off or putting it to sleep; metadata and content of telephone or video calls; recording or utilization of speakers or microphone; saving or accessing of application files; logging in or out of a device; changing device or app settings; or any other device usage.

For the purpose of an illustrative example, user device 106 with reference to FIG. 1 may store a record of the number of times that a user checked an e-mail app on his user device 106 during an interpersonal interaction, such as a conversation with a Networking Activity Attendee. User device 106 may transmit this record to interpersonal networking manager 202 with reference to FIG. 2. For the purpose of this example, we may assume that as part of an illustrative Characteristic and Interest determination process such as discussed with above reference to block 712 and FIG. 7 above, interpersonal networking manager 202 may determine that the number of times that the user checked his e-mail during the interpersonal interaction is greater than an predefined threshold value (indicating lower interest) and add −0.2 to an Interest value for the user corresponding to the Networking Activity Attendee.

As another illustrative example, interpersonal networking manager 202 may receive usage data corresponding to an interpersonal networking and recommendation system app installed on user computing device 302 with reference to FIG. 3. For this example, we may assume that the usage data corresponds to an amount of time taken to fill out a user profile on the app, that the usage data is stored in user data store 204 associated with interpersonal networking manager 202, and that the data is gathered as part of block 804. For the purpose of this example, we may assume that as part of an illustrative Characteristic and Interest determination process such as discussed with above reference to block 712 and FIG. 7 above, interpersonal networking manager 202 may determine that the amount of time taken to fill in the profile is less than an predefined threshold value (indicating possible technological proficiency) and add 0.1 to a “technology” Characteristic value associated with the user.

Although the above examples of device and usage data are described for purpose of clarity and illustration, in various embodiments any types, formats, or sets of data associated with a device or device usage may be collected, stored, or gatherd by an interpersonal networking and recommendation system. In various embodiments, device and user data may be collected at any time and stored on a user device or an interpersonal networking and recommendation system service or device such as interpersonal networking manager 202. Various values, pieces, or sets of data gathered as part of block 804 may be combined with each other or with values, pieces, or sets of data gathered in other parts of routine 800 and may be processed or analyzed alone or in any combination in an illustrative Characteristic and Interest determination process such as discussed with reference to FIG. 7 above.

At block 806, an interpersonal networking and recommendation system may gather user tag information. Illustratively and as discussed above, in one embodiment of an interpersonal networking and recommendation system, a user may be able to add metadata tags to their own profile, and may further be able to associate various public or private metadata tags with other system users or Attendees. For example, a user interested in finance and badminton might add a “finance” and a “badminton” tag to her profile. In the context of this example, she may further be able to add a “cats” tag to the profile of an Attendee she meets after learning that he owns several cats. In one embodiment, tags added to the profile of another individual may be public to all interpersonal networking and recommendation system users. In another embodiment, tags added to the profile of another individual may be private to the user who added the tag or private to a particular group or set of users. Illustrative interfaces and discussion of tags and tagging are included in more detail below with reference to FIGS. 9 and 19 et al.

Returning to block 706, an interpersonal networking and recommendation system may gather tag information including all or a subset of existing private or public metadata tags associated with one or more interpersonal networking and recommendation system users. Illustratively, gathered tag information may be processed or analyzed alone or in any combination with other data in an illustrative Characteristic or Interest determination process such as discussed with reference to FIG. 7 above. Illustratively, tag information gathered at block 806 may be utilized in an illustrative Characteristic or Interest determination process as the basis of a modification or setting of Characteristic or Interest values associated with the user or Attendee adding the tag or the user or Attendee to which the tag is added.

For the purpose of an illustrative example, at block 806, tag information associated with an interpersonal networking and recommendation system user and stored by interpersonal network manager 202 with reference to FIG. 2 may be gathered. For this example, we may assume that the user has tagged their own profile with a “hedge fund” tag and a “technical analysis” tag, and we may further assume that a second user has privately tagged the user's profile with a “chess” tag. We may further assume that the second user has a high “chess” Characteristic. In the context of this example, the user's tags and the second user's tags may be gathered in block 806 and provided to an illustrative Characteristic and Interest determination process such as discussed with reference FIG. 7 above. Specifically, for this example, we may assume that interpersonal network manager 202 accesses a set of defined weights or logical rules associated with different tag values and determines that 0.5 and 0.2 respectively should be added to the user's “finance” and “math” Characteristics based on the presence of the “hedge fund” tag; 0.1 and 0.3 respectively should be added to the user's “finance” and “math” Characteristics based on the presence of the “technical analysis” tag; and 0.1 should be added to the user's “math” characteristic and 0.3 should be added to the user's “board games” Interest based on the second users “chess” tag associated with the user. Still further, interpersonal network manager 202 may determine that based on the second user's high “chess” Characteristic and the addition of a “chess” tag by the second user, 0.5 should be added to an Interest of the second user corresponding to the user—indicating that the second user is expected to have an increased interest in the user.

As a further illustrative example, we may assume that a first user has tagged a second user with an “exboyfriend” tag, and that this tag association is gathered at block 806 by illustrative interpersonal network manager 202 with reference to FIG. 2. For the purpose of this example, we may assume that interpersonal network manager 202 accesses a set of defined weights or logical rules associated with tag values and determines that a first user tagging a second user with an “exboyfriend” tag should have an Interest corresponding to the second user set to −0.5, indicating low interest in the second user.

Illustratively, in various embodiments, tags added to a user's own profile by the user, public tags added to the user's profile by other users, private tags associated with the user by other users, and tags associated with other users by the user may all contribute to user Characteristics and Interests in an illustrative Characteristic and Interest determination process. In further embodiments, each tag may be weighted differently based on which user added each tag to whom and whether each tag is public or private. In still further embodiments, combinations or sets of tags may be weighted differently than individual tags. For example, an illustrative Characteristic and Interest determination process may add to an “airplanes” Interest when a user has been tagged with a combination of “flying” and “pilot,” but may add to a “travel” interest when a user has been tagged with a combination of “flying” and “foreign countries.”

At block 808, an interpersonal networking and recommendation system may gather activity feedback information. Illustratively, activity feedback information may correspond to feedback gathered about a Networking Activity, group, conversation or conversation topic, activity, game, or any other interpersonal interaction. Illustratively, activity feedback may be gathered through one or more interfaces allowing selection or entry of feedback data. An embodiment of an illustrative Networking Activity feedback interface is discussed below with reference to FIG. 21; however, feedback may be obtained on any interpersonal interaction or suggestion as described above and through any number of different or similar interfaces. Activity feedback may correspond to a rating (e.g. numerical, alphabetic, number of stars, etc.); absolute or relative ranking (e.g. “was conversation topic A more enjoyable than conversation topic B”); a request to have or not have similar activities recommended (e.g. “show me more events like this one”); an answer to a yes or no question (e.g. “did you enjoy the activity”); entered text comments or responses; selection of one or more options from a list; an association of an event with a particular metadata tag or set of tags (e.g. tagging an event “fun” or “loud”); leaving or arriving at an event early, late, or on time; choosing to not enter feedback; or any other type or format of feedback that may be directly provided or inferred from user action. Illustratively, feedback may be collected, selected, or entered through any interface control or element as known in the art, or may be inferred from any set of user behaviors, actions, or other feedback. Illustratively, any form or type of collected feedback may be combined, collected, or inferred with or from any other feedback. In one embodiment, indicating interest, confirming, signing up, or attending a Networking Activity by a user or Attendee may be treated as positive feedback by an interpersonal networking and recommendation system.

Activity feedback may further be addressed at any aspect or attribute associated with an interpersonal interaction or suggestion. In one embodiments, activity feedback may directly address enjoyment of a Network Activity, group interaction, conversation, conversation topic or interpersonal suggestion, or other interpersonal interaction or suggestion. In further embodiments, activity feedback may additionally or alternately correspond to any other associated aspect or attribute, such as: a perceived relevance (e.g. “was this activity relevant to your interests”, “was this conversation topic relevant to your interaction”, etc.); an specific descriptive attribute or set of attributes (e.g. “how loud was this activity on a scale of 1-10”, “was group A more friendly than group B”, “was this conversation topic too obscure”, etc); an associated Characteristic or Interest; an associated tag (e.g. “show me more events with a ‘hiking’ tag); a set of activity Attendees or group members; a time, location, cost, size, or other associated detail; or any other attribute or aspect directly or indirectly associated with a Network Activity, group interaction, conversation, conversation topic or interpersonal suggestion, or other interpersonal interaction or suggestion. In a further embodiment, activity feedback may correspond to a particular aspect of an interpersonal interaction or suggestion (e.g. “did you enjoy the food at this activity,” or “did you find the speech part of the activity too long”), or a particular user behavior (e.g. “did you go swimming,” “did you try the food,” “did you get a drink,” etc.). In a still further embodiment, activity feedback may correspond to a perceived reaction or inferred feedback from other users, groups or attendees. For example, feedback may be requested on whether a first Attendee at a Networking Activity thought a second Attendee at the same Networking Activity had fun.

Various questions, types or categories, requests, values, or aspects of activity feedback may, in one embodiment, be associated with one or more modification rule or value determining or affecting how Characteristic, Interest, or tags may be modified on the basis of the feedback. Illustratively, Characteristic, Interest, or tags of any entity or object associated with an interpersonal interaction may be the subject of a modification rule or may be otherwise affected by the giving of feedback, including the user or Attendee giving the feedback. In various embodiments, any other entity or object that is the target of feedback or associated with a target of feedback may be the subject of a modification rule or may be otherwise affected by feedback, such as: a Networking Activity or other interpersonal interaction; a type, category, or template of Networking Activity or other interpersonal interaction; one or more members of a group or conversation; one or more Attendees of a Networking Activity or other interpersonal interaction; a conversation; a conversation topic or other interpersonal suggestion; a tag; a venue or other location; an aspect or detail such as cost, time, timing, or size of a Networking Activity or other Interpersonal Interaction; or any other directly or indirectly associated attribute or characteristic of any object or entity directly or indirectly associated with the provider or target of the feedback. Illustratively, various modification rules or values associated with feedback may be defined by an interpersonal networking and recommendation admin or user, or may be derived from Characteristics, Interests, or tags of a provider or target (or associated entity or object) of the feedback.

In one embodiment, specific interfaces or questions may be associated with one or more Characteristics or Interests. For example, an interpersonal networking and recommendation system admin may define a feedback slider interface for a particular Networking Activity serving roast duck asking a question “how much did you enjoy the food,” and may associate an answer to this question over a certain threshold with a 0.2 increase in a “duck” Interest and a 0.1 increase in an “expensive food” Interest.

In another embodiment, an interface or question may be associated with a set or general category of Characteristic or Interest. For example, an interpersonal networking and recommendation system admin or user may define a feedback question “did you like the food” to always increase a “food” Interest of the answering user or Attendee by 0.1 and always increase a “food” Characteristic of any related Networking Activity by 0.02.

In a still further embodiment, an interface or question may be associated with a modification of Characteristics or Interests on the basis of Characteristics or Interests previously assigned to a user, Attendee, Networking Activity or other interpersonal interaction, group, conversation topic or other interpersonal suggestion, tag, or other entity or object. For example, a question “did you like the activity” associated with a Networking Activity may be linked to modification rules increasing each Interest of the answering Attendee that matches a Characteristic associated with the Networking Activity or Recommendation by 10% of the value of the Characteristic; increasing each Characteristic associated with the Networking Activity that matches a Characteristic associated with the answering Attendee by 1%; and increasing each Characteristic associated with any other Attendee of the Networking Activity that matches a Characteristic associated with the answering Attendee by 0.5%.

Illustratively, any modification rule or value may be associated with any other modification rule or value, and may apply any kind of threshold, Boolean or logical test, or other logical or mathematical technique. For example, a question “did you like the group you just talked to” associated with a Networking Activity may be linked to modification rules increasing each Interest of the answering Attendee that matches a Characteristic determined for the group by 10% of the value of the Characteristic; increasing each Characteristic of a group member that matches a Characteristic of the answering Attendee by 0.1, provided that the Characteristic of the answering Attendee is over a threshold value of 0.5; and increasing a “sociable” Characteristic of the answering Attendee by 10%.

Illustratively, activity feedback information gathered at block 808 may be processed or analyzed alone or in any combination with other data in block 820 or in an illustrative Characteristic and Interest determination process such as discussed with reference to block 712 and FIG. 7 above.

For the purpose of a specific illustrative example, we may assume that a user has attended a baseball themed Networking Activity and provided feedback on the activity through an associated user device to illustrative interpersonal networking manager 202 of FIG. 2. We may further assume for this example that a number of other Attendees have submitted their own feedback on the activity (for the purpose of this specific example, this feedback will be referred to as “Attendee Activity Feedback”). Further in the context of this example, interpersonal networking manager 202 may gather activity feedback information including the user's feedback and the Attendee Activity Feedback at block 808, process the activity feedback information at block 820, and further analyze the processed activity feedback information as part of an illustrative Characteristic and Interest determination process such as discussed with reference to FIG. 7 above. Specifically, in the context of this example, interpersonal networking manager 202 may identify that the user rated the baseball Networking Activity badly (e.g. a “1” on a scale of 1-10), and may determine based on a predefined set of modification rules and values that −0.2 should be added to the user's “baseball” Interest. Interpersonal networking manager 202 may further determine based on the Attendee Activity Feedback that other Attendees who rated the baseball Networking Activity badly had a very high average “football” Interest (e.g. over a threshold value of 0.5), and may accordingly determine that a predefined or weighted value (e.g. 0.1) should be added to the user's “football” Interest.

At block 810, an interpersonal networking and recommendation system may gather user feedback information. Illustratively, user feedback information may correspond to feedback gathered about a user, Attendee, or group participating in one or more interpersonal interactions. Illustratively, user feedback may be gathered through one or more interfaces allowing selection or entry of feedback data. An embodiment of an illustrative user feedback interface is discussed below with reference to FIG. 20; however, feedback may be obtained on users, Attendees, group members, or other individuals through any number of different or similar interfaces. User feedback may correspond to a rating (e.g. numerical, alphabetic, number of stars, etc.); absolute or relative ranking (e.g. “was user A more enjoyable than user B”); a request to meet or not meet similar users or Attendees (e.g. “introduce me to more users like this one”); an answer to a yes or no question (e.g. “did you have fun with this user”); entered text comments or responses, selection of one or more options from a list, an association of an user or Attendee with a particular metadata tag or set of tags (e.g. tagging an user “fun” or “loud”); a conversation with a user or Attendee going for a long or short time; choosing to not enter feedback on a user or Attendee; or any other type or format of feedback that may be directly provided or inferred from user action. Illustratively, feedback may be collected, selected, or entered through any interface control or element as known in the art, or may be inferred from any set of user behaviors, actions, or other feedback. Illustratively, any form or type of collected feedback may be combined, collected, or inferred with or from any other feedback. In one embodiment, a user or Attendee indicating interest, confirming, signing up, or attending a Networking Activity or interpersonal interaction with a particular user, Attendee, or group may be treated as positive feedback towards that particular user, Attendee, or group.

User feedback may further be addressed at any aspect or attribute associated with a user or Attendee or any associated group, interpersonal interaction or suggestion. In one embodiments, user feedback may directly address enjoyment of an interpersonal interaction or time spent with another user (e.g. “rate your enjoyment of this user from 1-5 stars”). In further embodiments, user feedback may additionally or alternately correspond to any other associated aspect or attribute, such as: a perceived relevance (e.g. “was this user relevant to your interests”); an specific descriptive attribute or set of attributes (e.g. “how loud was this user on a scale of 1-10”, “was Attendee A more friendly than Attendee B”, “was this user too pedantic”, etc.); an associated Characteristic or Interest; an associated tag (e.g. “show me more users with a ‘finance tag”); friends or acquaintances of a user or Attendee (e.g. “did you like this Attendee's friend”); or any other attribute or aspect directly or indirectly associated with a user or Attendee. In a further embodiment, user feedback may correspond to a particular aspect of a user, Attendee, or interpersonal interaction (e.g. “did you enjoy the conversation with this user,” or “did you think her clothes were stylish”), or a particular user or Attendee behavior (e.g. “did you laugh during the conversation,” “did he smile at you,” “did you buy him a drink,” etc.). In a still further embodiment, user feedback may correspond to a perceived reaction or inferred feedback from other users, groups or attendees. For example, feedback may be requested on whether a first Attendee at a Networking Activity thought a second Attendee at the same Networking Activity liked a third Attendee.

Various questions, types or categories, requests, values, or aspects of user feedback may, in one embodiment, be associated with one or more modification rule or value determining or affecting how Characteristic, Interest, or tags may be modified on the basis of the feedback. Illustratively, Characteristics, Interests, or tags of any entity or object associated with an user or Attendee may be the subject of a modification rule or may be otherwise affected by the giving of feedback, including the user or Attendee giving the feedback. In various embodiments, any other entity or object that is the target of feedback or associated with a target of feedback may be the subject of a modification rule or may be otherwise affected by feedback, such as: a user or Attendee, a friend or acquaintance of a user or Attendee, a Networking Activity or other interpersonal interaction; a type, category, or template of Networking Activity or other interpersonal interaction; one or more members of a group or conversation; one or more Attendees of a Networking Activity or other interpersonal interaction; a conversation; a conversation topic or other interpersonal suggestion; a tag; a venue or other location; an aspect or detail such as cost, time, timing, or size of a Networking Activity or other Interpersonal Interaction; or any other directly or indirectly associated attribute or characteristic of any object or entity directly or indirectly associated with the provider or target of the feedback. Illustratively, various modification rules or values associated with feedback may be defined by an interpersonal networking and recommendation admin or user, or may be derived from Characteristics, Interests, or tags of a provider or target (or associated entity or object) of the feedback.

In one embodiment, interfaces or questions may be associated with one or more Characteristics or Interests. For example, an interpersonal networking and recommendation system admin may define a feedback interface for an Attendee asking the yes or no question “did you laugh during your conversation” and associate it with a rule causing a yes answer to increase the “humor” Characteristic of the answering user or Attendee by 0.1 and increase the “funny” Characteristic of the target of the feedback by 10%.

In a further embodiment, an interface or question may be associated with a modification of Characteristics or Interests on the basis of Characteristics or Interests assigned to a feedback providing or target user. For example, a question “did you like this person” associated with a Networking Activity Attendee may be linked to modification rules increasing each Interest of the answering Attendee that matches a Characteristic associated with the target Attendee by 10% of the value of the Characteristic; increasing each Characteristic associated with the target Attendee that matches a Characteristic associated with the answering Attendee by 0.1; and increasing each Characteristic associated with any Attendees in the same group as the target Attendee at the time of the feedback that matches a Characteristic associated with the answering Attendee by 0.5%.

Illustratively, any modification rule or value may be associated with any other modification rule or value, and may apply any kind of threshold, Boolean or logical test, or other logical or mathematical technique. For example, a question “did you like the Attendee you just talked to” associated with a target Networking Activity Attendee may be linked to modification rules increasing each Interest of the answering Attendee that matches a Characteristic of the target Attendee by 10% of the value of the Characteristic; increasing each Characteristic of the target Attendee that matches a Characteristic of the answering Attendee by 0.1, provided that the Characteristic of the answering Attendee is over a threshold value of 0.5; and increasing a “sociable” Characteristic of the answering attendee by 10%.

Illustratively, user feedback may further include direct feedback on user traits, demographics, groups, Characteristics, Interests, or tags. For example, in one embodiment, an interpersonal networking and recommendation system may provide an interface allowing a user or Attendee to indicate that they enjoy other users or Attendees with a specific tag or trait. For example, a user may be able to provide feedback that they would like to meet more users with a “cat” tag, or that they would like to meet fewer users in the technology industry. Illustratively, an interpersonal networking and recommendation system may utilize positive or negative feedback regarding a tag, trait, demographic, Characteristic, Interest, or group as the basis for increasing or decreasing Characteristics or Interests associated with the tag, trait, demographic, Characteristic, Interest, or group. For example, an interpersonal networking and recommendation system may increase a “cat” interest and “pets” interest associated with a user responsive to that user indicating that they would like to meet more users with a “cat” tag.

Illustratively, gathered user feedback information may be processed or analyzed alone or in any combination with other data in block 820 or as part of an illustrative Characteristic and Interest determination process such as discussed with reference to FIG. 7 above.

For the purpose of a specific illustrative example, we may assume that a user has participated in a conversation with a Networking Activity Attendee and has provided feedback on the Attendee through an associated user device to illustrative interpersonal networking manager 202 of FIG. 2. We may further assume for the purpose of this example that the Attendee has a very high “technology” Characteristic and “baseball” Interest. We may further assume that the Attendee has submitted her own feedback on the user (for the purpose of this specific example, this feedback will be referred to as “Attendee User Feedback”). In the context of this example, interpersonal networking manager 202 may gather together user feedback information including the user's feedback and the Attendee User Feedback at block 810, may process the user feedback information at block 820, and may further analyze the processed user feedback information as part of an illustrative Characteristic and Interest determination process such as discussed with reference to FIG. 7 above. Specifically, in the context of this illustrative example, interpersonal networking manager 202 may identify that both the user and Attendee said they enjoyed the conversation (e.g. answered “Yes” to the question “Did you enjoy your meeting with this person”), and may accordingly determine based on a predefined set of modification rules or values that 0.5 should be added to the user's Interest value corresponding to the specific Attendee and 0.2 should be added to the user's “technology” Interest on the basis of the Attendees high “technology” Characteristic. Interpersonal networking manager 202 may further determine that the user's “baseball” Characteristic should be increased by 0.1 on the basis of the positive Attendee User Feedback and the Attendees high “baseball” Interest. Illustratively, if a particular Characteristic or Interest has not been defined for a user or Attendee (e.g. the user or Attendee has never received any feedback or been tagged with any tag that would modify a ‘baseball’ characteristic), the particular Characteristic or Interest may be defined (e.g. initialized to a default value) and modified first time a modification would otherwise be applied.

At block 812, an interpersonal networking and recommendation system may gather environmental information. Illustratively, environmental information may include any data or information associated with a user's surrounding environment or location, such as geolocation or coordinate data, including raw or processed data from GPS, cell or radio triangulation, RFID or NFC scanners; other information concerning a user's street address, building, cross-streets, nearby landmarks, nearby geographical features, nearby businesses or buildings, or other nearby location features; services available in the user's area (e.g. bar service, police, taxi service, etc.); height data; temperature, humidity, air speed, weather, or air pressure data; environmental noise, including noise amplitude, noise tones or frequencies, content of audible music or background noises, or content of audible conversations; video of a user's location; pictures of a user's location; data on nearby users, Attendees, animals, or other objects, such as determined by analysis of audio (e.g. voice recognition), video (e.g. video face recognition), location data (e.g. based on analysis of GPS, cell or radio triangulation), RFID or NFC data (e.g. sensing proximity of a RFID or NFC signal associated with a user, Attendee, or other object); interpersonal networking and recommendation service devices or services in the users area; or any other data or information associated with or describing the user's surrounding environment. For example, at block 812, an illustrative interpersonal networking and recommendation system may gather any new user location or movement data that has been collected by a user's mobile device since block 812 was last performed. As another example, at block 812, an illustrative interpersonal networking and recommendation system may gather camera data from cameras installed at a Networking Activity and process this camera data at block 820 with facial recognition technology as known in the art (e.g. OpenFace™ open-source facial recognition libraries) to determine the emotional state (e.g. happy, angry, sad, etc.) of a user at the Networking Activity. As still another example, at block 812, an interpersonal networking and recommendation system may gather sound data recorded or collected from mobile devices associated with Attendees in a conversation and process this sound data to determine a conversation loudness.

For the purpose of a specific illustrative example, we may assume that a user is attending a Networking Activity and is engaged in a conversation with a specific Attendee. For the purpose of this example, we may assume that the user's mobile device and the Attendee's mobile device are recording user location data and storing this data on each device respectively. We may further assume that an audio recording device on a nearby table at the Networking Activity is recording audio data from the surrounding environment, including the conversation between the user and other Attendee. In the context of this example, at block 812 illustrative interpersonal networking manager 202 of FIG. 2 may cause the user's mobile device, the Attendee's mobile device, and the audio recording device to each transmit collected data to interpersonal networking manager 202. For this example, we may assume that the audio and location data gathered at block 812 is processed at block 820. Specifically, and in the context of this example, interpersonal networking manager 202 may process the audio data to determine a conversation loudness and may process the user and Attendee location data to determine a physical nearness between the user and Attendee. To continue with this example, interpersonal networking manager 202 may analyze the processed environmental data as part of an illustrative Characteristic and Interest determination process such as discussed with reference to FIG. 7 above. Specifically, for this example, we may assume that interpersonal networking manager 202 determines that the conversation loudness is below a certain threshold indicating a vigorous conversation, and increases the “quiet” Characteristic of the user by 0.1 and a user Interest value corresponding to the specific other Attendee by −0.1. Further for this example, we may assume that interpersonal networking manager 202 applies a logical rule that decreases the user Interest value corresponding to the specific other Attendee by 0.05 for every foot further than two feet from the user that the other Attendee is standing. For the purpose of this example, we may assume that the specific other Attendee is standing four feet from the user and that interpersonal networking manager 202 accordingly decreases the user Interest value corresponding to the other Attendee by −0.1.

At block 814, an interpersonal networking and recommendation system may gather third-party information. Illustratively, third-party information may include information from third-party sources, such as websites, databases, APIs, or other services associated with third-party providers of data. For example, third-party information may specifically include information gathered from or provided by websites, databases, APIs, or other services associated with social networking, customer relationship management, hiring or recruitment, job search, comments, news, blogging, e-commerce, dating, company or organizational information, market data, or any other third-party service collecting, compiling, or providing user data associated with potential Attendees or interpersonal networking and recommendation service users.

For the purpose of a specific illustrative example, at block 814 interpersonal networking manager 202 of illustrative FIG. 2 may gather data from a third-party social networking site via a public API (to be referred to as “Social Networking Data” for this specific example) and may further gather data from a third-party recruitment database via a subscription API with a third-party recruitment data provider (to be referred to as “Recruitment Data” for this specific example). For the purpose of this example, we may assume that the Social Networking Data includes posts by a specific interpersonal networking and recommendation service user, and that the Recruitment Data includes a current job description and years worked data for the same user. To continue this example, at block 820 interpersonal networking manager 202 may parse the Social Networking Data to determine the frequency of positive words such as “happy” and “excited” in the user's recent posts. To continue with this example, interpersonal networking manager 202 may analyze the word frequency data and the years worked data as part of an illustrative Characteristic and Interest determination process such as discussed with reference to block 712 and FIG. 7 above. Specifically, for this example, we may assume that interpersonal networking manager 202 determines that the determined frequency of positive words is above a predefined threshold, and that a “happy at work” user Characteristic should accordingly be incremented by a predefined value of 0.2. Further, for this example, we may assume that interpersonal networking manager 202 determines that the user's years worked falls into a predefined midlevel range, and that a “seniority” user Characteristic should accordingly be set at 0.5 with a validity weight of 1.0.

At block 716, an interpersonal networking and recommendation system may gather defined user information. Illustratively, defined user information may include information directly entered, selected, defined, or approved by an interpersonal networking and recommendation system user. Defined user information is discussed in greater detail above with reference to illustrative FIG. 7, et al. Illustratively, defined user information discussed with reference to FIG. 7 or otherwise herein may be gathered at block 816 and may be processed at block 820 by itself or in any combination or associated with any other data discussed above with reference to blocks 804-818 or elsewhere.

At block 818, an interpersonal networking and recommendation system may gather other user-associated information. Illustratively, other user-associated information may include information on any known or defined direct or indirect relationships between users or Attendees, and may further include any information associated with users or Attendees in one or more direct or indirect relationship with an interpersonal networking and recommendation system user. For example, in one embodiment, an interpersonal networking and recommendation system may allow users to friend other users or take an action to define a relationship between the user and other users. In a further embodiment, relationships between users may be defined or created based on tags assigned between users. For example, a “friend” relationship between a first and second user may be created by the first user associating a private “friend” metadata tag with the second user. In one embodiment, relationship data gathered at block 818 may be processed at block 820 to determine values or data sets associated with user relationships or connectivity, such as a connectedness between users, degrees of relationships between users, strength of relationships between users, user relationship density or number of connections, or any other relationship data associated with a user. Illustratively, various types, values, aspects, or sets of data associated with a user's friends or with other users or Attendees with a direct or indirect relationship with the user may be processed at block 820 or utilized as part of an illustrative Characteristic and Interest determination process such as discussed with reference to FIG. 7 above.

As a specific illustrative example, interpersonal networking manager 202 may determine that a first user's Characteristic or Interest values should be modified as discussed in any one or more of the specific illustrative examples discussed above with reference to blocks 804-816. In the context of this illustrative example, interpersonal networking manager 202 may further apply a logical rule that applies any modifications to the first user's Characteristics or Interests to all friends of the first user, but at 50% of the original value. For example, interpersonal networking manager 202 may determine that a “baseball” interest associated with a first user should be incremented by 0.3, and may further determine that a “baseball” interest of all friends of the first user should accordingly incremented by 0.15.

As discussed in greater detail above, at block 820 any data gathered in blocks 804-818 may be processed to obtain alternate or additional values, relationships, sets, or series.

At block 822, routine 800 ends. In one embodiment, user-associated data gathered or processed in routine 800 may be utilized as part of an illustrative Characteristic and Interest determination process such as discussed with reference to FIG. 7 above.

FIG. 9 is a device diagram depicting an illustrative embodiment of a user data entry interface displayed on tablet computing device 900. Illustratively, tablet computing device 900 may include, implement, or be associated with any number or type of processors, memories, hardware, software, or other processes, components, or devices. In one embodiment, tablet computing device 900 may correspond to interpersonal networking interface device 132 or client computing device 106 or 108 discussed with reference to FIG. 1, or user computing device 202 discussed with reference to FIGS. 2 and 3. In further embodiments, tablet computing device 900 may include, implement, or be associated with any one or more elements, interfaces, processes, systems, hardware, software, entities, or devices discussed with reference to illustrative computing environments of FIGS. 1-3. In one embodiment, tablet computing device 900 may be a subject of one or more values, sets, or pieces of data described above with reference to block 804 of illustrative FIG. 8.

In one embodiment, tablet computing device 900 may include a touchscreen interface 902. Touchscreen interface 902 may consist of a combination display and input device allowing a user finger to interact with tablet computing device 900. In various embodiments, touchscreen interface 902 may allow input by any number of fingers, body parts, styluses, pens, or other input devices. In various embodiments, touchscreen interface 902 may support any combination of gestures, motions, or other interactions. Illustratively, tablet computing device 900 may support any number of additional inputs or peripherals, such as displays, mice, trackballs, keyboards, trackpads, drawing tablets, etc. In various embodiments, tablet computing device 900 may additionally include or implement any number of device interfaces or processes as discussed with reference to user computing device 302 in FIG. 3. Illustratively, any interfaces, processes, routines, interactions, or aspects described with regards to tablet computing device 900 may be implemented, performed, or displayed on or in association with any number of alternate or additional computing or client interfaces as known in the art.

In various embodiments, a user data entry interface displayed on tablet computing device 900 may allow or facilitate the entering of user information or biographic data into an interpersonal networking and recommendation system. Illustratively, a user data entry interface may be displayed to users setting up a new account with an interpersonal networking and recommendation system on a mobile, web, or computer app, or may be displayed to Attendees entering a Networking Event in order to capture biographic data and other information for use in facilitating interpersonal networking. In one embodiment, user information or biographic data entered into a user data entry interface may be collected, gathered, processed, or utilized to determine Characteristics and Interests as discussed with reference to illustrative FIGS. 5 and 6, et al.

Illustratively, a user data entry interface may include photograph selection control 904 for selecting and displaying a user picture. A user data entry interface may further include additional fields for entering biographic data about the current user, including name field 906, age field 908, gender field 910, and relationship status field 912. Illustratively, a user data entry interface may include any number of additional or alternate controls, fields, or interface components for capturing user data to facilitate interpersonal networking. A user data entry interface may further include a save button 914 for saving the entered information.

Although biographic data is discussed above in the context of an illustrative user data entry interface, in various embodiments an interpersonal networking and recommendation system may manage or utilize any number or combination of different interfaces allowing users or Attendees to select or enter various other types of user data, such as professional data (e.g. a title, company, employment sector, years at job, and years at industry, seniority level, etc.); relevant categories, Characteristics, or Interests; metadata tags; or any other type or category of user data.

For example, an interpersonal networking and recommendation interface may include a selectable category interface with a categories quilt of selectable checkboxes or other controls allowing a user to select categories that may apply to him or her.

As another example, in one embodiment a user self-tagging interface may allow or facilitate the entry or selection of metadata tags. In various embodiments, a tag may represent any concept, keyword, action, activity, preference, status, or other descriptive term associated with a user. Illustratively, a user may enter one or more metadata tags to a user self-tagging interface to be associated with her interpersonal networking and recommendation system account or profile. In one embodiment, metadata tags added to a user's account or profile by the user may be displayed to other users of an illustrative interpersonal networking and recommendation system. Tags are discussed further below with reference to illustrative FIG. 19 et al.

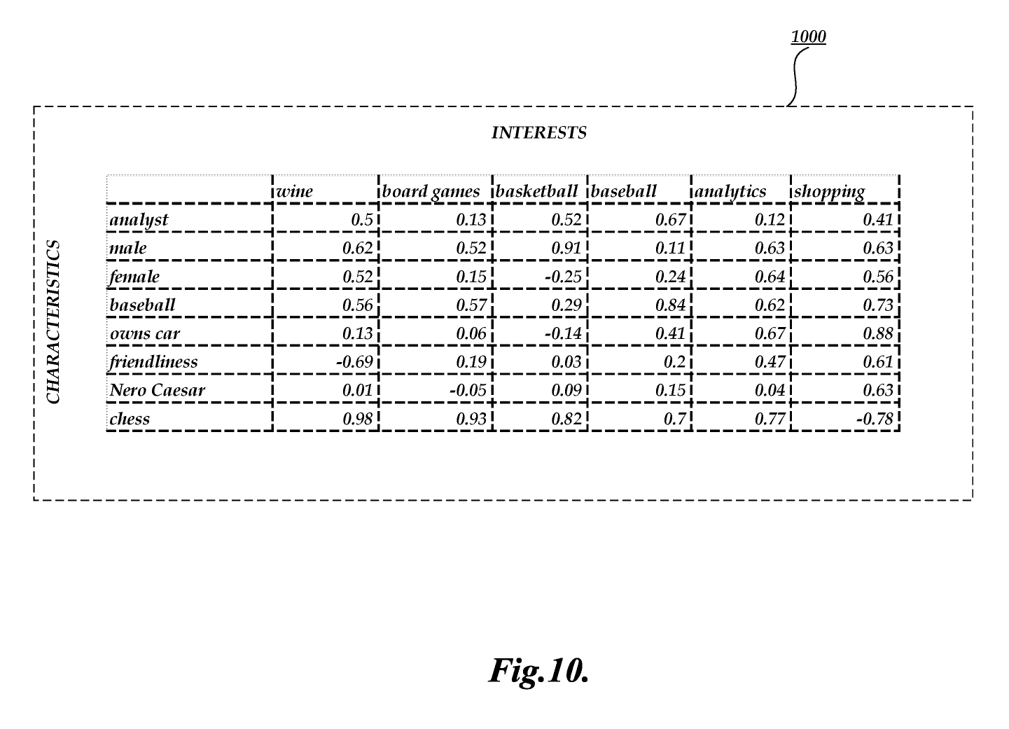

FIG. 10 is a data diagram depicting an illustrative example of recommendation weights 1000 associated with an illustrative interpersonal networking and recommendation system. Illustratively, an interpersonal networking and recommendation system user may define any number of different recommendation weights for the determination of Recommendations. In one embodiment, recommendation weights may correspond to a pair interpersonal networking and recommendation system Characteristics and Interests. Illustratively, a recommendation weight corresponding to a pair of Characteristics and Interests may represent an attractiveness or correlation strength between the Characteristic and the Interest. In one embodiment, recommendation weights close to 1 may indicate a strong correlation or attractiveness between an Interest and a Characteristic, while recommendation weights close to −1 may indicate a weak correlation or attractiveness. For example, and with reference to recommendation weights 1000, a “board games” Interest may have a 0.93 recommendation weight corresponding to a “chess” characteristic, indicating that users with a “board games” Interest are expected to be highly attracted towards users with a high “chess” characteristic. As another example with reference to recommendation weights 1000, a “wine” Interest may have a recommendation weight of 0.69 with regards to a “friendliness” Characteristic, indicating that users with a “wine” interest are expected to be moderately unattracted towards users with a high “friendliness” Characteristic. An illustrative routine for determining Recommendations based on recommendation weights and other user-associated values is discussed below with reference to FIG. 11.

In various embodiments, recommendation weights may be predefined by an interpersonal networking and recommendation system admin or user, or may be automatically or may be manually determined by one or more interpersonal networking and recommendation system components. In one embodiment, an illustrative interpersonal networking and recommendation system may automatically determine recommendation weights by generating a least-squares correlation between Interest and Characteristic values for all users in the system. In a further embodiment, an illustrative interpersonal networking and recommendation system may generate recommendation weights by a weighted average weighting each least-squares correlation by a Characteristic or Interest validity weight. In other embodiments, an illustrative interpersonal networking and recommendation system may determine recommendation weights from user Interest and Characteristic values using any other arithmetical or statistical method.

Illustratively, recommendation weights may be defined globally, or may correspond to a particular geographical area, demographic, user interest or feature, community, or other set, sector, or area. In one embodiment, multiple sets of recommendation weights may be defined for different areas or sets of users, and may be combined or averaged to generate a recommendation weight for users in a particular sub-group or area. For example, an interpersonal networking and recommendation system may define a global set of recommendation weights, a set of recommendation weights for New York City, and an additional set of recommendation weights for users employed in finance. In the context of this example, an interpersonal networking and recommendation system may perform a simple or weighted average of all three sets of recommendation weights to generate a combined set of weights to apply in determining recommendations for finance sector employees in New York.

FIG. 11 is a flow diagram depicting an illustrative routine 1100 for determining Recommendations for a user or Networking Activity Attendee. Illustratively, routine 1100 may be implemented or performed by components of an interpersonal networking and recommendation system such as depicted above at least with reference to illustrative FIGS. 1-3, et al. In one embodiment, interface elements and routine blocks discussed with reference to FIG. 11 may be implemented, displayed, or executed on a computing device 102 with reference to illustrative FIG. 1 or interpersonal networking manager 202 with reference to illustrative FIG. 2. Illustratively, various interfaces and processes of illustrative routine 1100 may further be performed on any combination of various other devices or services such as interpersonal networking interface device 132, user devices 106 or 108, or user computing device 302 as discussed with reference to FIGS. 1 and 3 respectively. In one embodiment, aspects or blocks of routine 1100 may be performed by an automated or semi-automated process associated with client computing device 102 or interpersonal networking manager 202. Aspects of routine 1100 may be performed in response to specific interactions or commands by a user or process. In yet another embodiment, aspects of routine 1100 may be performed in response to an automatic process or trigger, or implemented on a continuous basis. It will be appreciated by one skilled in the relevant art that various aspects or blocks of routine 1100 may be performed concurrently, sequentially, or at different times and in response to different events or timings. For example, in one embodiment a first set of Recommendations scored in block 1110 may be filtered at block 1112 concurrently as additional Recommendations are scored in block 1110.

At block 1102, routine 1100 begins responsive to a signal or request for user or Attendee Recommendations. In one embodiment, a request for user Recommendations may correspond to user interaction with an interpersonal networking and recommendation app. For example, a user may access an upcoming Networking Activities interface or section of an app or may interact with an interface or control for finding or requesting Recommendations. An illustrative embodiment of a Networking Activities selection interface is described in more detail below with reference to FIG. 13. In another embodiment, a user may request or may be automatically presented with Recommendations corresponding to individuals to meet or groups to join. For example, routine 1100 may be performed responsive to a user signing into a Networking Activity, and may determine Recommendations to interact with one or more individuals or groups at the Networking Activity. In a further embodiment, routine 1100 may begin responsive to a signal by an interpersonal networking and recommendation system. For example, an interpersonal networking and recommendation system may determine that a predetermined or calculated period of time has passed since a last set of Recommendations has been generated for a user, and may automatically begin routine 1100 to determine a set of new Recommendations for the user. As a specific illustrative example, an interpersonal networking and recommendation system may determine that a user interaction is over based on user feedback or system interactions, or based on a predefined length of time passing since a user began an interpersonal interaction with an Attendee at a Networking Activity, and may automatically perform routine 1100 in order to provide a new list of Recommendations for individuals or Group to meet. As another illustrative example, an interpersonal networking and recommendation system may determine that a fixed period of time has passed since a user attended a Networking Activity through the service, and may automatically trigger routine 1100 to generate a new set of potential Networking Activities to Attend. Illustratively, a user may be notified of newly determined Networking Activities through an interpersonal networking and recommendation system interface, such as an app or interpersonal networking interface device, a notification (e.g. e-mail, text, mobile or desktop push notification, phone call, etc.), or any other way. In one embodiment, routine 1100 may automatically be triggered subsequent or in association with an illustrative Characteristic or Interest determination routine such as discussed above with reference to FIG. 7.

At block 1104, an interpersonal networking and recommendation system may determine previously defined groups and Networking Activities. Illustratively, an interpersonal networking and recommendation service may store information on potential, current, or ongoing Networking Activities, meetings, groups of users or attendees, or other social interactions. For example, interpersonal networking manager 202 of illustrative FIG. 2 may maintain a list of current and upcoming Networking Activities in activity data store 206. As another example, interpersonal networking manager 202 may maintain a list of upcoming or ongoing interpersonal interactions, such as group conversations, games, or other activities, at an ongoing Networking Activity.

At block 1106, an interpersonal networking and recommendation system may determine an availability of system users or Attendees. Illustratively, an interpersonal networking and recommendation system may gather or determine availability information both for a user for whom Recommendations are being generated, and for other users or Attendees that may be the subject of interpersonal interactions or Networking Activities recommended for the user. In one embodiment, an interpersonal networking and recommendation system may utilize various defined or determined scheduling information in determining when a user is likely to be available, such as availability information associated with a user calendar or schedule, a list of Networking Activities that a user has RSVP's for or signaled interest in attending, a list of previously determined Recommendations previously presented to a user, information on any current Networking Activities or other interpersonal interactions that a user may be attending or participating in, estimated or defined lengths of Networking Activities or social interactions, common time periods of user unavailability (e.g. work hours), or any other source of scheduling or timing information associated with a user. For example, an interpersonal networking and recommendation system may determine that a user is free outside of normal work hours during any time period where the user has not signaled interest or RSVP's for a Networking Activity. In another embodiment, an interpersonal networking and recommendation system may allow a user to maintain a calendar or schedule including information on upcoming user availability.

Illustratively, sets of user or groups participating in conversations, games, activities, or other interpersonal interaction at a Networking Activity may be determined from a relative nearness of attendees based on location data associated with Attendee mobile devices or other location tracking devices (e.g. RFID, NFC, Bluetooth, GPS, etc.); may be determined from audio or video data collected through interpersonal networking and recommendation system devices installed at a Networking Activity or mobile devices associated with Attendees; may be determined based on previously suggested or accepted Recommendations presented to one or more Attendees to participate in a group conversation, activity, or other interpersonal interaction; or may be based on any other information associated with Attendee whereabouts or activities.

Illustratively, in the context of an ongoing Networking Activity, an interpersonal networking and recommendation system may determine which Attendees or users are available for a new interpersonal interaction, such as an introduction or conversation, and may further determine which Attendees or users are currently engaged in individual or group conversations, group games or other activities, or other group interpersonal activities. A determination of which Attendees or users may be currently engaged may be based in part on a determination of previously defined or current groups or Networking Activities with reference to block 1104 above.

At block 1108, an interpersonal networking and recommendation system determines a new set of Recommendations for a user. Illustratively, an interpersonal networking and recommendation system may determine a new set of Recommendations based on user availability data from block 1106; previously defined upcoming, current, and ongoing conversations, groups, Networking Activities, or other interpersonal interactions determined in block 1104, or any other information. In one embodiment, a set of Recommendations determined or generated at block 1108 may be an initial or over-inclusive set of Recommendations that may be further filtered, winnowed, or defined at other stages or blocks of routine 1100. For example, an interpersonal networking and recommendation system may determine a set of Recommendations based in part on a list of all possible introductions, group conversations or activities, Networking Activities, or other interpersonal interactions corresponding to an upcoming time period. As a specific illustrative example, an interpersonal networking and recommendation system may determine a list of all scheduled or previously defined Networking Activities occurring in the next week that do not conflict with a user's availability. As another specific illustrative example, an interpersonal networking and recommendation system may determine a list of all current ongoing conversations and groups at a Networking Activity.

In a further embodiment, an interpersonal networking and recommendation system may determine a set of Recommendations based in part on a determination of other user's or Attendee's availability. For example, an interpersonal networking and recommendation system may determine a set of possible introductions or other individual interactions based on matching a user's availability with availability data of other system users or Networking Activity Attendees. As another example, an interpersonal networking and recommendation system may generate a set of potential, but not yet scheduled, Networking Activities that may be hosted by a user or host associated with the interpersonal networking and recommendation system based on an availability of system users. As a specific illustration, an interpersonal networking and recommendation system may determine a set of system users with availability on Friday night, and may generate a set of possible Networking Activities that these available users could attend, such as a dinner hosted by one of the users, cocktails at a local bar, dancing, a game night, or any other potential Networking Activity. In the context of this specific illustration, the interpersonal networking and recommendation system may add one or more of the set of potential Networking Activities to a list of scheduled Networking Activities once a certain number of system users indicate interest in each potential activity.

Illustratively, in some embodiments, an interpersonal networking and recommendation system may constrain a determined set of Recommendations by a geographical area, demographic, or broad assessment of user Characteristics or Interests. For example, an interpersonal networking and recommendation system may determine a set of Recommendations corresponding to all upcoming Networking Activities and all system users or groups available for an interpersonal interaction within a predefined or user-selected radius of a user. As another example, an interpersonal networking and recommendation system may a set of Recommendations corresponding to all upcoming Networking Activities and all available users or groups available for an interpersonal interaction in a certain area (e.g. a city or neighborhood, etc.) or belonging to a certain employment sector (e.g. employed in finance). Illustratively, an interpersonal networking and recommendation system may determine that one or more constraints should be applied to narrow a set of potential Recommendations based on efficiency or availability of computational resources, user preference, a predetermined threshold or desired Recommendation set size, or any other factor.

At block 1110, one or more of the set of Recommendations generated at block 1108 may be assigned a score. Illustratively, a Recommendation score may be based on any combination of user Characteristics, user Interests, global or user specific recommendation weights, or any other user-associated information, values, or weights. In one embodiment, a Recommendation score may correspond to or in part be based on an assessment of how much a user would enjoy, engage with, or be rewarded by a Recommended Networking Activity or social interaction. In further embodiments, a Recommendation score may alternatively or additionally be based on how much a Recommended Networking Activity or social interaction would contribute to a user's personal or professional goals, or considerations of group dynamics, such as how much the user's presence at a Recommended Networking Activity or social interaction would improve the activity or social interaction for other Attendees or involved users.

In one embodiment, each Recommendation determined in block 1108 may be assigned a Recommendation score as one or more numerical values. Illustratively, an illustrative routine for scoring of Recommendations is discussed in more detail with reference to illustrative FIG. 12. For example, in one embodiment block 1110 may include one or more parts, processes, or blocks of routine 1200 discussed with reference to FIG. 12.

At block 1112, an interpersonal networking and recommendation system may filter a set of Recommendations determined at block 1108 on the basis of Recommendation scores assigned in block 1110 or on any other information. In one embodiment, an interpersonal networking and recommendation system may filter Recommendations on the basis of whether each Recommendation's score meets a predefined or automatically generated threshold. For example, an interpersonal networking and recommendation system may filter out all Recommendations with Recommendation scores lower than a predetermined value. In one embodiment, an interpersonal networking and recommendation system may generate a partially randomized set of filtered Recommendations by utilizing a form of monte carlo algorithm. In this embodiment, an interpersonal networking and recommendation system may generate a random threshold value within a certain range or distribution for each Recommendation in the set of Recommendations, and filter out each Recommendation with a score lower than the random threshold value generated for that specific Recommendation. In another embodiment, an interpersonal networking and recommendation system may base a threshold value on a desired number of filtered recommendations. For example, an interpersonal networking and recommendation system may choose a threshold value predicted to filter out all but a certain number of recommendations (e.g. ten recommendations) by assuming a normal distribution of Recommendation scores. Specifically, in the context of this example, an interpersonal networking and recommendation system may take the mean and standard deviation of Recommendation scores for the set of Recommendations and choose a threshold value a number of standard deviations away from the mean such that an appropriate number of Recommendations exceeding the threshold value are likely. In a further embodiment, an interpersonal networking and recommendation system may filter out recommendations by selecting recommendations at random, or may select recommendations at random from a set that meets a cutoff threshold. In another embodiment, an interpersonal networking and recommendation system may maintain a queue of users waiting for Recommendations, and may base a threshold on a value associated with a time spent waiting in this queue. For example, an interpersonal networking and recommendation system may generate lower threshold values for users who have been waiting longer for recommendations.

At block 1114, an interpersonal networking and recommendation system may determine whether a number of Recommendations in the filtered set generated at block 1112 satisfies a target range. For example, an interpersonal networking and recommendation system may check whether the size of filtered set of Recommendations falls between a minimum and maximum value. Illustratively, a target range may be predefined or predetermined, or may be automatically generated. In one embodiment, a subset of a set of filtered Recommendations generated at block 1112 may be selected at random to satisfy target range. Illustratively, a target range may be predefined for different Recommendation requests (e.g. a request for recommended Network Activities, a request for recommended conversations at an ongoing Networking Activity, etc.), may be requested by a user or Attendee (e.g. a request to show exactly five recommendations), or may be determined based on any other information.

If a number of filtered Recommendations satisfies a target range, or a number of filtered Recommendations have been selected to satisfy the target range, routine 1100 proceeds to optional block 1118 to determine Networking Activity or meeting locations. If a number of filtered Recommendations does not satisfy a target range, routine 1100 proceeds to block 1116 to update Recommendation criteria.

At block 1116, if a number of filtered Recommendations has not satisfied a target range, an interpersonal networking and recommendation system may update Recommendation criteria to attempt and satisfy the target number of filtered Recommendations.

In one embodiment, an interpersonal networking and recommendation system may update Recommendation criteria by modifying a threshold filter value and proceeding to block 1112 to re-filter a previously generated and scored set of Recommendations based on the newly modified value. For example, if a previous filtering operation at block 1112 produced too few recommendations to satisfy a target range at block 1114, an interpersonal networking and recommendation system may lower a filter threshold value used at block 1112 and return to block 1112 to refilter the previously filtered Recommendations.

In another embodiment, an interpersonal networking and recommendation system may trigger a Characteristic and Interest determination routine such as illustrative routine 700 of FIG. 7 to determine new Characteristic and Interest values associated with a user, and may return to block 1108 to determine a new set of Recommendations based in part on the new Characteristic and Interest values. In a further embodiment, an interpersonal networking and recommendation system may recalculate or update one or more sets of recommendation weights such as illustratively described with reference to FIG. 10, and may return to block 1108 to determine a new set of Recommendations. In a still further embodiment, an interpersonal networking and recommendation system may update a target geographical area, demographic sector, or time or date availability information, and may return to block 1108 to determine a new set of Recommendations. Illustratively, geographical area, demographic sector, or time or date availability may be broadened or narrowed, or one or more categories may excluded or added to a determination of a new set of Recommendations at block 1108. For example, if a previous filtering operation at block 1112 produced too few Recommendations to satisfy a target range at block 1114, at block 1116 a target geographical area may be expanded (e.g. from Brooklyn to greater New York City) to produce a potentially bigger larger set of new Recommendations. In one embodiment, an interpersonal networking and recommendation system may modify a filter threshold value to be used at block 1112 as well as one or more of the types of information discussed above, and may return to block 1108 to determine a new set of Recommendations.

At optional block 1118, having determined that the set of filtered Recommendations satisfies the target range at block 1114, an interpersonal networking and recommendation system may determine activity or meeting locations for one or more recommended Network Activities, introductions, group meetings or activities, conversations, or other interpersonal interactions without predetermined associated locations. In one embodiment, no Recommendations in the set of filtered Recommendations from block 1114 may require the determination of activity or meetings, and routine 1100 may proceed to end at block 1120.

Illustratively, predefined or scheduled Network Activities, groups, meetings, or other interpersonal interactions may be pre-associated with particular locations. For example, an interpersonal networking and recommendation system administrator may previously have reserved, scheduled, or assigned locations to a set of Network Activities defined in the system. In another embodiment, an interpersonal networking and recommendation system may maintain a list of assigned or otherwise associated locations corresponding to planned or current groups, conversations, activities, or other interpersonal interactions at an ongoing Networking Activity. In one embodiment, locations for predefined or scheduled Network Activities, groups, meetings, or other interpersonal interactions may be identified or determined at illustrative block 1104 above.

In one embodiment, certain Network Activities may be proposed or scheduled, but not yet associated with a fixed location. For example, a set of filtered Recommendations may include a proposed “dinner” Network Activity without an associated restaurant or venue. In one embodiment, an interpersonal networking and recommendation system may select a location for a Network Activities without a predefined location at random from a list corresponding to a Network Activity type. For example, in the context of the above “dinner” Activity, an interpersonal networking and recommendation system admin may have defined a list of potential locations in a certain geographic area for dinner-type events, and an interpersonal networking and recommendation system may select one of the defined list of locations at random and associated it with the “dinner” Networking Activity. As another example, a set of filtered Recommendations may include a suggestion for a first user to meet with a second user for drinks, and may automatically suggest a drinks location close to both the first and second user from a predefined list of bar venues. In one embodiment, an interpersonal networking and recommendation system may suggest one or more locations for a potential Networking Activity or introduction and allow a user to decide. In a further embodiment, an interpersonal networking and recommendation system may automatically make reservations or reserve a venue after a location has been selected by the system or by a system user or admin.

In another embodiment, Recommendations for introductions, group conversations, or other interpersonal interactions at an ongoing Networking Activity may be assigned one or more predefined or determined locations associated with the Networking Activity. For example, a Networking Activity may be associated with a list of potential locations for group meetings or locations. In one embodiment, a list of potential locations associated with a Networking Activity may be defined by an interpersonal networking and recommendation system admin or user, a venue owner, or may be automatically generated based on a floor layout or based on location data. Illustratively, an interpersonal networking and recommendation system may track which locations associated with a Networking Activity are currently being used or likely being utilized by extant introductions, group conversations, or other interpersonal interactions, and may automatically assign potential locations to one or more of a set of Recommendations from block 1114.

Routine 1100 may end at block 1120. Illustratively, a set of Recommendations determined at one or more blocks of illustrative routine 1100 may be provided or displayed to an interpersonal networking and recommendation server user. Illustrative interfaces for displaying Recommendations to system user or Attendees are discussed below with further reference to FIGS. 13-18.

FIG. 12 is a flow diagram depicting an illustrative routine 1200 for scoring user or Attendee Recommendations. Illustratively, routine 1200 may be implemented or performed by components of an interpersonal networking and recommendation system such as depicted above at least with reference to illustrative FIGS. 1-4, et al. In one embodiment, interface elements and routine blocks discussed with reference to FIG. 12 may be implemented, displayed, or executed on a computing device 102 with reference to illustrative FIG. 1 or interpersonal networking manager 202 with reference to illustrative FIG. 2. Illustratively, various interfaces and processes of illustrative routine 1200 may further be performed on any combination of various other devices or services such as interpersonal networking interface device 132, user devices 106 or 108, or user computing device 302 as discussed with reference to FIGS. 1 and 3 respectively. In one embodiment, aspects or blocks of routine 1200 may be performed by an automated or semi-automated process associated with client computing device 102 or interpersonal networking manager 202. Aspects of routine 1200 may be performed in response to specific interactions or commands by a user or process. In yet another embodiment, aspects of routine 1200 may be performed in response to an automatic process or trigger, or implemented on a continuous basis. For example, in one embodiment, routine 1200 may be triggered or performed on one or more Recommendation as part of block 1110 of illustrative FIG. 11. It will be appreciated by one skilled in the relevant art that various aspects or blocks of routine 1200 may be performed concurrently, sequentially, or at different times and in response to different events or timings. Although Recommendation scoring is discussed herein in the context of scoring a single Recommendation in the context of one or more illustrative scoring algorithms, in various embodiments any number of Recommendations may be scored in any of a number of different ways, or according to different routines, algorithms, or processes.

At block 1202, routine 1200 begins responsive to a signal or request for the scoring of a Recommendation. Illustratively, a Recommendation score may comprise any number of numerical values corresponding to a fitness, desirability, efficiency, or weight of a Recommendation. Illustratively, aspects or blocks of routine 1200 may be performed as part of block 1110 of illustrative FIG. 11. Although in one embodiment Recommendation scores may be determined or generated when needed by an illustrative Recommendation determination process, in further embodiments Recommendation scores may be generated or determined at other times or responsive to other timings or user interactions, or may be stored or utilized in preparation of a subsequent Recommendation determination process or other routine. For example, an illustrative interpersonal networking and recommendation system may score potential recommendations continuously or as part of a background process, and may store the resulting scores for later use. In various embodiments, Recommendation scores may be generated for a specific user or Attendee, or may be generated for one or more Recommendations generally or without utilizing user or Attendee specific information. Recommendation scores may be generated or determined for any number of potential recommendations, and may be determined on the basis of user or Attendee Characteristics or Interests; Characteristics, Interests, or other values associated with Networking Activities, types of Networking Activities; groups, or types of Recommendations; recommendation weights; metadata tags associated with a user, group, Attendee, or Networking Event; or any other information directly or indirectly associated with an interpersonal networking and recommendation system, user, Attendee, group, Networking Activity, or interpersonal interaction.

At block 1204, an interpersonal networking and recommendation system may determine Characteristics and Interests associated with a Recommendation to be scored.

Illustratively, determination or generation of a Recommendation score may be based on a weighting or comparison of one or more relevant Characteristics or Interests. For example, a Recommendation scored for a user or Attendee may be based on a comparison of the user's Characteristics or Interests with one or more Characteristics or Interests associated with the Recommendation.

Illustratively, Characteristic or Interest values or weights may be identified, generated or determined for a Recommendation on the basis of Characteristics or Interests corresponding to one or more associated user or Attendee, on the basis of Characteristics or Interests corresponding to one or more associated Networking Activity, type of Networking Activity, or interpersonal interaction; on the basis of Characteristics or Interests corresponding to a venue, theme, or time period associated with the Recommendation; or on the basis of Characteristics, Interests, weights, or other values assigned or associated with the Recommendation.

Illustratively, a determination of Characteristics or Interest values or weights associated with a Recommendation scoring may be determined automatically based on information, descriptions, tags, or other values or information associated with an interpersonal networking and recommendation system, Networking Activity, Networking Activity type, Recommendation, Recommendation type, user, group, user or group type or attribute, or interpersonal interaction. For example, an interpersonal networking and recommendation system may parse a description of a programming themed Networking Activity, and may determine that a “computers” Characteristic should be assigned a value of 1 with a validity weight of 1 a “big data” Characteristic should be assigned a value of 0.5 with a validity weight of 1 based on a relative word frequency (e.g. first and second most frequent) of these terms in the description.

For example, a Recommendation for an introduction to a specific Attendee at a Networking Activity may be associated with Characteristics and Interests corresponding to the specific Attendee. As another example, a Recommendation to attend a specific Networking Activity may be associated with a set of Characteristic and Interest values corresponding to an average of Characteristic and Interest values of users confirmed to attend the Networking Activity, weighted by a validity weight corresponding to each Characteristic or Interest value associated with each user. As a further example, a Recommendation to attend a specific Networking Activity may be associated with Characteristic and Interest values corresponding to an average of values associated with users who showed interest in the Networking Activity, further modified by a set of values or weights assigned to the Networking Activity or the Networking Activity venue or location by an interpersonal networking and recommendation system admin or user. As a specific example, an interpersonal networking and recommendation system may determine that a Recommendation to attend a Networking Activity at a baseball game should be assigned base Characteristic values associated with the Networking Activity corresponding to a “baseball” Characteristic of 1 with a validity weight of 1, and a “sports” Characteristic value of 0.5 with a validity weight of 1, and may be assigned further Characteristic values based on an average of Characteristic values associated with users who selected an “Interested” interface element corresponding to the baseball Networking Activity. As an additional specific example, a Recommendation to attend a technology themed group meetup at a bar may be associated with Characteristic values corresponding to an average of Characteristic values including Characteristic values associated with the technology theme (e.g. a “technology” Characteristic value of 1, a “computers” Characteristic value of 0.8); Characteristic values associated with the meetup venue (e.g. a “drinks” Characteristic value of 0.5, a “food” Characteristic value of 0.2); and an average of Characteristic values of users who have indicated interest in the networking activity (e.g. an average “technology” Characteristic of 0.5). In various embodiments, Characteristics or Interests generated, determined, or assigned to a Recommendation, Networking Activity, group, theme, venue, time period, or interpersonal interaction may be combined through any mathematical or statistical technique such as averaging, weighted averaging (e.g. by a validity weight or assigned weight), summation, randomization (e.g. within a range or distribution), or any other algorithm, technique or process.

At block 1206, an interpersonal networking and recommendation system may determine Characteristics and Interests associated with a target user, Attendee, or group for whom the Recommendation is being scored. Illustratively, and as discussed above at least with reference to FIGS. 5 and 6, et al., in one embodiment an interpersonal networking and recommendation system may maintain values or validity weights associated with one or more user, Attendee, or group Characteristic or Interest. In another embodiment, an interpersonal networking and recommendation system may maintain values or validity weights associated with each user or Attendee, and may further determine values or validity weights corresponding to a group of users or Attendees based on an average of values or validity weights corresponding to users or Attendees in the group. In a further embodiment, an interpersonal networking and recommendation system may determine Characteristic or Interest values for a group of users or Attendees based on a weighted average by validity weight of Characteristic or Interest values for members of the group. In a still further embodiment, an interpersonal networking and recommendation system may calculate a new validity weight for each Characteristic or Interest value of a group based on a number of group-members included in a weighted average of each Characteristic or Interest value or with a corresponding validity weight over a defined threshold. In various other embodiments, Characteristics or Interests generated, determined, or assigned to a group may be based on a group composition, group theme or attribute, or one or more Characteristics, Interests, or other pieces of information associated with one or more group member, and may be calculated or combined from group-member values or weights through any mathematical or statistical technique such as averaging, weighted averaging (e.g. by a validity weight or assigned weight), summation, randomization (e.g. within a range or distribution), or any other algorithm, technique or process.

At block 1208, an interpersonal networking and recommendation system may determine Characteristics and Interests relevant to a Recommendation score determination. Illustratively, an interpersonal networking and recommendation system may base a determination of relevancy on any set of properties or attributes associated with a Characteristic or Interest, or associated with a Recommendation, user, or Attendee, Networking Event, venue, group, device, interpersonal interaction, or any other aspect of an interpersonal networking and recommendation system.

In one embodiment, an interpersonal networking and recommendation system may determine that Characteristics and Interests with low validity weights or not common to both a Recommendation and a target user, Attendee, or group should not be included as part of a Recommendation score determination.

As a specific illustrative example, at block 1204, an interpersonal networking and recommendation system may have determined that an illustrative Recommendation for a target user to attend a Networking Activity consisting of a technology group meetup should be associated with a “technology” Characteristic of 0.8, a “drinks” Characteristic of 0.4, and a “programming” Characteristic of 0.7. For this example, we may further assume that at block 1206 the interpersonal networking and recommendation system has determined that the target user has a “technology” interest of 0.5, a “drinks” interest of −0.1, and a “philosophy” interest of 0.9. In the context of this example, the interpersonal networking and recommendation system may determine that only Characteristics and Interests common to the target user and the Recommendation (e.g. the “technology” and “drinks” Characteristics and Interests) are relevant to a Recommendation score determination. In another embodiment but in the context of this same example, an interpersonal networking and recommendation system may determine, based in part on the technology theme of the Networking Activity, that only the “technology” Characteristic and Interest has relevance to a Recommendation score determination, and may ignore other Characteristics and Interests as part of a score determination process.

In a further embodiment, an interpersonal networking and recommendation system may determine that certain Characteristics or Interests are relevant to a Recommendation score determination even if one or more of the Characteristics or Interests are not currently defined for a target user or Recommendation, and may assign default values to an undefined Characteristic or Interest. For example, in another embodiment but in the context of the above technology group meetup example, an interpersonal networking and recommendation system may determine that all Characteristics and Interests are relevant to a Recommendation score determination, and may assign default values to Characteristics or Interest values not associated with the target user or Recommendation (e.g. may assign a default “philosophy” Characteristic value of 0.2 to the Recommendation, and a default “programming” Interest value of 0.0 to the target user).

In one embodiment, a determination of which Characteristics or Interests are relevant to a Recommendation score determination may be based on predefined attributes, settings, thresholds, or weights associated with an interpersonal networking and recommendation system, Networking Activity, Networking Activity type, Recommendation, Recommendation type, user, group, user or group type or attribute, or interpersonal interaction. For example, an interpersonal networking and recommendation system admin may define a set of relevant Characteristics and Interests corresponding to Recommendations for a specific Networking Activity or type of Networking Activity. As another example, a type of Recommendation corresponding to a personal introduction between two system users may be defined to only consider Characteristics and Interests that have validity weights over a defined threshold for both users.

In a further embodiment, a determination of which Characteristics or Interest are relevant to Recommendation scoring may be determined automatically based on information, descriptions, tags, or other values or information associated with an interpersonal networking and recommendation system, Networking Activity, Networking Activity type, Recommendation, Recommendation type, user, group, user or group type or attribute, or interpersonal interaction. For example, an interpersonal networking and recommendation system may parse a description of a programming themed networking group, and may determine that a “computers” Characteristic, a “big data” Characteristic, and a “hardware” Interest are relevant to Recommendations associated with Networking Activities created or hosted by users of this group based on a relative word frequency of these terms.

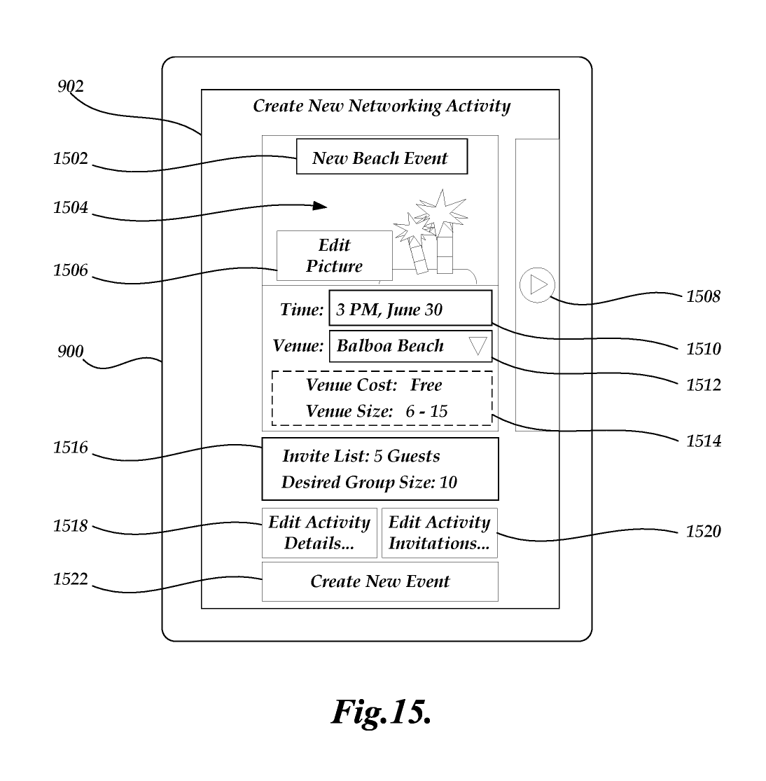

At optional block 1210, an interpersonal networking and recommendation system may determine user recommendation preferences. Illustratively, user recommendation preferences may be settings or preferences that may be utilized in calculating scores for Recommendations for a target user or Attendee. In one embodiment, user recommendation preferences may include settings or preferences associated with a particular group composition or group dynamic. For example, a user recommendation preference may correspond to a preference for a gender balance in a Networking Activity or group. As another example, a user recommendation preference may correspond to a preference for Networking Activities or groups with potential business contacts as Attendees or participants. A user recommendation preference may further correspond to a preference for any combination of particular mood, atmosphere, size, time, location, duration, type of venue, type of activity, type or subject of conversation, purpose, gender or personality balance, cost, or demographic or professional composition associated with a Networking Activity, group, introduction, or other interpersonal interaction. In one embodiment, user recommendation preferences may be determined based on user feedback or may be entered with profile information. In other embodiments, user recommendation preferences may be entered prior to or contemporaneously with requesting Recommendations for Networking Activities or other interpersonal interactions. Examples of interfaces allowing entry of user recommendation preferences are discussed below with reference to illustrative FIGS. 15-17. Illustrative embodiments of methods to calculate various user recommendation preference scores are discussed below with reference to block 1214.

At optional block 1212, an interpersonal networking and recommendation system may determine any further scoring factors, such as group chemistry or recommendation weighting factors, rules, weights, or algorithms that may apply to the recommendation score determination. Illustratively, various additional factors, rules, weights, or algorithms may be associated with an interpersonal networking and recommendation system, or one or more Networking Activity, Networking Activity type, Recommendation, Recommendation type, user, group, user or group type or attribute, or interpersonal interaction. For example, in one embodiment, all Recommendation scoring must take into account a group chemistry score representing the dynamics of a proposed Attendee Group as a whole. In another embodiment, an interpersonal networking and recommendation system may define a rule that requires Recommendation scoring for a particular type of Networking Activity (e.g. bar nights at a local club) to take into account the mix of single versus partnered participants. Illustratively, further scoring factors may be calculated according to any algorithm or formula, and may incorporate any user recommendation preference discussed with reference to block 1212 above or other algorithm or formula. Illustratively, further scoring factors may be defined by an interpersonal networking and recommendation system admin, or user or automatically generated or defined. Illustrative embodiments of methods to calculate various further scoring actions are discussed below with reference to block 1214.

At block 1214, an interpersonal networking and recommendation system may generate a score for a Recommendation. Illustratively, a Recommendation score may consist of one or more numerical values, weights, or other pieces of information.

Illustratively, an interpersonal networking and recommendation system may maintain a set of recommendation weights corresponding to Characteristics and Interests utilized by the system. In one embodiment, each recommendation weight may be associated with a Characteristic and an Interest. Illustrative recommendation weights are discussed in further detail above with reference to FIG. 10.

Illustratively, at block 1208, an interpersonal networking and recommendation system may have determined a set of Characteristics and Interests relevant to scoring of a Recommendation. In an illustrative embodiment, an interpersonal networking and recommendation system may determine an initial score value for each permutation of Recommendation Characteristic and target user, Attendee, or group Interest by multiplying a value of each relevant Characteristic of the Recommendation to be scored by a value of each relevant Interest of the target user, Attendee, or group for whom the Recommendation is being scored, and further multiplying each product times a corresponding recommendation weight associated with the Characteristic and Interest. Within the context of this illustrative embodiment, the interpersonal networking and recommendation system may further obtain an initial weight value associated with each permutation of Recommendation Characteristic and target user, Attendee, or group Interest by multiplying a validity weight of each relevant Characteristic of the Recommendation to be scored by a validity weight of each relevant Interest of the target user, Attendee, or group. Within this illustrative embodiment, the interpersonal networking and recommendation system may obtain an Initial Recommendation Score by performing a weighted average of initial score values weighted by corresponding initial validity weight for each permutation of Recommendation Characteristic and target user, Attendee, or group Interest.

An illustrative interpersonal networking and recommendation system may obtain a final Recommendation score by applying any user recommendation preferences or further scoring factors determined in blocks 1210 or 1212 above. In various embodiments, an illustrative interpersonal networking and recommendation system may apply a user recommendation preference or further scoring factor associated with obtaining geographical convenience, gender balance, obtaining positive group chemistry, obtaining a quiet or loud atmosphere, obtaining a work or personal focused group composition, or any other composition or dynamic. Illustratively, calculations of group balance, chemistry, dynamics, or atmosphere may be calculated based on any combination of current users in a group or Networking Activity or users confirmed or interested in joining a group or networking Activity, and in some embodiments may include the target Attendee or user for purposes of the group calculation. Illustratively, in various embodiments scores or weights associated with user recommendation preferences or further scoring factors may be combined with an Initial Recommendation Score by summation, multiplication, averaging, or any other mathematical or statistical technique. Embodiments of methods for obtaining user recommendation preference scores or further scoring factors are discussed below. Illustratively, any method, algorithm, process or function described below or herein may be utilized in calculating either user recommendation preferences or further scoring factors as discussed herein and with reference to blocks 1210 and 1212 et al.

An illustrative interpersonal networking and recommendation system may in one embodiment obtain a score associated with a geographical convenience based on travel time from a home address or the address of an employer associated with a target user or Attendee to the Networking Activity or group location, where a shorter travel time represents a higher score. In a further embodiment, a geographical convenience score may be calculated based on travel time from a home address or the address of an employer associated with a target user or Attendee to the Networking Activity or group location at the start time or end time of the Networking Activity or group (e.g. accounting for traffic), where a shorter travel time represents a higher score. Illustratively, map or travel time data may be obtained from a third-party mapping service or API as known in the art. In a still further embodiment where location data associated with a user or Attendee is available, a geographical convenience score may be calculated based on a travel time from an average location of a target user or Attendee at the start time of a Networking Activity or group to the Networking Activity or group location, where a smaller travel time represents a higher score. In one embodiment, travel times utilizing public transportation may be used to calculate geographic convenience in geographic areas with high public transportation usage (e.g. New York). In other embodiments, travel times based on taxi, car, or bicycle may be used. In one embodiment, Characteristics, Interests, or tags corresponding to particular modes of transportation may be the basis for calculating geographic convenience based on those particular modes of transportation for a target user or Attendee.

An illustrative interpersonal networking and recommendation system may in one embodiment obtain a score associated with gender balance by assigning each user or Attendee in a Networking Activity or other group with a positive “male” or “female” Characteristic a gender value of 0 or 1, respectively, averaging these gender values, and taking the absolute value of the difference between the average and 0.5. Illustratively, this formula may be used to calculate the balance between any two Characteristics within a group by substituting the two Characteristics for “male” and “female” in the example above, and subtracting the absolute value of a difference from a target value from 1, where a target value of 0.5 is balanced, 0 is all the first value (e.g. “male”) and 1 is all the second value (e.g. “female”).

One embodiment of a method to obtain a score associated with a group chemistry may comprise determining, for each user or Attendee, how many of the users or Attendees in a Networking Activity or other group have an Interest above a defined threshold which corresponds to at least one of Characteristics for that Attendee above a defined threshold (for the purpose of this example, we will refer to this number as “A1” for the first user or Attendee, “A2” for the second, “A3” for the third, etc. herein). In the context of this embodiment, the method to obtain a score associated with a group chemistry may further comprise determining, for each user or Attendee, how many of the users or Attendees in a Networking Activity or other group have an Characteristic above a defined threshold which corresponds to at least one of the Interests for that Attendee above a defined threshold (for the purpose of this example, we will refer to this number as “B1” for the first user or Attendee, “B2” for the second, “B3” for the third, etc. herein).). In the context of this embodiment, the method to obtain a score associated with a group chemistry may further comprise determining (A1*B1)*(A2*B2)*(A3*B3) . . . (AN*BN) for the full set of users or Attendees. It is noted that this score is very sensitive to any 0 values thereby preventing a Networking Activity or group with any very poorly matched users or Attendees from attaining a good score.

One embodiment of a method to calculate a particular group atmosphere or dynamic may comprise identifying particular Characteristics associated with that atmosphere or dynamic, assigning each user or Attendee in a Networking Activity or other group default values (e.g. 0.0) for each of the particular identified Characteristics that are not defined for that user or Attendee, taking an average of all identified Characteristic for each user or Attendee, and then taking an average of this average across all users or Attendees in the Networking Activity or group. Illustratively, Characteristics associated with a particular atmosphere or dynamic may be defined by an interpersonal networking and recommendation system admin or user, or may be automatically determined from user or Attendee feedback. For example, in one embodiment, an interpersonal networking and recommendation system may determine the work focus of a group from “finance,” “employed,” and “networking” Characteristics. In the context of this example, these Characteristics may be assigned a default value of 0.0 in users without these Characteristics assigned, and then the three Characteristics may be averaged for each users, and then the averages averaged together to obtain a score between 1 and 0 representing how work focused the group of users is. Illustratively, in a further embodiment of this same example, the same technique could be employed utilizing Characteristics associated with a non-work or personal group focus to obtain a score representing how non-work or personal focused the group was. In a still further embodiment of this same example, the scores obtained for how work focused and how non-work or personal focused the group was could be subtracted from one another to obtain a value representing the balance between work and non-work or personal focus, with a value closer to 1 being more work focused, and a value closer to 0 being more non-work or personal focused. Taking the difference in the other direction would in turn provide a positive value when a group was more non-work or personal focused. Illustratively, other Characteristics associated with other atmospheres or dynamics may be substituted into this method to obtain scores or balancing scores of any atmospheres or dynamics associated with a Networking Activity or other group of users or Attendees.

As a specific example of Recommendation scoring for the purpose of illustration, an interpersonal networking and recommendation system may have determined that a Recommendation for attending a baseball game Networking Activity is to be scored associated with a “baseball” Characteristic of 0.8 with a validity weight of 1 and a “male” Characteristic of 0.2 with a validity weight of 0.8. For this specific example, we may further assume that a target user is associated with a “baseball” Interest of 0.7 with a validity weight of 0.3 and a “wine” Interest of 0.3 with a validity weight of 0.6. For this specific example we may further assume that the interpersonal networking and recommendation system maintains a set of recommendation weights including at least the illustrative recommendation weights depicted in FIG. 10 above. In the context of this specific example, the interpersonal networking and recommendation system may generate initial values for each permutation of Recommendation Characteristic and user Interest by multiplying each Recommendation Characteristic value with a user Interest value and a corresponding recommendation weight, producing illustrative values of baseball:baseball=0.8*0.7*0.29=0.16; baseball:wine=0.8*0.3*0.56=0.13; male:baseball=0.2*0.7*0.11=0.02; and male:wine=0.2*0.3*0.62=0.04. In the context of this example, the interpersonal networking and recommendation system may further generate initial validity weights for each permutation of Recommendation Characteristic and user Interest by multiplying each Characteristic validity weight with a user Interest validity weight, yielding illustrative validity weights of baseball:baseball=1*0.3=0.3; baseball:wine=1*0.6=0.6; male:baseball=0.8*0.3=0.24; male:wine=0.8*0.6=0.48. Further in the context of this example, the interpersonal networking and recommendation system may determine an Initial Recommendation Score for the Recommendation by taking a weighted average of the initial values weighted by the initial validity weights, yielding a Recommendation score of 0.09.

To continue this illustrative example, we may assume that the interpersonal networking and recommendation system determined at block 1210 that a user recommendation preference for equal gender balance should be applied to the Recommendation score, and further determined at block 1212 that it was not necessary to apply any further scoring factor. In the context of this example, the interpersonal networking and recommendation system may determine that the users confirmed to attend the baseball game Networking Activity (including the target user) include 12 male users and 3 female users. The interpersonal networking and recommendation system may assign the male users a value of 0 and the female users a value of 1, obtaining an average of 3/15=0.2. The interpersonal networking and recommendation system may subtract this from a target value of 0.5 (representing equal balance), and subtract the absolute value of the result from 1, yielding 1−0.3=0.7. Illustratively, in this illustrative example, we may assume that the interpersonal networking and recommendation system obtains a final Recommendation score by multiplying the gender balance score of 0.7 by the Initial Recommendation Score of 0.09 to obtain a Final Recommendation score of 0.06.

Although a specific embodiment and specific example of a Recommendation scoring algorithm is discussed above for purpose of illustration, in various embodiments a Recommendation may be scored through any number of different algorithms or mathematical processes. In one embodiment, Recommendation Interests may be compared to user, Attendee, or group Characteristics. In another embodiment, Recommendation Characteristics may be compared to user, Attendee, or group Characteristics. In a still further embodiment, Recommendation Interests may be compared to user, Attendee, or group Interests. In further embodiments, user recommendation preferences or further scoring factors may be summed, multiplied, averaged, or otherwise combined with an Initial Recommendation Score in any way or utilizing any technique. Illustratively, in various embodiments an order of operations of any mathematical technique or algorithm discussed herein may be changed or modified. Further, although an algorithm producing a single Recommendation score consisting of a single value is presented here for purpose of illustration, in various embodiments a Recommendation score may comprise any number, range, or set of values.

In one embodiment, Characteristic or Interest values associated with a Recommendation may not have corresponding validity weights. In one embodiment, the illustrative algorithm discussed above may be utilized to calculate a Recommendation score for a Recommendation without corresponding validity weights by setting validity weights corresponding to each Recommendation Characteristic or Interest to 1.

Although illustrative algorithms and formulas above are discussed in the context of a Recommendation for a target user, Attendee, or group, in one embodiment a Recommendation may be scored for a generic set of Characteristics or Interests. For example, in one embodiment a Recommendation may be scored against a set of Interest values representing a general, generic, or archetypical user, Attendee, or group. As a specific example, a Recommendation may be scored against a generic target user with assumed Characteristic and Interest values all set to a default (e.g. 0.0). As another specific example, a Recommendation may be scored against an archetype of a user in the finance industry with a set of predefined Characteristic and Interest values representing a generic finance industry employee. Illustratively, Recommendation scores generated against a generic or archetypical set of Characteristics or Interests may represent how generally interesting or desirable a particular Recommendation is across users or within particular demographics, and may be used to filter out bad Recommendations or identify likely Recommendations in a general case without expending computational resources scoring a Recommendation for a particular user, Attendee, or group. For example, a generic Recommendation score corresponding to a default user or user archetype may be used as part of block 1108 or block 1112 of illustrative FIG. 11 to determine or filter recommendations for a user.

At block 1212, routine 1200 ends having determined a Recommendation score. In one embodiment, a Recommendation score may be utilized to select or filter a set of Recommendations as part of an illustrative Recommendation determination routine or process such as described above with reference to illustrative FIG. 11.

FIG. 13 is a device diagram depicting an illustrative embodiment of a Networking Activity selection interface displayed on tablet computing device 900. Illustratively, a Networking Activity selection interface may be displayed responsive to an interpersonal networking and recommendation system determining that Networking Activity Recommendations should be provided to a user or Attendee, responsive to a request by a user or Attendee to view Recommendations or current or upcoming Networking Activities, or responsive to any other user or Attendee request or interpersonal networking and recommendation system signal or determination. In various embodiments, a Networking Activity selection interface may allow or facilitate selecting or confirming interest or future or current attendance at Networking Activities in an illustrative networking and recommendation system. For the purposes of illustration, a Networking Activity selection interface may display information corresponding to a set of recommended Networking Activities, such as Networking Activities corresponding to Recommendations determined through an illustrative Recommendation determination process such as described above with reference to illustrative FIG. 11. In one embodiment, a Networking Activity selection interface may allow or facilitate a user or Attendee selection of one or more Networking Activity for the purpose of signaling attendance or joining a guest list managed or facilitated by an interpersonal networking and recommendation system. In a further embodiment, a Networking Activity selection interface may allow a user or Attendee to signal interest or confirm their attendance at one or more Networking Activities.

Illustratively, Networking Activities displayed in an illustrative Networking Activity selection interface may be generated, defined, scheduled, or suggested by an interpersonal networking and recommendation system admin or user, may be based upon or defined by a third-party activity management system or website, or may be automatically generated, defined, scheduled, or suggested by one or more devices, processes, or components of an interpersonal networking and recommendation system. In one embodiment, Networking Activities displayed by a Networking Activity selection interface may correspond to any combination of upcoming or ongoing Networking Activities and suggested Networking Activities, such as Networking Activities generated or suggested by an interpersonal networking and recommendation service but not yet scheduled or finalized with an actual venue or invite list. Illustratively, a set of Networking Activities may be displayed in a sequence as represented in illustrative FIG. 13, or may additionally or alternately be displayed as a list, grid, set of icons or thumbnails, or in any other way.

Returning to FIG. 13, a Networking Activity selection interface may display information corresponding to a Networking Activity of a set of Networking Activities currently being browsed by or recommended to a user, including Networking Activity title 1302, Networking Activity picture 1304 associated with the Networking Activity, Networking Activity time label 1306, Networking Activity location label 1308, and networking Activity Attendee panel 1310. Illustratively, Networking Activity Attendee panel 1310 may display elements corresponding to all or a subset of potential Networking Activity Attendees that have confirmed attendance, signaled interest, or looked at a Recommended Networking Activity. In various embodiments, display elements corresponding to potential Attendees in Networking Activity Attendee panel 1310 may include pictures, names, titles, attendance status (e.g. confirmed or interested), or any other biographic or professional information about a potential Attendee. In one embodiment, elements representing potential Attendees displayed in Networking Activity Attendee panel 1310 may be displayed with a set of associated tags. For example, a potential Attendee may be displayed alongside tags that he has in common with the user viewing the Networking Activity selection interface. In another embodiment, a set of potential attendees may be selected to be displayed from a set of all potential attendees based on Characteristics, Interests, or tags in common with the user or attendee viewing the Networking Activity selection interface.

A Networking Activity selection interface may further include more info button 1312. Illustratively, user or Attendee selection of more info button 1312 may cause the display of additional information associated with the currently displayed Networking Activity. Illustratively, additional information associated with the currently displayed Networking Activity may include Networking Activity location, theme, subject, duration, time, description, cost, whether friends may be invited, Network Activity exclusivity, document or files associated with the Networking Activity, reviews of the Networking Activity or associated venue, maximum or minimum number of attendees, full or partial invitee list, invitee status (e.g. confirmed for the activity, interested in the activity, etc.), tags associated with the Networking Activity, an explanation for why the Networking Activity is recommended for the user, or any other information associated with the Networking Activity.

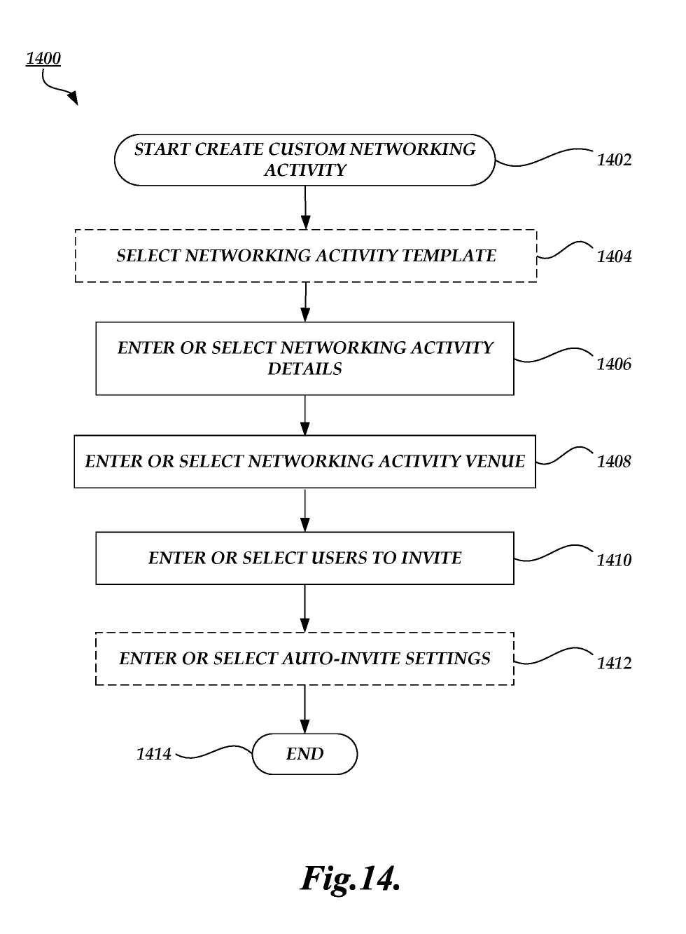

A Networking Activity selection interface may further include a next arrow 1314. Illustratively, user selection of next arrow 1314 may allow the user to view a next Networking Activity in a set of displayed networking activities. For example, in the context of the illustrative Networking Activity selection interface displayed in FIG. 13, there may be five different Networking Activities recommended for a user, and next arrow 1314 may allow a user to browse through or view information on each Networking Activity. Illustratively, next arrow 1314 may be paired with a back button (not shown) to browse back and forth through a displayed set of Networking Activities. A Networking Activity selection interface may further include interested button 1316 and confirm button 1318. Illustratively, selection of interested button 1316 may allow a user to signal interest in a Networking Activity without committing to attend, while selection of confirm button 1318 may allow a user to reserve a spot or otherwise confirm attendance at a Networking Activity. In one embodiment, selection of confirm button 1318 may cause display of a further confirmation interface (not shown) allowing a user to enter RSVP information or other details and pay any required Networking Activity cost or deposit. In one embodiment, sets of interested or confirmed users may be utilized in Recommendation scoring or determination such as discussed above with reference to illustrative FIGS. 11 and 12, et al. A Networking Activity selection interface may still further include create new event button 1320. Illustratively, user selection of new event button 1320 may enable or facilitate creation of a new Networking Activity. Embodiments of illustrative Networking Activity creation routines and interfaces are discussed below with reference to illustrative FIGS. 14-17.

Although particular interface components are discussed above as part of an illustrative Networking Activity selection interface, in various embodiments a Networking Activity selection interface may include any number of additional or alternate interface components corresponding to any piece of information or aspect associated with one or more illustrative Networking Activities. In one embodiment, various information discussed with reference to a Networking Activity may be defined by an illustrative networking and recommendation system admin or user; adapted or defined based on a default value, information associated with a Networking Activity, or Networking Activity template; associated with an activity venue or type; or may automatically generated or defined by an illustrative networking and recommendation system.

FIG. 14 is a flow diagram depicting an illustrative routine 1400 for creating a custom Networking Activity. Illustratively, routine 1400 may be performed by a user or Networking Activity Attendee interacting with an illustrative tablet computing device 900 with reference to FIG. 9, or other components of an interpersonal networking and recommendation system such as depicted above at least with reference to illustrative FIGS. 1-3, et al. In one embodiment, interface elements and routine blocks discussed with reference to FIG. 14 may be implemented, displayed, or executed on a computing device 102 with reference to illustrative FIG. 1 or interpersonal networking manager 202 with reference to illustrative FIG. 2. Illustratively, various interfaces and processes of illustrative routine 1400 may further be performed on any combination of various other devices or services such as interpersonal networking interface device 132, user devices 106 or 108, or user computing device 302 as discussed with reference to FIGS. 1 and 3 respectively. In one embodiment, aspects or blocks of routine 1400 may be performed by an automated or semi-automated process associated with tablet computing device 900, computing device 102 or interpersonal networking manager 202. Aspects of routine 1400 may be performed in response to specific interactions or commands by a user or process. In yet another embodiment, aspects of routine 1400 may be performed in response to an automatic process or trigger, or implemented on a continuous basis. It will be appreciated by one skilled in the relevant art that various aspects or blocks of routine 1400 may be performed concurrently, sequentially, or at different times and in response to different events or timings.

At block 1402, routine 1400 begins responsive to a user request or a determination by an interpersonal networking and recommendation system that a new Networking Activity should be defined. For example, in one embodiment, routine 1400 may be triggered or performed responsive to user selection of create new event button 1320 of an illustrative Networking Activity selection interface with reference to FIG. 13. In another embodiment, routine 1400 may be automatically triggered at a user device based on a determination that the user should host a new Networking Activity.

At optional block 1404, a user may select a Networking Activity template from an optionally displayed list or set of Networking Activity templates. Illustratively, a Networking Activity template may include one or more default values for creation of a Networking Activity, such as any combination of a default title, default description, one or more default pictures, one or more associated tags, Characteristics, or Interests, one or more possible venues with accompanying locations, costs, and venue size information, or any other information potentially associated with a Networking Activity as discussed herein. One embodiment of an illustrative Networking Activity template is discussed below with reference to illustrative FIG. 15.

At block 1406, a user may enter or select details to be associated with the Networking Activity. In various embodiments, Networking Activity details may include any information or details discussed herein with reference to a Networking Activity, Networking Activity template, or related interface, such as discussed with reference to illustrative FIGS. 13, 15, et al. In one embodiment, Networking Activity details may include an event cut-off time, such as a latest time to that a user or Attendee may confirm attendance at an event. In another embodiment a cut-off time may be automatically determined or predefined for a Networking Activity or venue. Illustratively, if the user selected a Networking Activity template in optional block 1404, various instances of Networking Activity details may be prepopulated or defined to default values. One embodiment of an illustrative create Networking Activity interface is discussed below with reference to FIG. 15.

At block 1408, a user may enter or select a Networking Activity venue or location. Illustratively, a Networking Activity venue may be associated with various attributes such as a minimum or maximum number of Attendees, a cost, a location, possible times or durations of events, booking statuses, layouts, maps, associated services, etc. In one embodiment, various venue information may have been entered by an interpersonal networking and recommendation service user or admin, or may be automatically gathered or updated through an API or automatic process associated with a venue or venue information service. In one embodiment, a Networking Activity template may be associated with a number of different pre-defined venues corresponding to the template. In other embodiments, a user may select from any venue defined in an interpersonal networking and recommendation system or may enter details or define a new venue to host a Networking Activity. Illustratively, in one embodiment, a venue may be scored on the basis of an invitee list or set of potential Attendees as discussed in U.S. patent application Ser. No. ______ (attorney docket number: SLD.002A) filed by inventors Steven Wu, Russell Wong, Tyler Rosche, and Theodore R. Smith on the same date as the present application, entitled COMPUTERIZED SYSTEMS AND METHODS FOR OFFLINE EVENT FACILITATION, and incorporated by reference herein. Illustratively, one or more venue may be suggested to the user or selected based on the highest score. An embodiment of an interface including venue selection controls is discussed below with reference to illustrative FIG. 15.

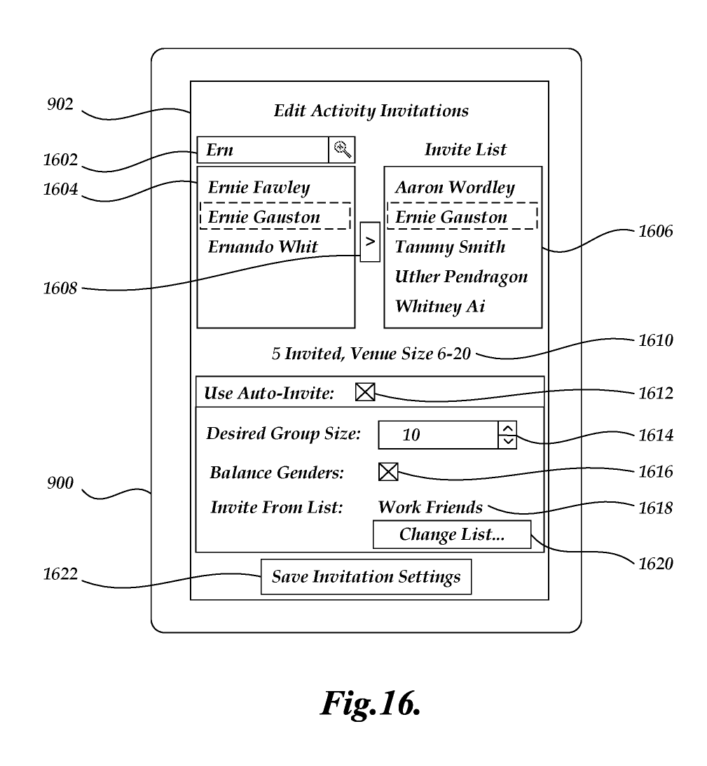

At block 1410, a user may enter or select users to invite to the Networking Activity. In one embodiment, a user may select one or more users of an interpersonal networking and recommendation system from a list or other interface such as discussed below with reference to illustrative FIG. 16. In various embodiments, users that a user may invite to a Networking Activity may include only friends of the user (e.g. users that have agreed to be friended by the user, users that have been tagged with a “friend” tag by the user, etc.), may include all users of an interpersonal networking and recommendation system, may include people or friends from other social networks, may include people or friends invited through an e-mail or phone contact, or may include or be constrained to any other group or set of people or users. In one embodiment, a user may invite groups or lists of users that the user has previously defined.

At optional block 1412, a user may enter or select auto-invite settings for the Networking Activity. Illustratively, a venue with a minimum and maximum number of potential Attendees may have been selected in block 1408 above; however, the number of users to invite as specified in block 1410 may exceed or may not reach this number. Moreover, not all invited users may be able or willing to attend a Networking Activity to which they are invited. In one embodiment, specifying auto-invite settings may allow an interpersonal networking and recommendation system to determine various subsets of users specified at block 1410 or defined with the auto-invite settings to invite or recommend a new Networking Activity to in order to meet size requirements or various group composition, dynamics, or chemistry preferences. Auto-invite settings may further include various user recommendation preferences for Recommendation scoring such as discussed above with reference to illustrative FIG. 12. Illustrative auto-invite settings are discussed further below with reference to FIG. 16.

At block 1414, routine 1400 ends. Illustratively, an interpersonal networking and recommendation system may determine a first set of users, friends, or other potential Attendees to invite from users specified at block 1410 or with auto-invite settings at block 1412. For example, an illustrative interpersonal networking and recommendation system may determine a set of all users specified at block 1410, and a sub-set of other users from additional invitation lists specified with auto-invite settings at optional block 1412, such that the total number of users selected meets a desired activity size specified with auto-invite settings at optional block 1412 or a minimum or maximum venue size associated with the Networking Activity.

Illustratively, in one embodiment, an interpersonal networking and recommendation system may determine a set of users, friends, or other potential Attendees by scoring Recommendations for a set of potential Networking Activities consisting of various potential versions of the new Networking Activity with different permutations of potential invitees from lists specified in block 1410 or optional block 1412 and choosing the set corresponding to the highest score. Illustrative embodiments of recommendation scoring are discussed above with reference to FIGS. 11 and 12. In one embodiment, Recommendations for potential Networking Activities may be scored against the creating user as the target user. In another embodiment, Recommendations may be scored targeting a generic user or generic or default set of Characteristics and Interests. Illustratively, scoring of Recommendations may incorporate user recommendation preferences selected or entered in optional block 1412.

In one embodiment, an interpersonal networking and recommendation system may invite a set of users, friends, or other invitees defined in block 1410, and may further add the Networking Activity to a list of defined Networking Activities to recommend to other system users such as discussed with reference to block 1104 of illustrative FIG. 11. In a further embodiment, the Networking Activity may only be included in a list of defined Networking Activities for potential invitees defined in block 1410 or block 1412. In one embodiment, an illustrative interpersonal networking and recommendation system may cause notifications, e-mails, or other messages to be presented to invited users notifying them that they have a Recommendation or invitation to join the Networking Activity. Illustratively, selecting or interacting with a notification or message may cause the display of an interface allowing a user or other invitee to join, confirm, or signal interest in the Networking Activity such as an illustrative Networking Activity selection interface discussed with reference to FIG. 13. In another embodiment, the Networking Activity may be automatically included in a list of Recommended Networking Activities for each invited user. In a still further embodiment, some users (e.g. users defined in block 1410), may be notified that they are invited to the Networking Activity, and other users (e.g. users selected from lists of users defined at block 1412) may have the Networking Activity automatically included in lists of Recommended Networking Activities such as discussed with reference to illustrative FIG. 13, et al.

In one embodiment, an interpersonal networking and recommendation system may cause notifications or Recommendations associated with the new Networking activity to be sent or displayed to sets of users as determined above until a minimum or target number of users have confirmed attendance or signified interest. Illustratively, an interpersonal networking and recommendation system may determine a first set of users or other invitees to invite to or Recommend for the Networking Activity, and after a defined amount of time determine a second set of users or other invitees based on a remaining number of available slots associated with the Networking Activity (e.g. a difference between the number of invitees that have so far confirmed and a minimum or target size of the Networking Activity). In one embodiment, an interpersonal networking and recommendation system may continue to determine sets of users to invite to the Networking Activity until either a minimum or target number of confirmed Attendees is reached or a pre-defined cut-off time is reached (e.g. a day before the start time of the Activity). In a further embodiment, if a minimum or target number of confirmed Attendees has not been reached before a cut-off time, the Networking Activity may be cancelled and notifications sent to any previously confirmed users or Attendees.

FIG. 15 is a device diagram depicting an illustrative embodiment of a create Networking Activity interface displayed on tablet computing device 900. Illustratively, a create Networking Activity interface may be displayed responsive to a user request to create a new Networking Activity, such as selection of new event button 1320 with reference to FIG. 13.

A create Networking Activity interface may include a title field 1502 allowing a user to edit or enter a title for a new Networking Activity, activity picture 1504 and picture edit button 1506 allowing a user to view and select a picture corresponding to the new Networking Activity, activity time field 1510 allowing a user to select or enter an activity time, and venue selection control 1512 allowing a user to select a venue for the new Networking Activity. In one embodiment, information displayed or selectable in title field 1502, activity picture 1504, activity time field 1510, and venue selection control 1512 may be associated with one or more Networking Activity templates predefined by an admin or user. Create Networking Activity interface may optionally include a forward button 1508 or back button (not shown) to browse between predefined templates. Illustratively, a template may include a set of predefined images selectable through picture edit button 1506, or may allow a user to upload or define their own picture to associate with the new Networking Activity. In one embodiment, one or more venues selectable through venue selection control 1512 may have associated sets of pictures for a user to select through picture edit button 1506. Illustratively, venues selectable through venue selection control 1512 may correspond to a predefined set of venues associated with a template currently being viewed, may include any venue defined for an interpersonal networking and recommendation system, or may allow a user to enter a new venue and any necessary venue information. A create Networking Activity interface may further include a venue information panel 1514 displaying details about a venue, such as a venue cost, venue size, venue location, or any other venue details such as discussed above with reference to illustrative FIG. 14, et al.

A create Networking Activity interface may further include an invitation details panel 1516 displaying information regarding a Networking Activity invitation list or auto-invite settings or rules. A create Networking Activity interface may still further include edit activity details button 1518 and edit activity invitations button 1520. Illustratively, user selection of edit activity details button may cause the display of an interface allowing the user to enter or select other information associated with the new Networking Activity, such as various other information discussed with reference more info button 1312 of illustrative FIG. 13. User selection of edit activity invitations button 1520 may cause the display of an invitation edit interface allowing the user to select or enter invitation details such as a list of users to invite or auto-invite settings as discussed with reference to FIG. 14 above. An illustrative invitation edit interface is discussed below with reference to illustrative FIG. 16. A create Networking Activity interface may further include create event button 1522. Responsive to user selection of create event button 1522, a Networking Activity may be created. Illustratively, notifications and Recommendations associated with a newly created Networking Activity may be generated or provided as discussed with reference to block 1414 of illustrative FIG. 14.

FIG. 16 is a device diagram depicting an illustrative embodiment of an invitation edit interface displayed on tablet computing device 900. Illustratively, an invitation edit interface may be displayed responsive to a request by a user to edit invitation lists or settings associated with a Networking Activity. For example, an invitation edit interface may be displayed responsive to user selection of edit activity invitations button 1520 discussed with reference to illustrative FIG. 15. An invitation edit interface may enable or facilitate definition, entry, or selection of invitation lists and auto-invite settings associated with a Networking Activity.

Illustratively, an invitation edit interface may include a user search field 1602 and search results grid 1604 for searching and identifying users to be added to invitation list 1606. In one embodiment, users selected in search results grid 1604 may be added to invitation list 1606 by selecting add invitee button 1608. Illustratively, a search for users or invitees may be restricted to only friends of a user, or may include any user in an illustrative interpersonal networking and recommendation system. Illustratively, in other embodiments, interface controls including user search field 1602, search results grid 1604, add invitee button 1608, and invitation list 1606 may be used to define lists or groups of users or Attendees for any other purpose, such as invitation lists specified in auto-invite settings discussed below and with reference to illustrative FIG. 14. In one embodiment, interface components may be included to allow a user to invite non-users through a third-party social network, by e-mail address, phone, or other form of identification. In one embodiment, users or other invitees added to invitation list 1606 may comprise an invitation list as discussed with reference to block 1410 of illustrative FIG. 14, et al.

An invitation edit interface may further include interface elements or controls associated with auto-invite settings such as discussed above with reference to optional block 1412 of illustrative FIG. 14, including use auto-invite checkbox 1612, desired group size field 1614, gender balance checkbox 1616, auto-invite list field 1618, and change auto-invite list button 1620. Illustratively, auto-invite checkbox 1612 may control whether an interpersonal network recommendation system utilizes auto-invite functionality, and desired group size field 1614 may allow a user to enter a desired group size such as discussed with reference to FIG. 14. Selection of gender balance checkbox 1616 may signal that an illustrative auto-invite Recommendation scoring process such as discussed with reference to block 1414 of FIG. 14 should utilize a gender balancing user recommendation preference such as discussed with reference to illustrative FIG. 12. Auto-invite list field 1618 may display the name of a list of users or other invitees created or selected by the user through an interface displayed responsive to selection of change auto-invite list button 1620. For example, a user may create and name one or more lists of users or other potential invitees through an interface allowing selection or entry of users or invitees (not shown). In one embodiment, an interface allowing selection or entry of users or invitees may incorporate one or more controls or interface elements similar to or corresponding to search field 1602, search results grid 1604, add invitee button 1608, and invitation list 1606 as discussed above, and in various embodiments may further incorporate fields allowing selection or entry of individuals from third party social networking sites or selection or entry of potential invitees by e-mail or phone number. An invitation edit interface may further include save invitation settings button 1622. In one embodiment, invitation lists or auto-invite settings may be saved responsive to interaction or selection of save invitation settings button 1622. In one embodiment, a user may return to a create Networking Activity interface such as discussed above with reference to illustrative FIG. 15 responsive to saving invitation settings. Saved invitation settings may correspond to invitation lists or auto-invite settings discussed above with reference to illustrative FIG. 14.

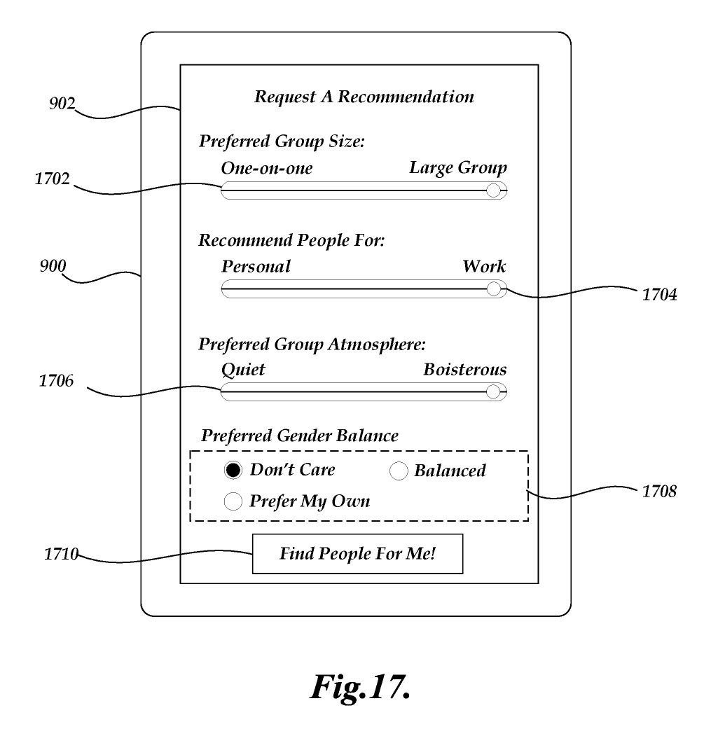

FIG. 17 is a device diagram depicting an illustrative embodiment of a recommendation request interface displayed on tablet computing device 900. Illustratively, a recommendation request interface may be displayed responsive to a determination by an interpersonal networking and recommendation system that a user wishes to request a Recommendation. For example, a recommendation request interface may be displayed responsive to a request by a user to request a Recommendation for a group introduction, meeting, Networking Activity, or other interpersonal interaction. As a specific example, a user may scan a QR code to signal his physical presence at a Networking Activity, and may be presented with a recommendation request interface through tablet computing device 900. As another specific example, a user at a Networking Activity may select a button signifying that he wishes to request Recommendations for introductions or interpersonal interactions. As a still further example, an interpersonal networking and recommendation system may determine that a defined period of time has passed since the user last participated in an interpersonal interaction and may automatically display a recommendation request interface.

Returning to FIG. 17, a recommendation request interface may include a group size slider 1702, a personal versus work slider 1704, a group atmosphere slider 1706, and a preferred gender balance radio panel 1708. Illustratively, settings associated with the aforementioned controls may correspond to user recommendation preferences discussed in the context of embodiments of Recommendation scoring with reference to block 1710 of FIG. 17. A recommendation request interface may further include find recommendations button 1710. Illustratively, user interaction with find recommendations button 1710 may cause an interpersonal networking and recommendation system to perform a Recommendation determination process or routine such as discussed with reference to illustrative FIGS. 11 and 12 incorporating user recommendation preferences corresponding to with group size slider 1702, a personal versus work slider 1704, a group atmosphere slider 1706, and a preferred gender balance radio panel 1708. Although four controls corresponding to user recommendation preferences are shown in FIG. 17 for purposes of clarity, in various embodiments any number of different controls may be displayed in a recommendation request interface, and controls may be associated with any number or combination of different user recommendation preferences such as discussed with reference to illustrative FIG. 17 or corresponding to any combination of desired group balance, size, composition, atmosphere, dynamic, or chemistry.

FIG. 18 is a device diagram depicting an illustrative embodiment of a group Recommendation interface displayed on tablet computing device 900. Illustratively, a group Recommendation interface may be displayed responsive to a determination by an interpersonal networking and recommendation system that a Recommendation for a group meeting or other interpersonal interaction should be provided to a user or Attendee. In one embodiment, an interpersonal networking and recommendation system may determine that a group Recommendation should be provided to a user or Attendee responsive to the user or Attendee signaling their attendance at a Networking Activity or interpersonal interaction. For example, a group Recommendation interface may be displayed responsive to a user or Attendee checking in or otherwise signaling his physical presence at the event. In another embodiment, an interpersonal networking and recommendation system may determine that a group Recommendation should be provided to a user or Attendee responsive to the user or Attendee requesting a Recommendation for a group or personal introduction through an illustrative Recommendation request interface such as discussed above with reference to FIG. 17. In still further embodiments, an interpersonal networking and recommendation system may determine that a group Recommendation should be provided to a user or Attendee responsive to a request by the user or Attendee, a signal or determination that the user or Attendee is not currently engaged in an interpersonal interaction, a length of time passing since a user or Attendee interacted with an interpersonal networking and recommendation system interface, or any other determination, activity, or interaction by the interpersonal networking and recommendation system or associated components, user, or Attendee.

Illustratively, after determining that a Recommendation for a group meeting or other interpersonal interaction should be provided to a user or Attendee, an interpersonal networking and recommendation system may cause the display of a group Recommendation interface, including a meeting location element 1802 displaying a location for a Recommended group meeting and an Attendee information panel 1804 containing information on one or more Recommended Attendees or Attendees in the recommended group. A group Recommendation interface may further include a found button 1806. In one embodiment, user selection of found button 1806 may signal to an interpersonal networking and recommendation system that the user has engaged with or found Attendees or groups displayed in Attendee information panel 1804. In one embodiment, an interpersonal networking and recommendation system may provide Recommendations for conversation topics, behaviors, or other interpersonal suggestions associated with Recommended Attendees or group responsive to selection of found button 1806.

Illustratively, Recommendations shown in a group Recommendation interface may be determined or otherwise generated by a Recommendation determination process or routine such as discussed above with reference to illustrative FIG. 11. Although a Recommendation for a specific group meeting is depicted in illustrative FIG. 18, in various embodiments, an interpersonal networking and recommendation system or group Recommendation interface may display any number of different Recommendations for group meetings, introductions, or other interpersonal interactions. For example, an interpersonal networking and recommendation system may cause an interface to display a list, grid, or other set of Recommendations that a user may view. Although only names and pictures of Attendees in a Recommended group are shown in illustrative FIG. 18, in various other embodiments a group Recommendation interface may display any other information or data associated with Recommended users or Attendees as discussed herein. In further embodiments, a group Recommendation interface may display any other information associated with a Recommendation, Networking Activity, or interpersonal interaction.

FIG. 19 is a device diagram depicting an illustrative embodiment of a user details interface displayed on tablet computing device 900. Illustratively, a user details interface may be displayed responsive to a request by a user or Attendee to view details associated with a user or Attendee. For example, in one embodiment an interpersonal networking and recommendation system may display a user details interface responsive to a user or Attendee selecting an interface element associated with user or Attendee, such as a user or Attendee searched through a search interface (not shown) or selected in Attendee information panel 1310 of illustrative FIG. 13. Illustratively, a user details interface may enable or facilitate viewing of professional or biographic information; tags; pictures; lists of friends, common connections, or acquaintances; audio messages; posts; or any other information or data associated with a user or Attendee.

Returning to FIG. 19, a user details interface may include a back button 1902, which may enable a user to return to a previous interface screen or layout after viewing details associated with a selected user or Attendee. A user details interface may further include user information panel 1904 containing information corresponding to a user or Attendee being viewed, such as a name, title, employer, or picture. In various embodiments, user information panel 1904 may contain any professional, biographical, or other information associated with a user or Attendee as discussed above. A user details interface may further include system tags panel 1906 containing one or more tag generated or defined by an interpersonal networking and recommendation system component, process, admin, or user, or generated or defined by the user or Attendee being viewed. For example, in one embodiment, a user whose details are being viewed in the illustrative user details interface of FIG. 19 may have entered the tags shown in system tags panel 1906 through a profile creation or illustrative self-tagging interface (not shown) discussed with reference to illustrative FIG. 9 above. In another embodiment, one or more tags displayed in system tags panel 1906 may be added by an interpersonal networking and recommendation system admin, or may be automatically generated based on professional or biographical information entered by the user or Attendee being viewed. Illustratively, some tags may be private or otherwise not accessible by all users. For example, not all tags added by the user being viewed or otherwise added, generated, or associated with the user being viewed may be displayed or viewable in tags panel 1906.

A user details interface may further include user tagging control 1910 and user tagging panel 1908 containing tags added by the viewing user or Attendee. Illustratively, a user or Attendee may utilize user tagging control 1910 to add tags to user tagging panel 1908 that the user or Attendee believes have relevance to the user or Attendee being viewed. For example, an Attendee at a Networking Activity may engage in a conversation with a second Attendee, and may afterwards decide to access a user details interface corresponding to the second Attendee and utilize user tagging control 1910 to add tags corresponding to the conversation topic to an illustrative user tagging panel 1908. In one embodiment, tags added to a specific user or Attendee by another user or Attendee may not be visible to the specific user or Attendee. In another embodiment, tags added to a specific user or Attendee by another user or Attendee may be visible to the specific user or attendee, or may alert the specific user or Attendee through a notification, e-mail, or other message. Illustratively, tags added to user tagging panel 1908 and tags displayed in system tags panel 1906 may be gathered as part of an illustrative Characteristics or Interests determination process such as discussed above with reference to illustrative FIGS. 7 and 8. A user details interface may further include save button 1912, allowing a user or Attendee to save changes to user tagging panel 1908 or any other aspects or components of user details displayed through the interface.

FIG. 20 is a device diagram depicting an illustrative embodiment of a user feedback interface displayed on tablet computing device 900. Illustratively, a user feedback interface may be displayed responsive to an interpersonal networking and recommendation system determining that feedback on a user, Attendee, or group should be gathered. For example, an interpersonal networking and recommendation system may provide a Networking Activity Attendee with a Recommendation to meet a specific other Attendee. In the context of this example, once the interpersonal networking and recommendation system has determined that the meeting or interpersonal interaction is over (e.g. after a certain amount of time has passed or one of the Attendees has requested an additional Recommendation), the interpersonal networking and recommendation system may cause the display of a user feedback interface on illustrative tablet computing device 900 associated with the Attendee in order to gather feedback on the specific other Attendee. Illustratively, a user feedback interface may be used to gather feedback regarding a user or Attendee after a personal meeting or interpersonal interaction, or may be used to gather feedback regarding one or more of a group of users or Attendees after a group interaction. In one embodiment, a user or Attendee may request to provide feedback regarding a specific user or Attendee. In another embodiment, an interpersonal networking and recommendation system may automatically determine that feedback should be gathered randomly, based on an quantity of feedback associated with one or more users or Attendees, based on a time since the last feedback was provided corresponding to a user or Attendee, based on an expected positive or negative outcome of an interpersonal interaction or Networking Activity, based on a recommendation weight or other comparison of Characteristics or Interests corresponding to one or more users or Attendees participating in an interpersonal interaction, based on a position of a user or Attendee in a matching or Recommendation generation queue, based on a time or other signal that an interpersonal interaction or Networking Activity has completed, or on any other factor, aspect, or piece of information.

Returning to FIG. 20, a user feedback interface may include identifying information elements 2002 allowing identification of the user or Attendee for whom feedback is being requested. Illustratively, identifying information elements 2002 may include a picture, a name, a description, a title or employer, tags associated with the user or Attendee, or any other information associated with the user or Attendee that may facilitate identification. A user feedback interface may further include feedback controls such as feedback slider control 2004, commonality feedback radio control 2006, and group feedback radio control 2008. Illustratively, feedback controls associated with a user feedback interface may include any number or type of different interface control corresponding to any type or format of feedback. For example, a user feedback interface may include a notes panel allowing free form text feedback on a user or Attendee, or feedback in any other form. A user feedback interface may further include a save feedback button 2010 allowing a user or Attendee to save their feedback. Illustratively, feedback collected through a user feedback interface may be gathered or used as part of an illustrative Characteristic or Interest determination process such as discussed with reference to illustrative FIGS. 7 and 8 above or aspects or blocks of an illustrative Recommendation determination process such as discussed with reference to illustrative FIGS. 11-14 above.

FIG. 21 is a device diagram depicting an illustrative embodiment of a Networking Activity feedback interface displayed on tablet computing device 900. Illustratively, a Networking Activity feedback interface may be displayed responsive to an interpersonal networking and recommendation system determining that feedback on a Networking Activity or interpersonal interaction should be gathered. For example, an interpersonal networking and recommendation system may provide a user with a Recommendation to attend a Networking Activity. In the context of this example, once the interpersonal networking and recommendation system has determined that the Networking Activity is over (e.g. after the scheduled end of the Networking Activity), the interpersonal networking and recommendation system may cause the display of a Networking Activity feedback interface on illustrative tablet computing device 900 associated with the Attendee in order to gather feedback on the Networking Activity. Illustratively, a Networking Activity feedback interface may be used to gather feedback regarding a Networking Activity, or may be used to gather feedback regarding one or more interpersonal interactions or activities at a Networking Activity or other event. In one embodiment, a user or Attendee may request to provide feedback regarding a specific Networking Activity or interpersonal interaction. In another embodiment, an interpersonal networking and recommendation system may automatically determine that feedback should be gathered randomly, based on an quantity of previously generated feedback associated with a Networking Activity, based on an amount of time since the Networking Activity, based on an expected likeability or recommendation weight corresponding to a Networking Activity, based on a comparison of Characteristics or Interests corresponding to a Networking Activity to one or more Attendees, based on a time or other signal that an Networking Activity has completed, or on any other factor, aspect, or piece of information.

Returning to FIG. 21, a Networking Activity feedback interface may include Networking Activity identifying elements 2102 allowing identification of the Networking Activity for which feedback is being requested. Illustratively, Networking Activity identifying elements 2102 may include a picture, a name, a description, a time, a location, tags associated with the Networking Activity, or any other information associated with the Networking Activity or interpersonal interaction that may facilitate identification. A Networking Activity feedback interface may further include feedback controls such as attend feedback radio control 2104 and Networking Activity feedback slider control 2106. Illustratively, feedback controls associated with a Networking Activity feedback interface may include any number or type of different interface control corresponding to any type or format of feedback. For example, a Networking Activity feedback interface may include a notes panel allowing free form text feedback on a Networking Activity or interpersonal interaction, or feedback in any other form. A Networking Activity feedback interface may further include a save feedback button 2108 allowing a user or Attendee to save their feedback. Illustratively, feedback collected through a Networking Activity feedback interface may be gathered or used as part of an illustrative Characteristic or Interest determination process such as discussed with reference to illustrative FIGS. 7 and 8 above or an illustrative Recommendation determination process such as discussed with reference to illustrative FIGS. 11-14 above.

It will be appreciated by those skilled in the art and others that all of the functions described in this disclosure may be embodied in software executed by one or more processors of the disclosed components and communications devices. The software may be persistently stored in any type of non-volatile storage.

Conditional language, including, but not limited to, “can,” “could,” “might,” or “may,” unless stated otherwise, is generally intended to convey that certain embodiments include certain features, elements or steps, while other embodiments may contain additional, fewer, alternate, or modified features, elements, or steps. Such conditional language is not generally intended to imply that features, elements or steps are in any way required in the context of one or more embodiments, or that embodiments include logic for deciding, with or without user input or prompting, whether particular features, elements or steps are included or are to be performed in any particular embodiment. Alternative conjunctions such as “or,” unless stated otherwise, are generally intended as inclusive, and should be interpreted as including any possible combination of one or more features, elements, or steps.

Any process descriptions, elements, or blocks described or suggested herein or depicted in one or more of the attached figures should be understood as potentially representing modules, segments, or portions of code which include executable instructions for implementing specific logical functions or steps. Alternate implementations are included within the scope of the embodiments described herein in which elements, functions, routines, user or process interactions, or any other step or aspect may be omitted, added, or executed in an alternate order from that shown or discussed, including substantially concurrently or in reverse order as would be understood by those skilled in the art. Data, metadata, components, or code described above may be stored on a computer-readable medium and loaded into memory of a computing device through any means known in the art including, but not limited to, a flash drive or other portable storage device, a storage system or device associated with the computing device, a CD-ROM, a DVD-ROM, a network interface, etc. Any number and combination of components, processes, functionality, data, metadata, or other elements may be included in a single device or distributed in any manner. Accordingly, one or more general purpose computing devices may be configured to implement any combination of processes, algorithms, or methodology of the present disclosure.

It should be emphasized that many variations and modifications may be made to the herein described embodiments; all aspects and elements of said variations and modifications, among other acceptable examples, are to be understood as being described herein. All such modifications and variations are intended to be herein included and within the scope of this disclosure and protected by the following claims.

What is claimed is:

1. A system for offline event management comprising:
a first memory component for storing matching values associated with a plurality of users; and
a computer implemented interpersonal networking component operable to:
cause the display of an offline event creation interface to a user;
receive event size information from a user, wherein the event size information comprises at least a maximum event size;
receive an invitation list comprising a set of users of the plurality of users, wherein the size of the set of users is greater than the maximum event size;
receive an auto-invite setting comprising at least one scoring preference value;
select a first subset of the set of users based at least on a comparison between the at least one scoring preference value and matching values associated with each of the set of users;
cause event invitations to be provided to the first subset of users;
receive event confirmations from one or more of the first subset of users;
select a second subset of the set of users, wherein users in the one or more of the first subset of users are excluded from the second subset of users;
cause event invitations to be provided to the second subset of users;

2. The system of claim 1, wherein the size of the first subset of the set of users is smaller than the maximum event size.

3. The system of claim 2 further operable to select the first subset of the set of users based at least on the maximum event size.

4. The system of claim 1 further operable to select the second subset of the set of users based at least on a comparison between the at least one scoring preference value and matching values associated with each of the second subset of the set of users.

5. The system of claim 1, wherein the at least one scoring preference value is associated with a gender balance.

6. The system of claim 1, wherein the at least one scoring preference value is associated with a group chemistry.

7. A computer-implemented method for managing offline events comprising:
receiving, by at least one computing device, a scoring preference value;
receiving, by at least one computing device, an invitation list comprising a plurality of users;
selecting a first set of users from the invitation list based on a comparison between the scoring preference value and at least one matching value associated with each of the first set of users;
identifying a plurality of confirmed users from the first set of users;
selecting a second set of users from the invitation list at least based on a comparison between the scoring preference value and at least one matching value associated with each of the second set of users, wherein the second set of users does not contain users in the plurality of confirmed users

8. The computer-implemented method of claim 7, further comprising:
receiving, by at least one computing device, event size information, wherein the event size information comprises at least a target event size, and wherein selection of the second set of users from the invitation list is at least based on the target event size.

9. The computer-implemented method of claim 8 further comprising receiving confirmation information from one or more users of the second set of users, and adding the one or more of the second set of users to the plurality of confirmed users.

10. The computer-implemented method of claim 9 further comprising:
selecting, by at least one computing device, subsequent sets of users from the plurality of users;
identifying subsets of confirmed users from each subsequent set of users based on received confirmation information from the subsets of confirmed users;
adding each identified subset of confirmed users to the plurality of confirmed users; and
halting selecting subsequent sets of users when the size of the plurality of confirmed users reaches or exceeds the target event size.

11. The computer-implemented method of claim 10, wherein the invitation list comprises a first list and a second list, wherein the first set of users is selected from the first list, and wherein the second and subsequent sets of users are selected from the second list.

12. The computer-implemented method of claim 7, wherein the scoring preference value is associated with a gender balance.

13. The computer-implemented method of claim 7, wherein the scoring preference value is associated with a group chemistry.

14. A system for offline event management comprising:
a first memory component for storing matching values associated with a plurality of users; and
a computer implemented interpersonal networking component operable to:
receive an invitation list comprising a set of users of the plurality of users;
receive a scoring preference value;
select a plurality of sets of users from the invitation list, wherein each set of users is selected at least based on comparisons between the scoring preference value and one or more matching values associated with the set of users.

15. The system of claim 14, wherein each set of users is selected at least based on comparisons between the scoring preference value and one or more matching value associated with each user of the set of users.

16. The system of claim 14, wherein a subset of each set of users is added to a list of confirmed users.

17. The system of claim 14, wherein sets of users are selected from the invitation list until the size of the list of confirmed users reaches a target event size.

18. The system of claim 14, wherein the scoring preference value is associated with an event gender balance.

19. The system of claim 14, wherein the one or more matching values comprises a gender matching value.

20. The system of claim 14, wherein the scoring preference value is associated with how work-oriented an event is.
